(19) United States
(12) Patent Application Publication
(10) Pub. No.: US 2008/0307240 A1
(43) Pub. Date: Dec. 11, 2008

(54) POWER MANAGEMENT ELECTRONIC CIRCUITS, SYSTEMS, AND METHODS AND PROCESSES OF MANUFACTURE

(75) Inventors: Franck Dahan, Nice (FR); Gilles Dubost, Valbonne (FR); Gordon Gammie, Plano, TX (US); Uming Ko, Plano, TX (US); Hugh Mair, Fairview, TX (US); Sang-Won Song, Plano, TX (US); Alice Wang, Richardson, TX (US); William D. Wilson, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/760,263

(22) Filed: Jun. 8, 2007

(51) Int. Cl. G06F 1/32

(52) U.S. Cl. 713/320

(57) ABSTRACT

An electronic circuit including a power managed circuit (2610), and a power management control circuit (3570) coupled to the power managed circuit (2610) and operable to select between at least a first operating performance point (OPP1) and a second higher operating performance point (OPP2) for the power managed circuit (2610), each performance point including a respective pair (Vn, Fn) of voltage and operating frequency, and the power management control circuit (3570) further operable to control dynamic power switching of the power managed circuit (2610) based on a condition wherein the power managed circuit (2610) at a given operating performance point has a static power dissipation (4820.1), and the dynamic power switching puts the power managed circuit in a lower static power state (4860.1) that dissipates less power than the static power dissipation (4820.1).

### CROSS-REFERENCE TO RELATED APPLICATIONS

This application is related to provisional U.S. Patent Application No. 60/645,875, (TI-39850PS) filed Jan. 21, 2005, titled “Smartreflex—DVFS: Adaptive, Dynamic Voltage & Frequency Scaling,” and said provisional patent application is incorporated herein by reference.

This application is related to provisional U.S. Patent Application No. 60/645,861, (TI-39851PS) filed Jan. 21, 2005, titled “Smartreflex—DPS: Adaptive Dynamic Power Switching,” and said provisional patent application is incorporated herein by reference.

### STATEMENT REGARDING FEDERALLY SPONSORED RESEARCH OR DEVELOPMENT

Not applicable.

### COPYRIGHT NOTIFICATION

Portions of this patent application contain materials that are subject to copyright protection. The copyright owner has no objection to the facsimile reproduction by anyone of the patent document, or the patent disclosure, as it appears in the United States Patent and Trademark Office, but otherwise reserves all copyright rights whatsoever.

### BACKGROUND OF THE INVENTION

This invention is in the field of electronic computing hardware and software and communications, and is more specifically directed to improved circuits, devices, and systems for power management and information and communication processing, and processes of operating and making them. Without limitation, the background is further described in connection with communications processing.

Wireline and wireless communications, of many types, have gained increasing popularity in recent years. The personal computer with a wireline modem such as DSL (digital subscriber line) modem or cable modem communicates with other computers over networks. The mobile wireless (or cellular) telephone has become ubiquitous around the world. Mobile telephony has recently begun to communicate video and digital data, and voice over packet (VoP or VOIP), in addition to cellular voice. Wireless modems for communicating computer data over a wide area network are also available.

Mobile video on cellular telephones and other mobile platforms is increasing in popularity. It is desirable that many streams of information such as video, voice and data should be flexibly handled by such mobile devices and platforms under power management.

Wireless data communications in wireless mesh networks, such as those operating according to the IEEE 802.16 standard or “WiMax,” are increasing over a widening installed base of installations. The wireless mesh networks offer wideband multi-media transmission and reception that also appear to call for substantial computing power and hardware. Numerous other wireless technologies exist and are emerging about which various burdens and demands for power management exist and will arise.

Security techniques are used to improve the security of retail and other business commercial transactions in electronic commerce and to improve the security of communications wherever personal and/or commercial privacy is desirable. Security is important in both wireline and wireless communications and apparently imposes still further demands for computing power and hardware and compatible power management.

Processors of various types, including DSP (digital signal processing) chips, RISC (reduced instruction set computing), information storage memories and/or other integrated circuit blocks and devices are important to these systems and applications. Containing or reducing energy dissipation and the cost of manufacture and providing a variety of circuit and system products with performance features for different market segments are important goals in DSPs, integrated circuits generally and system-on-a-chip (SOC) design.

Further advantageous solutions and alternative solutions would, accordingly, be desirable in the art.

### SUMMARY OF THE INVENTION

Generally and in one form of the invention, an electronic circuit includes a power managed circuit, and a power management control circuit coupled to the power managed circuit and operable to select between at least a first operating performance point and a second higher operating performance point for the power managed circuit, each performance point including a respective pair of voltage and operating frequency, and the power management control circuit further operable to control dynamic power switching of the power managed circuit based on a condition wherein the power managed circuit at a given operating performance point has a static power dissipation, and the dynamic power switching puts the power managed circuit in a lower static power state that dissipates less power than the static power dissipation.

Generally and in another form of the invention, an electronic circuit includes an electronic device having a processor, and a power management circuit operable to establish a selected operating point including a voltage and operating frequency for said processor thereby defining ranges bounded by adjacent pairs of operating frequencies, said processor operable to generate a target frequency and operable to determine whether or not the target frequency is outside or within a current range and further operable to configure an operating point transition in said power management circuit when the target frequency is outside the current range.

Generally and in a further form of the invention, an electronic circuit includes a processor, a functional circuit coupled to said processor, a power management register circuit coupled to said processor for holding configuration bits in said power management register circuit, a power management control circuit coupled to said power management register circuit and said power management control circuit operable in response to the configuration bits for voltage and frequency scaling combined with conditional dynamic power switching of said processor.

Generally and in an additional form of the invention, an electronic circuit includes a processor operable to run an application, a memory coupled to said processor, a peripheral including a buffer coupled to said memory and said buffer having a buffer state output, and a power management control circuit coupled to said processor, to said memory and to said buffer state output, said power management control circuit conditionally operable in a dynamic power switching mode having a controlled sequence wherein said processor runs the application and delivers resulting information to said memory, and power to said processor is substantially lowered, and portions of the resulting information are successively transferred from said memory to said buffer depending on the buffer state output, and then power to said processor is restored.

Generally and in another further form of the invention, an electronic circuit includes a power management circuit having a dynamic power switching mode and a sleep control mode, and a processor operable in a secure mode and responsive to said power management circuit dynamic power switching mode to perform a context save of the processor before a sleep transition and a context restore on a wakeup transition, said processor further operable to perform a security context save on each exit from secure mode, whereby the security context save does not need to be done on the sleep transition.

Generally and in a further additional form of the invention, an electronic circuit includes a power-managed processing circuit operable to execute an application context and said power-managed processing circuit subject to active power consumption when an application is running and static power consumption if its power is on when the application is not running, a dynamic voltage and frequency scaling (DVFS) circuit operable to establish a voltage and a clock frequency for said power-managed circuit, and a dynamic power switching (DPS) circuit coupled to said dynamic voltage and frequency scaling circuit, said DPS circuit operable to determine an excess of the clock frequency over a target frequency for said power-managed processing circuit, and when that excess exceeds a predetermined threshold to initiate a context save by said power-managed processing circuit then temporarily substantially reduce the static power consumption.

Generally and in another additional form of the invention, an electronic system includes a first integrated circuit including a processor, a functional circuit coupled to said processor, a power management register circuit coupled to said processor to hold configuration bits, a power management control circuit coupled to said power management register circuit and said power management control circuit operable in response to the configuration bits for combined voltage and frequency scaling and conditional dynamic power switching of said processor; and a second integrated circuit including a power controller coupled to said power management control circuit of said first integrated circuit, and a first controllable voltage power supply responsive to said power controller and said first controllable voltage power supply coupled to supply a controllable voltage to power said processor, and a second controllable voltage power supply responsive to said power controller and said second controllable voltage power supply coupled to supply a controllable voltage to power said functional circuit said first integrated circuit.

Generally and in another system form of the invention, an electronic camera system includes a camera sensor operable for successive capture operations to capture image frames, a digital signal processor operable for image processing, an interconnect coupled to said digital signal processor, an interconnect clock coupled to said interconnect, a power management control circuit; a camera interface coupled to said camera sensor and to said interconnect, said camera interface including a buffer and supporting a smart standby mode wherein when said camera sensor is enabled, a time interval elapses between the successive capture operations, said camera interface operable during the time interval to assert a camera standby signal to the power management control circuit that said camera interface is not accessing said interconnect, said power management control circuit operable during the time interval to shut down said interconnect clock and assert a wait signal to prevent sourcing by said digital signal processor onto said interconnect, and at substantially the end of the time interval the camera interface further operable to de-assert the camera standby signal to indicate that said camera interface is ready to access said interconnect, and said power management control circuit operable to then disable the wait signal and activate said interconnect clock; and a display coupled to said digital signal processor.

Generally and in a further system form of the invention, a mobile video electronic system includes a processor, a power management control circuit coupled to said processor and operable for voltage and frequency scaling combined with conditional dynamic power switching of said processor, a video camera coupled to said processor and to said power management control circuit, a modem coupled to said power management control circuit, and a video display operable to display video content and coupled to said power management control circuit.

Generally, a manufacturing process form of the invention includes preparing design code representing a processor and configurable power management circuitry for voltage and clock control by power management control operable for voltage and frequency scaling combined with conditional dynamic power switching of the processor, and making at least one integrated circuit by wafer fabrication responsive to said design code.

These and other circuit, device, system, apparatus, process, and other forms of the invention are disclosed and claimed.

### BRIEF DESCRIPTION OF THE DRAWINGS

FIG. 1 is a pictorial diagram of a communications system embodiment including system blocks, for example a cellular base station, a DVB video station, a WLAN AP (wireless local area network access point), a WLAN gateway, a personal computer, a set top box and television unit, and two cellular telephone handsets, any one, some or all of the foregoing improved according to the invention.

FIG. 2 is a block diagram of inventive integrated circuit chips for use in the blocks of the communications system of FIG. 1, including an inventive partitioning of circuit blocks of a cellular telephone handset.

FIG. 3 is a block diagram of an inventive applications processor integrated circuit in FIG. 2 with associated integrated circuits.

FIG. 4 is a block diagram of an inventive integrated circuit combination of stacked chips for use as applications processor integrated circuit and modem chip in FIG. 2.

FIG. 5 is a block diagram of an inventive integrated circuit combination of an applications processor of FIGS. 2, 3, and 4 combined with a power IC (integrated circuit) of FIG. 2.

FIG. 6 is a partially schematic, partially block diagram of an inventive integrated circuit for use in FIGS. 1-5 with voltage domains and power domains.

FIGS. 7A and 7B are graphs of normalized power versus execution time for an integrated circuit without Dynamic Voltage and Frequency Scaling (DVFS) power management and with DVFS power management respectively.

FIGS. 8A and 8B are graphs of normalized power versus execution time for an integrated circuit without Dynamic Power Switching (DPS) power management and with DPS power management respectively.

FIG. 9 is a graph of normalized maximum frequency versus normalized voltage, the graph showing a curve for a hot device from a strong process and a curve for a cold device from a weak process.

FIGS. 10A and 10B are graphs of normalized power versus execution time for an integrated circuit without Dynamic Power Switching (DPS) power management and with DPS power management respectively, and wherein the operation is in the vicinity of a DPS margin threshold recognized herein.

FIG. 11 is a partially graphical, partially tabular illustration of Operating Performance Points (OPPs) spread vertically over a spectrum of increasing device performance and legended with types and combinations of inventive power management process and structure embodiments.

FIG. 12 is a graph of frequency versus voltage and showing the OPPs of FIG. 1 as darkened circles positioned at various frequency and voltage coordinates of FIG. 12, and further showing DPS margin thresholds for different OPPs and as well as a computed target frequency as an open circle positioned vertically from OPP2 beyond the DPS margin threshold for OPP2 in an inventive power management process and structure embodiment.

FIG. 13 is a state transition diagram of inventive power management operational process of an inventive integrated circuit with various portions of the integrated circuit powered and unpowered as illustrated in FIGS. 14A-14D.

FIGS. 14A-14D is an inventive process sequence of various portions of the same inventive integrated circuit of FIG. 3, wherein any given portion of the integrated circuit is shown when powered and not shown when unpowered, wherein the sequence is correspondingly illustrated in the inventive state transition diagram of FIG. 13.

FIG. 15 is an inventive block diagram of software for an image, video, and audio (IVA) digital signal processor (DSP) combined with an inventive block diagram of software for a microprocessor unit (MPU) such as in FIG. 3.

FIG. 16 is a flow diagram of an inventive process of combining power management modes for the structures and processes of FIGS. 1-15.

FIG. 17 is a more detailed flow diagram of an inventive process of combining power management modes for the structures and processes of FIGS. 1-16.

FIG. 18 is a block diagram detailing inventive voltage processing and control structures and processes for power management in the inventive integrated circuit of FIGS. 2-6 and processes of FIGS. 11-12.

FIG. 19 is a flow diagram of an inventive process of operation of the structures of FIG. 18.

FIG. 20 is a block diagram further detailing inventive voltage processing and control structures and processes for power management in the inventive integrated circuit of FIGS. 2-6 and 18 and processes of FIGS. 11-12 and 18.

FIG. 21 is a block diagram detailing an inventive voltage processor block of FIGS. 18 and 20.

FIG. 22 is a state transition diagram of an inventive finite state machine (FSM) structure and process for use in the inventive structure and process of FIG. 20.

FIG. 23 is a block diagram of an inventive combination of control circuits for power management and combined with controlled circuits in a power domain, and providing further detail for use with FIGS. 5 and 6.

FIGS. 24A, 24B and 24C are parts of a composite diagram of an inventive state transition process and state machine PSCON structure for use in the inventive structure and process of FIG. 23.

FIG. 25 is a block diagram of inventive clock control structure and process for establishing frequencies and turning clocks off and on for OPPs of FIGS. 11-12 DVFS combined with DPS.

FIG. 26 is a block diagram of inventive wakeup control structure and process for input/output (IO) pads and inventive power management.

FIG. 27 is partially schematic, partially block diagram of inventive structures and processes proliferated over an integrated circuit and used for power management clock multiplication and division and turning clocks off and on in FIG. 25 and for wakeup in FIG. 26, and controlled as in FIGS. 6-17.

FIG. 28A is a flow diagram of an inventive process for disabling clock pulses for one or more modules, and FIG. 28A is read by comparison with FIGS. 6, 17, 25 and 27.

FIG. 28B is a flow diagram of an inventive process for enabling clock pulses for one or more modules, and FIG. 28B is read by comparison with FIGS. 6, 17, 25 and 27.

FIG. 29 is a flow diagram of an inventive process for controlling and changing frequency of clock pulses for one or more modules, and FIG. 29 is read by comparison with FIGS. 6, 17, 25 and 27.

FIG. 30 is a flow diagram of an inventive process for initiating a sleep mode for one or more power domains, and FIG. 30 is read by comparison with FIGS. 6, 17, and 25-28.

FIG. 31 is a flow diagram of an inventive process for initiating a wakeup for one or more power domains, and FIG. 31 is read by comparison with FIGS. 6, 17, and 25-28.

FIG. 32 is a flow diagram of an inventive process of manufacturing various embodiments of the invention.

Corresponding numerals in different figures indicate corresponding parts except where the context indicates otherwise. Corresponding designations differing only by upper or lower case represent the same designation except where the context indicates otherwise.

### DETAILED DESCRIPTION OF EMBODIMENTS

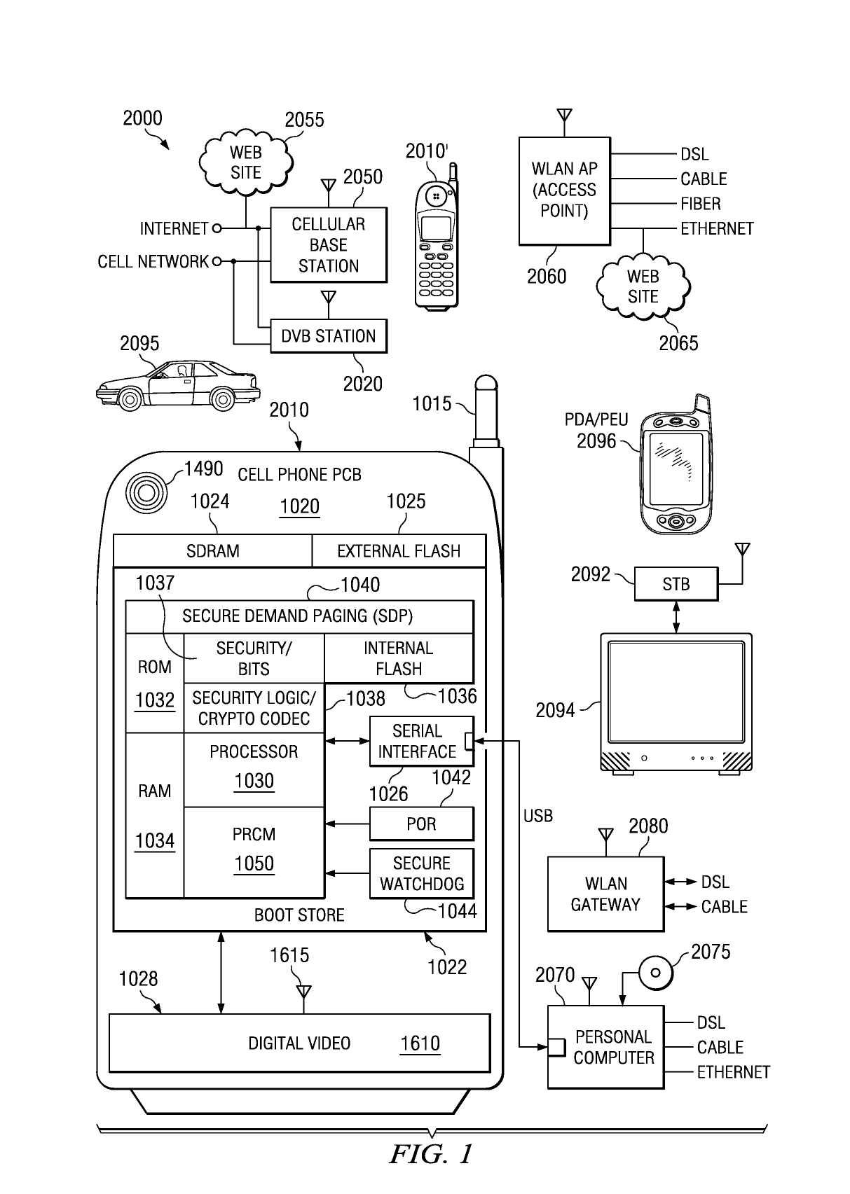

In FIG. 1, an improved communications system 2000 has system blocks as described next and improved with any one, some or all of the circuits and subsystems shown in FIGS. 1-10. Any or all of the system blocks, such as cellular mobile telephone and data handsets 2010 and 2010′, a cellular (telephony and data) base station 2050, a WLAN AP (wireless local area network access point, IEEE 802.11 or otherwise) 2060, a Voice over WLAN gateway 2080 with user voice over packet telephone 2085 (not shown), and a voice enabled personal computer (PC) 2070 with another user voice over packet telephone (not shown), communicate with each other in communications system 2000. Each of the system blocks 2010, 2010′, 2050, 2060, 2070, 2080 are provided with one or more PHY physical layer blocks and interfaces as selected by the skilled worker in various products, for DSL (digital subscriber line broadband over twisted pair copper infrastructure), cable (DOCSIS and other forms of coaxial cable broadband communications), premises power wiring, fiber (fiber optic cable to premises), and Ethernet wideband network. Cellular base station 2050 two-way communicates with the handsets 2010, 2010′, with the Internet, with cellular communications networks and with PSTN (public switched telephone network).

In this way, advanced networking capability for services, software, and content, such as cellular telephony and data, audio, music, voice, video, e-mail, gaming, security, e-commerce, file transfer and other data services, internet, world wide web browsing, TCP/IP (transmission control protocol/Internet protocol), voice over packet and voice over Internet protocol (VoP/VoIP), and other services accommodates and provides security for secure utilization and entertainment appropriate to the just-listed and other particular applications.

The embodiments, applications and system blocks disclosed herein are suitably implemented in fixed, portable, mobile, automotive, seaborne, and airborne, communications, control, set top box 2092, television 2094 (receiver or two-way TV), and other apparatus. The personal computer (PC) 2070 is suitably implemented in any form factor such as desktop, laptop, palmtop, organizer, mobile phone handset, PDA personal digital assistant 2096, internet appliance, wearable computer, content player, personal area network, or other type.

For example, handset 2010 is improved for selectively determinable functionality, performance, security and economy when manufactured. Handset 2010 is interoperable and able to communicate with all other similarly improved and unimproved system blocks of communications system 2000. Camera 1490 provides video pickup for cell phone 1020 to send over the internet to cell phone 2010′, PDA 2096, TV 2094, and to a monitor of PC 2070 via any one, some or all of cellular base station 2050, DVB station 2020, WLAN AP 2060, STB 2092, and WLAN gateway 2080. Handset 2010 has a video storage, such as hard drive, high density memory, and/or compact disk (CD) in the handset for digital video recording (DVR) such as for delayed reproduction, transcoding, and retransmission of video to other handsets and other destinations.

On a cell phone printed circuit board (PCB) 1020 in handset 2010, is provided a higher-security processor integrated circuit 1022, an external flash memory 1025 and SDRAM 1024, and a serial interface 1026. Serial interface 1026 is suitably a wireline interface, such as a USB interface connected by a USB line to the personal computer 1070 and magnetic and/or optical media 2075 when the user desires and for reception of software intercommunication and updating of information between the personal computer 2070 (or other originating sources external to the handset 2010) and the handset 2010. Such intercommunication and updating also occur via a processor in the cell phone 2010 itself such as for cellular modem, WLAN, Bluetooth from a website 2055 or 2065, or other circuitry 1028 for wireless or wireline modem processor, digital television and physical layer (PHY).

In FIG. 1, processor integrated circuit 1022 includes at least one processor MPU (or central processing unit CPU) block 1030 coupled to an internal (on-chip read-only memory) ROM 1032, an internal (on-chip random access memory) RAM 1034, and an internal (on-chip) flash memory 1036. A security logic circuit 1038 is coupled to secure-or-general-purpose-identification value (Security/GPI) bits 1037 of a non-volatile one-time alterable Production ID register or array of electronic fuses (E-Fuses). Depending on the Security/GPI bits, boot code residing in ROM 1032 responds differently to a Power-On Reset (POR) circuit 1042 and to a secure watchdog circuit 1044 coupled to processor 1030. A device-unique security key is suitably also provided in the E-fuses or downloaded to other non-volatile, difficult-to-alter parts of the cell phone unit 1010.

The words “internal” and “external” as applied to a circuit or chip respectively refer to being on-chip or off-chip of the applications processor chip 1022. All items are assumed to be internal to an apparatus (such as a handset, base station, access point, gateway, PC, or other apparatus) except where the words “external to” are used with the name of the apparatus, such as “external to the handset.”

ROM 1032 provides a boot storage having boot code that is executable in at least one type of boot sequence. One or more of RAM 1034, internal flash 1036, and external flash 1024 are also suitably used to supplement ROM 1032 for boot storage purposes.

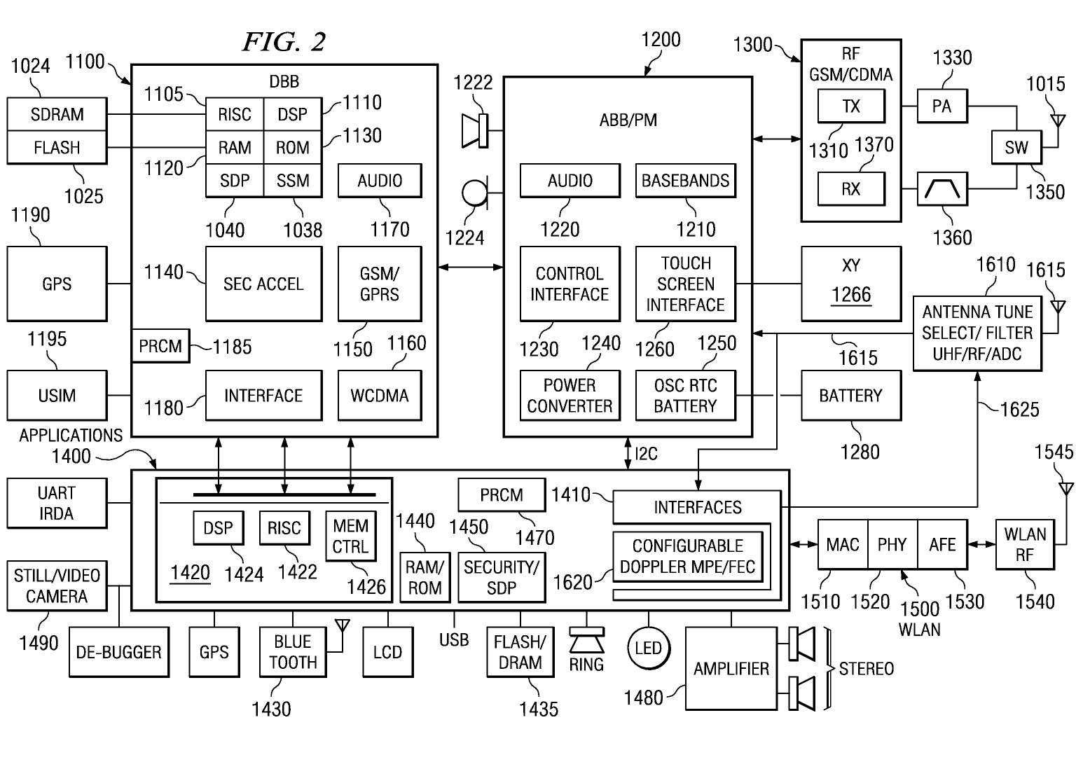

FIG. 2 illustrates inventive integrated circuit chips including chips 1100, 1200, 1300, 1400, 1500, 1600 for use in the blocks of the communications system 2000 of FIG. 1. The skilled worker uses and adapts the integrated circuits to the particular parts of the communications system 2000 as appropriate to the functions intended. For conciseness of description, the integrated circuits are described with particular reference to use of all of them in the cellular telephone handsets 2010 and 2010′ by way of example.

It is contemplated that the skilled worker uses each of the integrated circuits shown in FIG. 2, or such selection from the complement of blocks therein provided into appropriate other integrated circuit chips, or provided into one single integrated circuit chip, in a manner optimally combined or partitioned between the chips, to the extent needed by any of the applications supported by the cellular telephone base station 2050, personal computer(s) 2070 equipped with WLAN, WLAN access point 2060 and Voice WLAN gateway 2080, as well as cellular telephones, radios and televisions, Internet audio/video content players, fixed and portable entertainment units, routers, pagers, personal digital assistants (PDA), organizers, scanners, faxes, copiers, household appliances, office appliances, microcontrollers coupled to controlled mechanisms for fixed, mobile, personal, robotic and/or automotive use, combinations thereof, and other application products now known or hereafter devised for increased, partitioned or selectively determinable advantages.

In FIG. 2, an integrated circuit 1100 includes a digital baseband (DBB) block 1110 that has a RISC processor 1105 (such as MIPS core(s), ARM core(s), or other suitable processor) and a digital signal processor 1110 such as from the TMS320C55x™ DSP generation from Texas Instruments Incorporated or other digital signal processor (or DSP core) 1110, communications software and security software for any such processor or core, security accelerators 1140, and a memory controller. Security accelerators block 1140 provide additional computing power such as for hashing and encryption that are accessible, for instance, when the integrated circuit 1100 is operated in a security level enabling the security accelerators block 1140 and affording types of access to the security accelerators depending on the security level and/or security mode. The memory controller interfaces the RISC core 1105 and the DSP core 1110 to Flash memory 1025 and SDRAM 1024 (synchronous dynamic random access memory). On chip RAM 1120 and on-chip ROM 1130 also are accessible to the processors 1110 for providing sequences of software instructions and data thereto. A security logic circuit 1038 of FIGS. 1-3 has a secure state machine (SSM) 2460 to provide hardware monitoring of any tampering with security features. A Secure Demand Paging (SDP) circuit 1040 is provided for effectively-extended secure memory.

Digital circuitry 1150 on integrated circuit 1100 supports and provides wireless interfaces for any one or more of GSM, GPRS, EDGE, UMTS, and OFDMA/MIMO (Global System for Mobile communications, General Packet Radio Service, Enhanced Data Rates for Global Evolution, Universal Mobile Telecommunications System, Orthogonal Frequency Division Multiple Access and Multiple Input Multiple Output Antennas) wireless, with or without high speed digital data service, via an analog baseband chip 1200 and GSM/CDMA transmit/receive chip 1300. Digital circuitry 1150 includes a ciphering processor CRYPT for GSM ciphering and/or other encryption/decryption purposes. Blocks TPU (Time Processing Unit real-time sequencer), TSP (Time Serial Port), GEA (GPRS Encryption Algorithm block for ciphering at LLC logical link layer), RIF (Radio Interface), and SPI (Serial Port Interface) are included in digital circuitry 1150.

Digital circuitry 1160 provides codec for CDMA (Code Division Multiple Access), CDMA2000, and/or WCDMA (wideband CDMA or UMTS) wireless suitably with HSDPA/HSUPA (High Speed Downlink Packet Access, High Speed Uplink Packet Access) (or 1xEV-DV, 1xEV-DO or 3xEV-DV) data feature via the analog baseband chip 1200 and RF GSM/CDMA chip 1300. Digital circuitry 1160 includes blocks MRC (maximal ratio combiner for multipath symbol combining), ENC (encryption/decryption), RX (downlink receive channel decoding, de-interleaving, viterbi decoding and turbo decoding) and TX (uplink transmit convolutional encoding, turbo encoding, interleaving and channelizing.). Blocks for uplink and downlink processes of WCDMA are provided.

Audio/voice block 1170 supports audio and voice functions and interfacing. Speech/voice codec(s) are suitably provided in memory space in audio/voice block 1170 for processing by processor(s) 1110. An applications interface block 1180 couples the digital baseband chip 1100 to an applications processor 1400. Also, a serial interface in block 1180 interfaces from parallel digital busses on chip 1100 to USB (Universal Serial Bus) of PC (personal computer) 2070. The serial interface includes UARTs (universal asynchronous receiver/transmitter circuit) for performing the conversion of data between parallel and serial lines. A power resets and control module 1185 provides power management circuitry for chip 1100. Chip 1100 is coupled to location-determining circuitry 1190 for GPS (Global Positioning System). Chip 1100 is also coupled to a USIM (UMTS Subscriber Identity Module) 1195 or other SIM for user insertion of an identifying plastic card, or other storage element, or for sensing biometric information to identify the user and activate features.

In FIG. 2, a mixed-signal integrated circuit 1200 includes an analog baseband (ABB) block 1210 for GSM/GPRS/EDGE/UMTS/HSDPA/HSUPA which includes SPI (Serial Port Interface), digital-to-analog/analog-to-digital conversion DAC/ADC block, and RF (radio frequency) Control pertaining to GSM/GPRS/EDGE/UMTS/HSDPA/HSUPA and coupled to RF (GSM etc.) chip 1300. Block 1210 suitably provides an analogous ABB for CDMA wireless and any associated 1xEV-DV, 1xEV-DO or 3xEV-DV data and/or voice with its respective SPI (Serial Port Interface), digital-to-analog conversion DAC/ADC block, and RF Control pertaining to CDMA and coupled to RF (CDMA) chip 1300.

An audio block 1220 has audio I/O (input/output) circuits to a speaker 1222, a microphone 1224, and headphones (not shown). Audio block 1220 has an analog-to-digital converter (ADC) coupled to the voice codec and a stereo DAC (digital to analog converter) for a signal path to the baseband block 1210 including audio/voice block 1170, and with suitable encryption/decryption activated.

A control interface 1230 has a primary host interface (I/F) and a secondary host interface to DBB-related integrated circuit 1100 of FIG. 2 for the respective GSM and CDMA paths. The integrated circuit 1200 is also interfaced to an 12C port of applications processor chip 1400 of FIG. 2. Control interface 1230 is also coupled via circuitry to interfaces in circuits 1250 and the baseband 1210.

A power conversion block 1240 includes buck voltage conversion circuitry for DC-to-DC conversion, and low-dropout (LDO) voltage regulators for power management/sleep mode of respective parts of the chip regulated by the LDOs. Power conversion block 1240 provides information to and is responsive to a power control state machine between the power conversion block 1240 and circuits 1250.

Circuits 1250 provide oscillator circuitry for clocking chip 1200. The oscillators have frequencies determined by one or more crystals. Circuits 1250 include a RTC real time clock (time/date functions), general purpose I/O, a vibrator drive (supplement to cell phone ringing features), and a USB On-The-Go (OTG) transceiver. A touch screen interface 1260 is coupled to a touch screen XY 1266 off-chip.

Batteries such as a lithium-ion battery 1280 and backup battery provide power to the system and battery data to circuit 1250 on suitably provided separate lines from the battery pack. When needed, the battery 1280 also receives charging current from a Charge Controller in analog circuit 1250 which includes MADC (Monitoring ADC and analog input multiplexer such as for on-chip charging voltage and current, and battery voltage lines, and off-chip battery voltage, current, temperature) under control of the power control state machine. Battery monitoring is provided by either or both of 1-Wire and/or an interface called HDQ.

In FIG. 2 an RF integrated circuit 1300 includes a GSM/GPRS/EDGE/UMTS/CDMA RF transmitter block 1310 supported by oscillator circuitry with off-chip crystal (not shown). Transmitter block 1310 is fed by baseband block 1210 of chip 1200. Transmitter block 1310 drives a dual band RF power amplifier (PA) 1330. On-chip voltage regulators maintain appropriate voltage under conditions of varying power usage. Off-chip switchplexer 1350 couples wireless antenna and switch circuitry to both the transmit portion 1310, 1330 and the receive portion next described. Switchplexer 1350 is coupled via band-pass filters 1360 to receiving LNAs (low noise amplifiers) for 850/900 MHz, 1800 MHz, 1900 MHz and other frequency bands as appropriate. Depending on the band in use, the output of LNAs couples to GSM/GPRS/EDGE/UMTS/CDMA demodulator 1370 to produce the I/Q or other outputs thereof (in-phase, quadrature) to the GSM/GPRS/EDGE/UMTS/CDMA baseband block 1210.

Further in FIG. 2, an integrated circuit chip or core 1400 is provided for applications processing and more off-chip peripherals. Chip (or core) 1400 has interface circuit 1410 including a high-speed WLAN 802.11a/b/g interface coupled to a WLAN chip 1500. Further provided on chip 1400 is an applications processing section 1420 which includes a RISC processor 1422 (such as MIPS core(s), ARM core(s), or other suitable processor), a digital signal processor (DSP) 1424 such as from the TMS320C55x™ DSP generation and/or the TMS320C6x™ DSP generation from Texas Instruments Incorporated or other digital signal processor(s), and a shared memory controller MEM CTRL 1426 with DMA (direct memory access), and a 2D (two-dimensional display) graphic accelerator. Speech/voice codec functionality is suitably processed in chip 1400, in chip 1100, or both chips 1400 and 1100.

The RISC processor 1420 and the DSP 1424 in section 1420 have access via an on-chip extended memory interface (EMIF/CF) to off-chip memory resources 1435 including as appropriate, mobile DDR (double data rate) DRAM, and flash memory of any of NAND Flash, NOR Flash, and Compact Flash. On chip 1400, the shared memory controller 1426 in circuitry 1420 interfaces the RISC processor 1420 and the DSP 1424 via an on-chip bus to on-chip memory 1440 with RAM and ROM. A 2D graphic accelerator is coupled to frame buffer internal SRAM (static random access memory) in block 1440. A security block 1450 in security logic 1038 of FIG. 1 includes an SSM analogous to SSM 1038, and includes secure hardware accelerators having security features and provided for secure demand paging 1040 as further described herein and for accelerating encryption and decryption. A random number generator RNG is provided in security block 1450. Among the Hash approaches are SHA-1 (Secured Hashing Algorithm), MD2 and MD5 (Message Digest version #). Among the symmetric approaches are DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard). Among the asymmetric approaches are RSA, DSA, DH, NTRU, and ECC (elliptic curve cryptography). The security features contemplated include any of the foregoing hardware and processes and/or any other known or yet to be devised security and/or hardware and encryption/decryption processes implemented in hardware or software.

Security logic 1038 of FIG. 1 and FIG. 2 (1038, 1450) includes hardware-based protection circuitry, also called security monitoring logic or a secure state machine SSM. Security logic 1038 (1450) is coupled to and monitors busses and other parts of the chip for security violations and protects and isolates the protected areas. Security logic 1038 (1450) makes secure ROM space inaccessible, makes secure RAM and register space inaccessible and establishes any other appropriate protections to additionally foster security. In one embodiment such a software jump from Flash memory 1025 (1435) to secure ROM, for instance, causes a security violation wherein, for example, the security logic 1038 (1450) produces an automatic immediate reset of the chip. In another embodiment, such a jump causes the security monitoring logic 1038, (1450) to produce an error message and a re-vectoring of the jump away from secure ROM. Other security violations would include attempted access to secure register or RAM space.

On-chip peripherals and additional interfaces 1410 include UART data interface and MCSI (Multi-Channel Serial Interface) voice wireless interface for an off-chip IEEE 802.15 (Bluetooth and low and high rate piconet and personal network communications) wireless circuit 1430. Debug messaging and serial interfacing are also available through the UART. A JTAG emulation interface couples to an off-chip emulator Debugger for test and debug. Further in peripherals 1410 are an 12C interface to analog baseband ABB chip 1200, and an interface to applications interface 1180 of integrated circuit chip 1100 having digital baseband DBB.

Interface 1410 includes a MCSI voice interface, a UART interface for controls, and a multi-channel buffered serial port (McBSP) for data. Timers, interrupt controller, and RTC (real time clock) circuitry are provided in chip 1400. Further in peripherals 1410 are a MicroWire (u-wire 4 channel serial port) and multi-channel buffered serial port (McBSP) to Audio codec, a touch-screen controller, and audio amplifier 1480 to stereo speakers.

External audio content and touch screen (in/out) and LCD (liquid crystal display), organic semiconductor display, and DLPTm digital light processor display from Texas Instruments Incorporated, are suitably provided in various embodiments and coupled to interface 1410. In vehicular use, the display is suitably any of these types provided in the vehicle, and sound is provided through loudspeakers, headphones or other audio transducers provided in the vehicle. In some vehicles a transparent organic semiconductor display 2095 of FIG. 1 is provided on one or more windows of the vehicle and wirelessly or wireline-coupled to the video feed.

Interface 1410 additionally has an on-chip USB OTG interface couples to off-chip Host and Client devices. These USB communications are suitably directed outside handset 1010 such as to PC 1070 (personal computer) and/or from PC 1070 to update the handset 1010.

An on-chip UART/IrDA (infrared data) interface in interfaces 1410 couples to off-chip GPS (global positioning system block cooperating with or instead of GPS 1190) and Fast IrDA infrared wireless communications device. An interface provides EMT9 and Camera interfacing to one or more off-chip still cameras or video cameras 1490, and/or to a CMOS sensor of radiant energy. Such cameras and other apparatus all have additional processing performed with greater speed and efficiency in the cameras and apparatus and in mobile devices coupled to them with improvements as described herein. Further in FIG. 2, an on-chip LCD controller or DLPT controller and associated PWL (Pulse-Width Light) block in interfaces 1410 are coupled to a color LCD display or DLPTm display and its LCD light controller off-chip and/or DLPTm digital light processor display.

Further, on-chip interfaces 1410 are respectively provided for off-chip keypad and GPIO (general purpose input/output). On-chip LPG (LED Pulse Generator) and PWT (Pulse-Width Tone) interfaces are respectively provided for off-chip LED and buzzer peripherals. On-chip MMC/SD multimedia and flash interfaces are provided for off-chip MMC Flash card, SD flash card and SDIO peripherals.

In FIG. 2, a WLAN integrated circuit 1500 includes MAC (media access controller) 1510, PHY (physical layer) 1520 and AFE (analog front end) 1530 for use in various WLAN and UMA (Unlicensed Mobile Access) modem applications. PHY 1520 includes blocks for Barker coding, CCK, and OFDM. PHY 1520 receives PHY Clocks from a clock generation block supplied with suitable off-chip host clock, such as at 13, 16.8, 19.2, 26, or 38.4 MHz. These clocks are compatible with cell phone systems and the host application is suitably a cell phone or any other end-application. AFE 1530 is coupled by receive (Rx), transmit (Tx) and CONTROL lines to WLAN RF circuitry 1540. WLAN RF 1540 includes a 2.4 GHz (and/or 5 GHz) direct conversion transceiver, or otherwise, and power amplifer and has low noise amplifier LNA in the receive path. Bandpass filtering couples WLAN RF 1540 to a WLAN antenna. In MAC 1510, Security circuitry supports any one or more of various encryption/decryption processes such as WEP (Wired Equivalent Privacy), RC4, TKIP, CKIP, WPA, AES (advanced encryption standard), 802.1 li and others. Further in WLAN 1500, a processor comprised of an embedded CPU (central processing unit) is connected to internal RAM and ROM and coupled to provide QoS (Quality of Service) IEEE 802.11e operations WME, WSM, and PCF (packet control function). A security block in WLAN 1500 has busing for data in, data out, and controls interconnected with the CPU. Interface hardware and internal RAM in WLAN 1500 couples the CPU with interface 1410 of applications processor integrated circuit 1400 thereby providing an additional wireless interface for the system of FIG. 2.

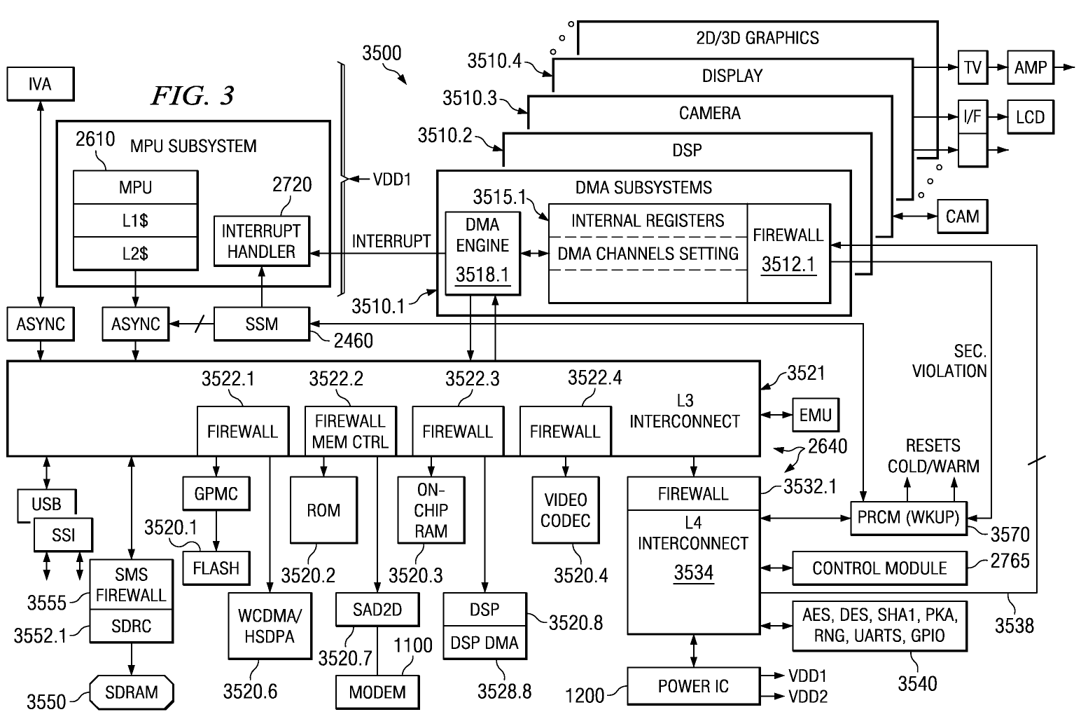

Still other additional wireless interfaces such as for wideband wireless such as IEEE 802.16 WiMAX mesh networking and other standards are suitably provided and coupled to the applications processor integrated circuit 1400 and other processors in the system. WiMax has MAC and PHY processes and the illustration of blocks 1510 and 1520 for WLAN indicates the relative positions of the MAC and PHY blocks for WiMax. See also description of FIGS. 3A and 3B hereinabove.

In FIG. 2, a further digital video integrated circuit 1610 is coupled with a television antenna 1615 (and/or coupling circuitry to share antenna 1015 and/or 1545) to provide television antenna tuning, antenna selection, filtering, RF input stage for recovering video/audio/controls from television transmitter (e.g., DVB station 2020 of FIG. 1). Digital video integrated circuit 1610 in some embodiments has an integrated analog-to-digital converter ADC on-chip, and in some other embodiments feeds analog to ABB chip 1200 for conversion by an ADC on ABB chip 1200. The ADC supplies a digital output to interfaces 1410 of applications processor chip 1400 either directly from chip 1610 or indirectly from chip 1610 via the ADC on ABB chip 1200. Applications processor chip 1400 includes a digital video block 1620 coupled to interface 1410 and having a configurable adjustable shared-memory telecommunications signal processing chain such as Doppler/MPE-FEC. See incorporated patent application TI-62445, “Flexible And Efficient Memory Utilization For High Bandwidth Receivers, Integrated Circuits, Systems, Methods And Processes Of Manufacture” Ser. No. 11/733,831 filed Apr. 11, 2007, which is hereby incorporated herein by reference. A processor on chip 1400 such as RISC processor 1422 and/or DSP 1424 configures, supervises and controls the operations of the digital video block 1620.

A GLOSSARY provides a list of some of the abbreviations used in this document.

### GLOSSARY OF SELECTED ABBREVIATIONS

ACK Acknowledge
AVS Adaptive Voltage Scaling
BIOS Basic Input Output System
CLK Clock
CM Clock Manager
COPR Coprocessor (skewed pipe or other auxiliary processor)
DFF D-Flipflop
DMA Direct Memory Access
DPLL Digital Phase Locked Loop
DPS Dynamic Power Switching
DSP Digital Signal Processor
DVFS Dynamic Voltage Frequency Scaling
D2D Device to Device
EMI Energy Management Interface
FIFO First In First Out (queue)
FSM Finite State Machine
GFX Graphics Engine
GPMC General Purpose Memory Controller
INTC Interrupt Controller
IVA Imaging, Video and Audio processor
LDO Low Drop Out regulator.
L1$, L2$ Level 1, Level 2 Cache
LS Level Shifter
MEM Memory
MPU Microprocessor Unit
OCP Open Core Protocol bus protocol
OPP Operating Performance Point
PLL Phase Lock Loop
POR Power On Reset
PRCM Power Reset and Clock Manager
PRM Power & Reset Manager
P1, P2 Peripheral domain, 1^{st} or 2^{nd}.
PSCON Power State Controller
REQ Request
RISC Reduced Instruction Set Computer
SDRAM Synchronous Dynamic Random Access Memory
SDRC SDRAM Refresh Controller
SGX Graphics engine
SLM Static Leakage Management
SMPS Switch Mode Power Supply
SMS SDRAM Memory Schedulerpt
SR Sensor Error unit
SRAM Static Random Access Memory
SSM Secure State Machine
UART Universal Asynchronous Receiver Transmitter (2-way serial interface)
VCON Voltage Controller
VDD Supply Voltage
VP Voltage Processor
WDT Watchdog Timer
WKUP Wakeup

In FIG. 3, a system 3500 has an MPU subsystem, an IVA subsystem, and DMA subsystems 3510.i. The MPU subsystem suitably has a RISC or CISC processor, such as a superscalar processor with L1 and L2 caches. The IVA subsystem has a DSP for image processing, video processing, and audio processing. The IVA subsystem has L1 and L2 caches, RAM and ROM, and hardware accelerators as desired such as for motion estimation, variable length codec, and other processing. DMA is integrated into the system 3500 in such a way that it can perform target accesses via target firewalls 3522.i and 3512.i of FIG. 3 connected on the interconnects 2640. A target is a circuit block targeted or accessed by an initiator. In order to perform such accesses the DMA channels are programmed. Each DMA channel specifies the source location of the Data to be transferred and the destination location of the Data.

Data exchange between the peripheral subsystem and the memory subsystem and general system transactions from memory to memory are handled by the System SDMA. Data exchanges within a DSP subsystem 3510.2 are handled by the DSP DMA 3518.2. Data exchange to refresh a display is handled in display subsystem 3510.4 using a DISP DMA 3518.4 (numeral omitted). This subsystem 3510.4, for instance, includes a dual output three layer display processor for 1xGraphics and 2xVideo, temporal dithering (turning pixels on and off to produce grays or intermediate colors) and SDTV to QCIF video format and translation between other video format pairs. The Display block 3510.4 feeds an LCD panel using either a serial or parallel interface. Also television output TV and Amp provide CVBS or S-Video output and other television output types. Data exchange to store camera capture is handled using a Camera DMA 3518.3 in camera subsystem CAM 3510.3. The CAM subsystem 3510.3 suitably handles one or two camera inputs of either serial or parallel data transfer types, and provides image capture hardware image pipeline and preview.

A hardware security architecture including SSM 2460 propagates qualifiers on the interconnect 3521 and 3534 as shown in FIG. 3. The MPU 2610 issues bus transactions and sets some qualifiers on Interconnect 3521. SSM 2460 also provides an MreqSystem qualifier(s). The bus transactions propagate through the L4 Interconnect 3534 and then reach a DMA Access Properties Firewall 3512. 1. Transactions are coupled to a DMA engine 3518.i in each subsystem 3510.i which supplies a subsystem-specific interrupt to the Interrupt Handler 2720. Interrupt Handler 2720 is also coupled to SSM 2460.

Firewall protection by firewalls 3522.i is provided for various system blocks 3520.i, such as GPMC to Flash memory 3520.1, ROM 3520.2, on-chip RAM 3520.3, Video Codec 3520.4, WCDMA/HSDPA 3520.6, MAD2D 3520.7 to Modem chip 1100, and a DSP 3528.8. Various initiators in the system are given 4-bit identifying codes designated ConnID. Some Initiators and their buses in one example are Processor Core MPU 2610 [RD, WR, INSTR Buses], digital signal processor direct memory access DSP DMA 3510 [RD, WR], system direct memory access SDMA 3510.1 [RD, WR], Universal Serial Bus USB HS, virtual processor PROC_VIRTUAL [RD, WR, INSTR], virtual system direct memory access SDMA_VIRTUAL [RD, WR], display 3510.4 such as LCD, memory management for digital signal processor DSP MMU, camera CAMERA 3510.3 [CAMERA, MMU], and a secure debug access port DAP.

The DMA channels support interconnect qualifiers collectively designated MreqInfo, such as MreqSecure, MreqPrivilege, MreqSystem in order to regulate access to different protected memory spaces. The system configures and generates these different access qualifiers in a security robust way and delivers them to hardware firewalls 3512.1, 3512.2, etc. and 3522.1, 3522.2, etc. associated with some or all of the targets. The improved hardware firewalls protect the targets according to different access rights of initiators. Some background on hardware firewalls is provided in incorporated patent application TI-38804, “Method And System For A Multi-Sharing Security Firewall,” Ser. No. 11/272,532 filed Nov. 10, 2005, which is hereby incorporated herein by reference.

The DMA channels 3515.1, .2, etc. are configurable through the L4 Interconnect 3534 by the MPU 2610. A circuitry example provides a Firewall configuration on a DMA L4 Interconnect interface that restricts different DMA channels according to the configuration previously written to configuration register fields. This Firewall configuration implements hardware security architecture rules in place to allow and restrict usage of the DMA channel qualifiers used in attempted accesses to various targets.

When an attempt to configure access for DMA channels in a disallowed way is detected, in-band errors are sent back to the initiator that made the accesses and out-band errors are generated to the Control Module 2765 and converted into an MPU Interrupt. Some background on security attack detection and neutralization is described in the incorporated patent application TI-37338, “System and Method of Identifying and Preventing Security Violations Within a Computing System,” Ser. No. 10/961,344 filed Oct. 8, 2004, which is hereby incorporated herein by reference.

In FIG. 3, the MPU 2610, Others block, and System DMA (SDMA) 3530.1, 3535.1 each supply or have some or all of the Mreqlnfo signals MreqSystem, MreqSecure, MreqPrivilege, MreqDebug, MreqType, and other signals for various embodiments. L4 Interconnect 3534 supplies the MreqInfo signals to the DMA Firewall and other firewalls 3512.i. Interconnect 3534 is also coupled to Control Module 2765 and cryptographic accelerator blocks 3540 and PRCM 3570.

A signal ConnID is issued onto the various buses by each initiator in the system 3500. The signal ConnID is coded with the 4-bit identifying code pertaining to the initiator originating that ConnID signal. System Memory Interface 3555 in some embodiments also has an adjustment made to ConnID initiator code so that if incoming ConnID=MPU AND MreqSystem=‘1’, then ConnID=MPU_Virtual. If incoming ConnID=SDMA AND MreqSystem=‘1’, then ConnID=SDMA_Virtual. In this way the special signal MreqSystem identifies a virtual world for these initiators to protect their real time operation. For background on these initiators and identifiers, see for instance incorporated patent application TI-61985, “Virtual Cores And Hardware-Supported Hypervisor Integrated Circuits, Systems, Methods and Processes of Manufacture,” Ser. No. 11/671,752, filed Feb. 6, 2007, which is hereby incorporated herein by reference.

The System Memory Interface SMS with SMS Firewall 3555 is coupled to SRAM Refresh Controller SDRC 3552.1 and to system SRAM 3550. A new ConnID is suitably generated each time the processor core MPU 2610 or system SDMA 3530.1, 3535.1 perform an access in the case when the MreqSystem qualifier is one (1).

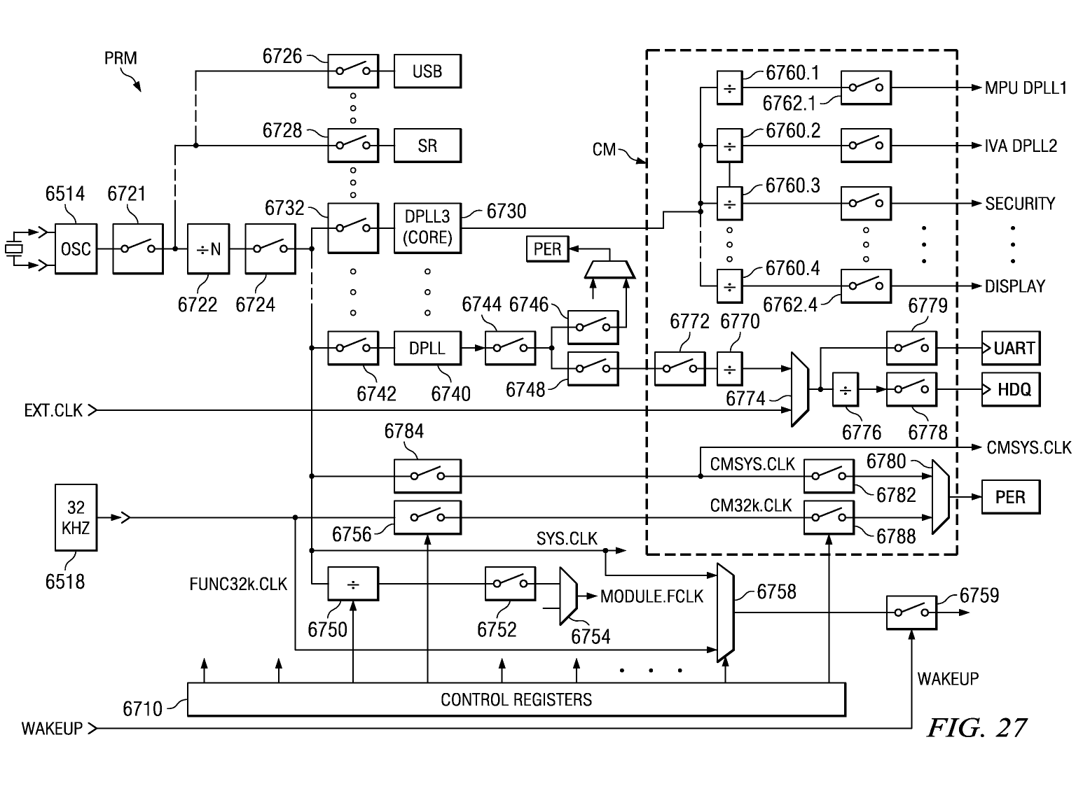

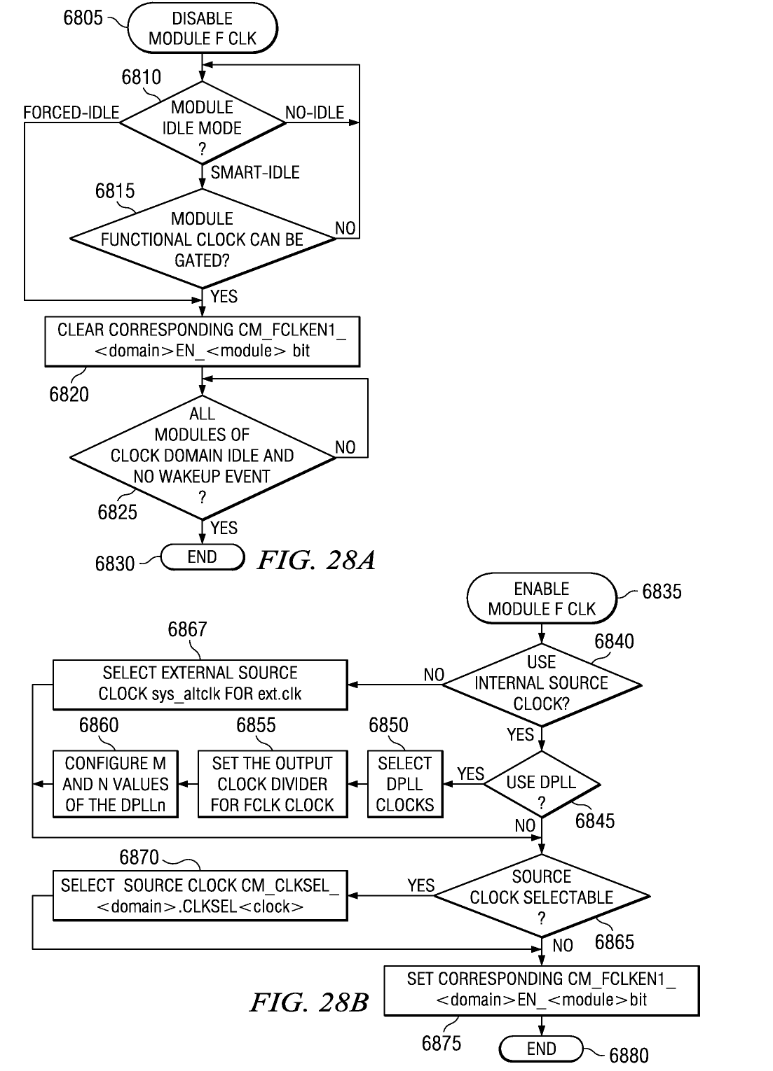

In FIG. 3, Control Module 2765 between Interconnect 3534 and DMA Firewall 3512.1 receives a Security Violation signal when applicable from DMA Firewall 3512.1. In FIGS. 27 and 28, a Flag pertaining to the Security Violation is activated in a Control_Sec_Err_Status register and is forwarded to SSM Platform_Status_Register. This flag is read on every Monitor Mode switch or otherwise frequently read, or interrupt handler 2720 generates an interrupt each time one of the Flag bits is updated or activated by the hardware.

In FIG. 3, PRCM 3570 is provided in a voltage domain called Wakeup domain WKUP. PRCM 3570 is coupled to L4 Interconnect 3534 and coupled to Control Module 2765. PRCM 3570 is coupled to a DMA Firewall 3512.1 to receive a Security Violation signal, if a security violation occurs, and to respond with a Cold or Warm Reset output. Also PRCM 3570 is coupled to the SSM 2460.

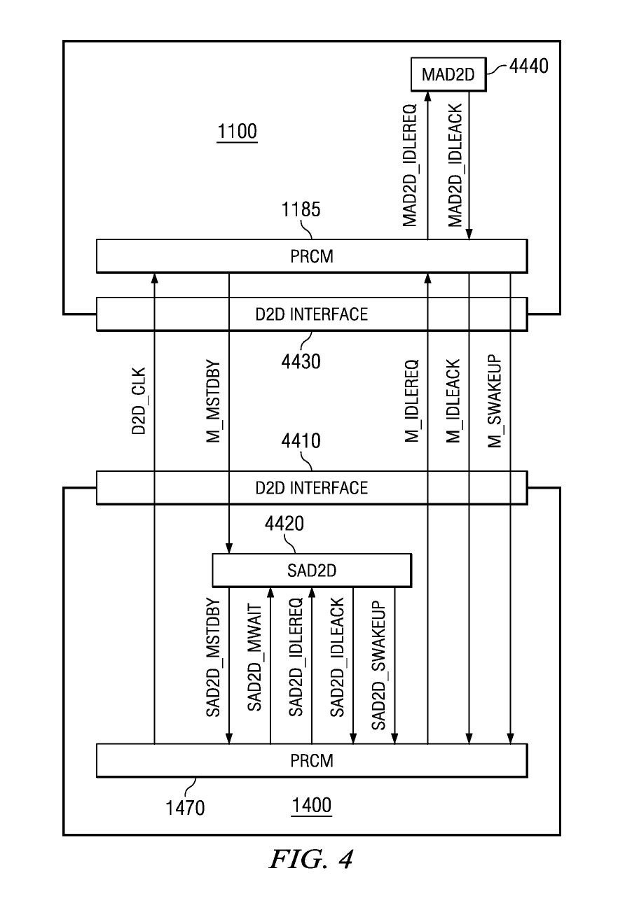

In FIG. 4, a stack die solution has the application processor chip 1400 coupled to the modem through a D2D interface. The PRCM interfaces with the D2D to manage the modem functional clock (system clock) using a smart idle protocol. The PRCM interfaces with the SAD2D module to manage the D2D OCP interface using a smart idle protocol and a smart standby protocol. This D2D embodiment allows independent gating of the Application processor chip 1400 OCP clock tree and the gating of the modem functional clock.

FIG. 4 illustrates the integration of application processor chip 1400 with a modem in a stack die solution and shows the interface between the PRCM and the D2D. The PRCM is programmed to allow automatic transition on the D2D clock domain in order to perform the sequences described in the next three paragraphs.

The SAD2D smart standby protocol allows the PRCM to initiate an idle transition on the D2D clock domain. The assertion of a SAD2D standby signal SAD2D_MStandby initiates an idle request on the D2D clock domain. Thus, an idle request signal SAD2D_IDLEREQ is asserted on the SAD2D slave interface and an idle request signal MODEM_IDLEREQ is asserted on a D2D slave interface. The PRCM gates the SAD2D OCP interface clock upon assertion of an SAD2D idle acknowledge signal SAD2D_IDLEACK.

As long as the modem is in a functional state wherein the modem functional clock is still requested, the modem can initiate OCP accesses on the D2D interface by de-asserting a standby signal MODEM_MSTDBY. This results in the assertion of a SAD2D wakeup signal SAD2D_SWAKEUP. The SAD2D OCP interface clock is restarted by the PRCM upon assertion of the SAD2D wakeup.

The modem enters the deep sleep state by acknowledging the D2D idle request by asserting the signal MODEM_IDLEACK. The PRCM will gate the modem functional clock upon assertion of the D2D Idle Acknowledge. The modem exits this deep sleep state by asserting a D2D wakeup signal MODEM_SWAKEUP. The SAD2D OCP interface clock and modem functional clock are each restarted by the PRCM upon assertion of the D2D wakeup.

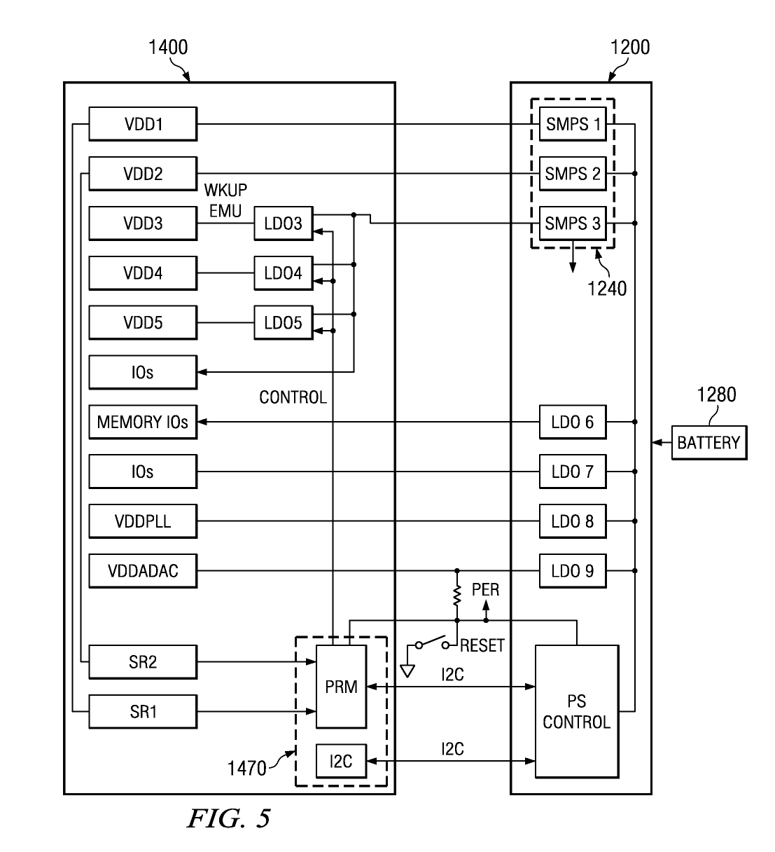

In FIG. 5, the MPU uses software control and a serial I2C interface, independent from PRM, to program the external power IC. Software can use the I2C interface to program any new operational VDD1/VDD2 voltage values. The I2C interface permits and facilitates changing of OPPs by programming fixed values. Moreover, the I2C interface facilitates more accurately regulating the OPP voltages to fit best power and performance requirements when Smart Reflex Class2 is operating. This mode of control need not or does not involve any PRM logic.

In addition to the VDD1 and VDD2 voltages controls, the PRM handles VDD3, VDD4, VDD5 and other voltages control. The PRM has operations to reduce SRAM LDOs voltage when all memories are in retention, reduce Wake-up LDO voltage when the device enters in OFF mode (Wake-up domain leakage reduction), increase Wake-up LDO voltage when emulation is active to support high performance tracing, active isolation of levels shifters during VDD1 and VDD2 removal, and active sleep mode in all analog cells when the device enters in OFF mode.

Two embedded SRAM LDOs supply regulated voltage (VDD4 or VDD5) to memory banks such as SRAM. These LDOs have three reference voltages—a normal voltage reference, used for processors OPP2, OPP3 and OPP4; a VDD1 overdrive voltage reference, when processors are operating at OPP 1. The SRAM LDO tracks and follows VDD1 voltage as soon as it exceeds OPP2 nominal voltage. A retention voltage is set for a reduced voltage whenever all memory banks belonging to the LDO are in Back-Bias retention mode. This allows dropping down the memory arrays in voltage to optimize leakage power savings. When not used (all memories OFF), the LDO is shut down (ON-OFF) control. These modes are automatically managed by hardware (PRM). The SRAM LDO has a Mux for reference voltages that are fed to a control circuit to deliver the memory array power supply VDD4 or VDD5.

An embedded wake-up LDO supplies voltage for both Wake-Up domain and Emulation domain. This LDO is permanently active, and continuously feeds the Wake-Up domain. It embeds a switch, controlled by the PRM which controls power of the Emulation domain. This switch is closed upon software request command when a debug session starts, or automatically upon JTAG plug detection. This LDO has three reference voltages—a normal voltage reference used in device active mode, a VDD1 overdrive voltage reference used when emulation is activated and MPU emulation trace is required, and a third voltage set when the device is in low power mode (OFF mode), in order to optimize leakage power savings. All these modes are automatically managed by hardware. The Wakeup LDO has a Mux for reference voltages. The Mux feeds a control circuit that delivers Wakeup and EMU power supply.

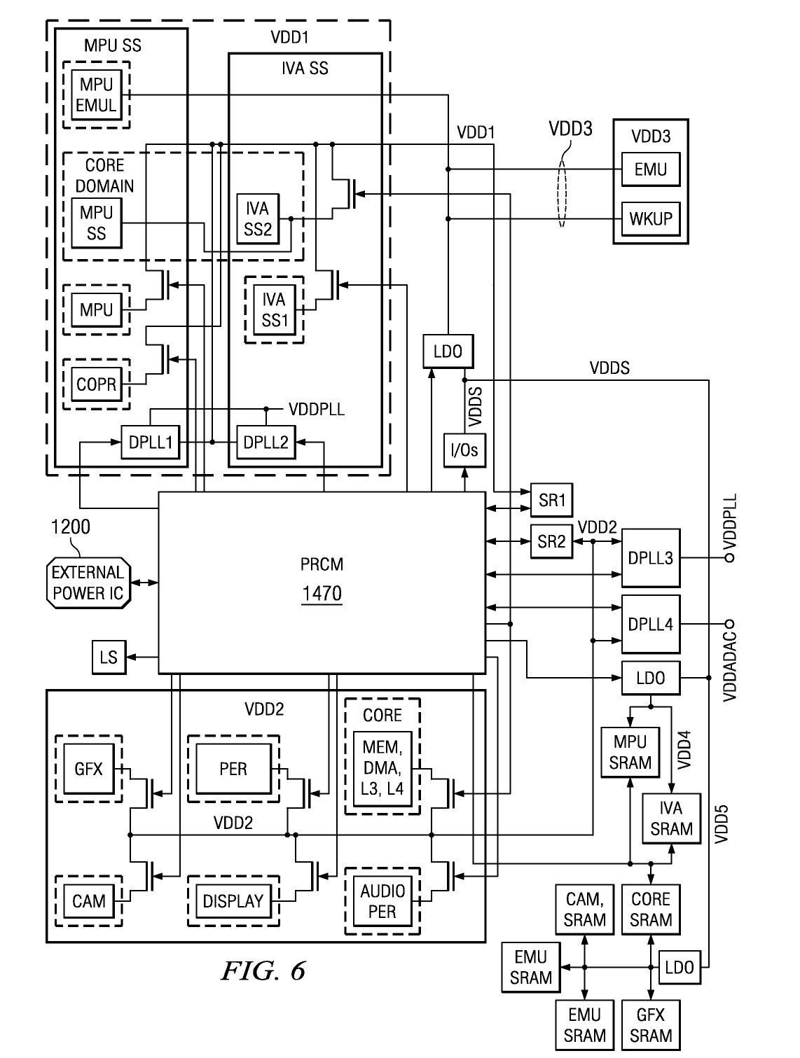

In FIG. 6, a Power and Resets Control Module PRCM 1470 in application processor integrated circuit 1400 (and/or circuit 1200) is coupled to a power integrated circuit 1200. Read FIG. 6 together with FIG. 5. PRCM 1470 provides independently controllable clocks at various configurable and adjustable clock rates to DPLL1, DPLL2, DPLL3, DPLL4. PRCM 1470 also delivers respective control signals to turn respective power switch transistors off or on to power various power domains. A VDD1 voltage domain has plural power domains for each of MPU and IVA. A Core domain has various power domains with respective power switch transistors that couple in voltage VDD2 under control of PRCM 1470. PRCM 1470 controls various Level Shifters LS. Voltage VDDPLL from power IC 1200 supplies voltage for DPLL1 and DPLL2, see also FIG. 5. The voltages VDD2 and VDDPLL are supplied for DPLL3, and the voltages VDD2 and VDDADAC are supplied for DPLL4. Thus, respective LDOs in FIG. 5 are connected to and supply their voltages to corresponding voltage rails for voltages VDD 1 and VDD2 in FIG. 6.

A pair of sensors SR1 and SR2 are respectively supplied with voltages VDD1 and VDD2. Sensors SR1 and SR2 provide respective sensor outputs to PRCM 1470.

Voltage VDDS from FIG. 5 is coupled to LDOs which respectively provide voltages VDD3, VDD4, VDD5. A VDD3 voltage domain has power domains for Emulator and Wakeup WKUP. A VDD4 voltage domain has power domains for MPU SRAM and IVA SRAM. A VDD5 voltage domain has power domains for Core SRAM, GFX SRAM, CAM SRAM, EMU SRAM, and other SRAM. Voltage switching transistors are provided for the respective power domains in the VDD3, VDD4, and VDD5 voltage domains and are not shown in the drawings for conciseness.

In most of the cases, a power domain is supplied by a single power supply as in FIGS. 5 and 6. The Core power domain is an exception in an example system wherein the Core power domain is spread over two voltage domains and three sub-systems. Voltage VDD1 is not set in retention or in OFF mode, independently from VDD2. The reason is that the daisy chains going through VDD1 voltage domain are disabled if VDD1 is at retention level, or dropped down to 0V. This then prevents any control of Core power domain when VDD2 stays active.

In FIGS. 5 and 6, the PRM manages sources of voltage as follows: Processors voltage (VDD1), Core voltage (VDD2), Wake-up voltage (VDD3), Processors SRAM voltage (VDD4), and Core SRAM voltage (VDD5). Other voltages VDDS, VDDPLL, VDDDLL, etc. in the device are directly controlled from the external device or controlled by software through an I2C interface independent from the PRM (VDDADAC).

Voltage control in applications processor chip 1400 is mainly handled by the PRM, according to 2 control types: 1) Memories LDOs (VDD4, VDD5) and Wake-up LDO (VDD3) direct control, and 2) Power IC control through PRM I2C interface (VDD1, VDD2). Additional device I2C interface, independent from PRM, allows Power IC programming MMC, VDDS and VDDADAC voltage control.

FIG. 5 shows power supplies distribution and control and connections of an application processor 1400 and a Power IC 1200. For system power-up sequencing reasons, memories IOs have a power rail independent from the other IOs. Depending on system context, the user can choose to supply memories IOs either from the power IC 1200 (and potentially share the LDO used for other IOs), or from any other power IC (such as a separate modem power IC).

In FIG. 6, the voltage domains have hardware dependencies between the various voltages. The PRCM 1470 manages these dependencies to process proper sleep and wake-up sequences. In an example, let all the VDD1, 2, 4, 5 ON/Ret/OFF depend on VDDS being on. VDD3 has states of Nominal, Low Power and Emulator (Emu). Also, for VDD1 to go ON, then depend on VDD2 to be ON. For VDD1 to go in Retention or OFF, then let the dependency be upon the corresponding request for VDD2 Retention or OFF. Further, let VDD1 to go OFF depend on VDD4 being OFF. For VDD2 to go ON or in Retention, then let the dependency be upon VDD1 ON or Retention being correspondingly requested. For VDD 1 to go OFF depends on VDD1 and VDD5 to be off. Further for VDD4 to go ON depends on VDD1 to be either in ON or Retention, and same dependence applies for VDD4 to go into Retention. Likewise, for VDD5 to go ON depends on VDD2 to be either in ON or Retention, and same dependence applies for VDD5 to go into Retention. Some dependencies such as keeping VDDPLL voltage when VDD1 and VDD2 are functional are under user responsibility.

A power-efficient DVFS/DPS result is achieved with minimum voltage, hence low power. Combined DVFS and DPS are established in power management structure and process.

Processor engines for battery powered devices such as PDA or smart cell phone have increased requirements in term of feature complexity and performance. To address these requirements advanced power management processes are provided herein, such as Dynamic Voltage and Frequency Scaling (DVFS), Dynamic Power Switching (DPS) and Adaptive Voltage Scaling (AVS) as described herein. All these processes have their respective advantages and are often more efficient for a given source of power consumption (active/standby).

These processes also have specific practical constraints. For example, hardware complexity and process complexity are increased when more voltage and frequency levels are provided in DVFS, because the resulting number of OPPs (Operating Performance Point [V,F]) for DVFS increases at least as much or more than the number of permitted voltage levels and number of permitted clock frequencies. In DVFS, supply voltage V is scaled to a lowest adequate voltage sufficient to deliver various operation modes and frequencies currently predicted as needed for processing and system bandwidth at different moments in operation.

The different power management processes may also appear sometimes to have conflicting goals. For example, DVFS tends to minimize the idle time of the system while DPS, by contrast, tends to maximize this idle time. DVFS pairs Voltage and frequency to form OPPs (operating performance points) of different predetermined voltage and frequency. By contrast, with AVS power management the voltage is variable instead of predetermined since the voltage is dynamically set by the hardware for each device.

Some embodiments herein combine all these power management processes in spite of their apparent contradictoriness, conflict and practical constraints. In this way, an even higher relative power saving and power management efficiency is synergistically conferred on all the circuits, domains, areas, and regions of power consumption in a given system.

Some embodiments combine any two or more of DVFS, DPS and AVS power management processes in order to optimize the power saving in all modes of operation and for all sources of power consumption. Power and performance optimization architecture concurrently or simultaneously adapts to variations of wafer fabrication process, variations of temperature, and to changing speed requirements.

Power savings associated with adjusting the supply voltage are combined with both changes in the performance requirements and changes in environmental variables, such as temperature and wafer fabrication process. For each operating point, reduced active power and reduced leakage power are sought. Dynamic voltage frequency scaling (DVFS), Dynamic Power Switching (DPS), and adaptive voltage scaling (AVS, SmartReflex™ power management from Texas Instruments Incorporated) are combined in some embodiments to minimize the power consumption of a device in plural, many, most, or all operating modes. Some embodiments, utilizing all three of DVFS, DPS, and AVS achieve greater power reduction than any one of DVFS, DPS, and AVS alone.

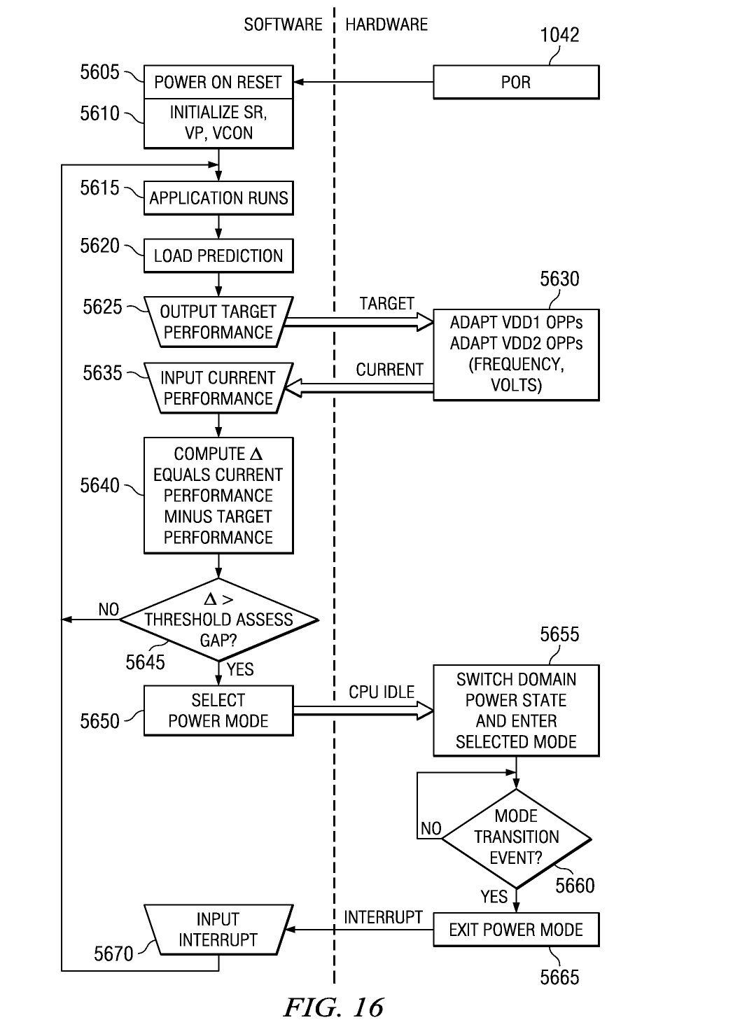

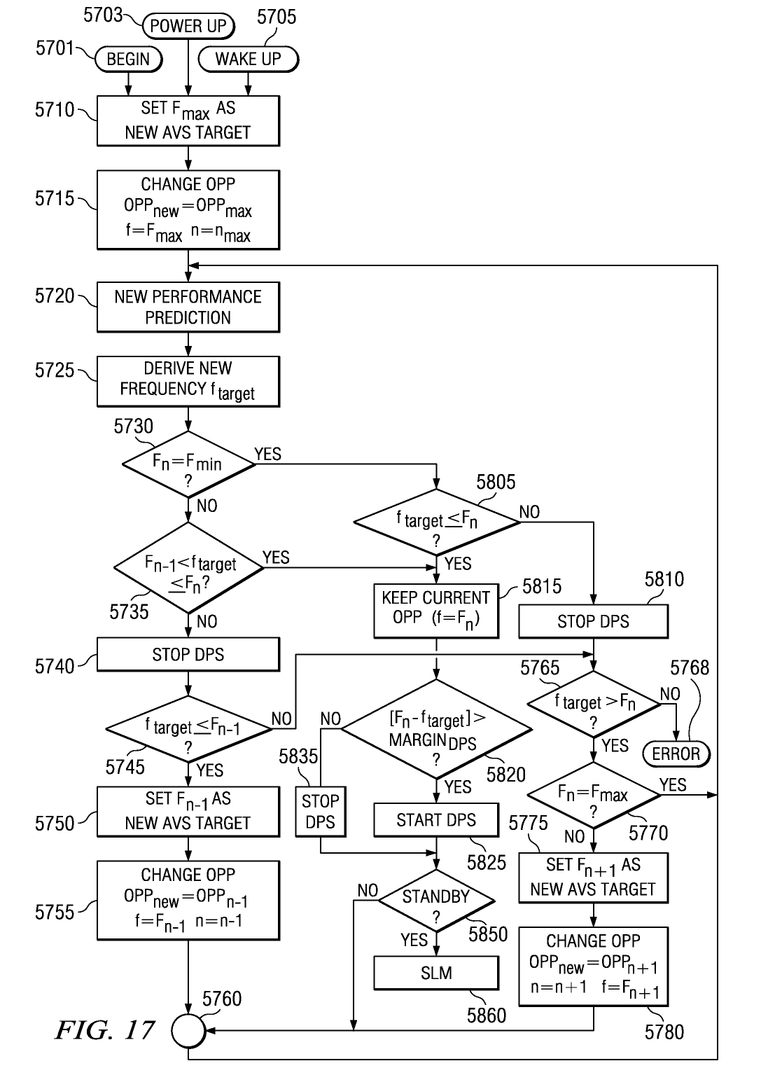

Some embodiments involve a power management policy for a system that describes when OPP change is performed (DVFS) and when DPS is started or stopped. Various power management process embodiments provide a more power efficient behavior of the system by combining the processes. See FIGS. 16-17.

The system includes a processor and/or any collection of modules that can be characterized by a performance requirement. The performance is defined, for instance, as a percentage (%) of maximum performance or maximum bandwidth and is translated into a target frequency of operation ftarget. The system is characterized for a given number of OPPn (operating performance point), each indexed by a value of an index n. Each OPPn corresponds to a pair (Fn, Vn) representing its frequency Fn and supply voltage Vn.

DFVS dynamically changes the OPP for various power domains in a system. When DPS is started, a given domain is switched dynamically between its Active state and a low power state (OFF, Retention, inactive). In some embodiments of DPS herein, supply voltage V is scaled to a) lowest adequate DVFS voltage in operation and b) a substantially lower leakage-reducing voltage or to zero when deep-sleep. Adaptive voltage scaling (AVS) is used to adjust and set an actual minimum appropriate voltage in the vicinity of a voltage Vn defined by DVFS for a current OPPn.

Substantial power savings result by combining processes and structures that synergistically act in different and even contradictory ways on the power consuming modules. An optimum combination resolves potential conflicts between different processes and structures and is widely applicable to various types of systems.

Hardware support is provided herein for multiple power management strategies for an application processor. Some embodiments of power management strategies synergistically combine any two or more of the following:
Dynamic Voltage and Frequency Scaling (DVFS)
Adaptive Voltage Scaling (AVS)
Dynamic Power Switching (DPS)
Static Leakage Management (SLM)
Other Power Management (OPM).

Standby Leakage Management (SLM) improves standby time. SLM switches the device into ultra-low power modes when no applications are running. SLM saves more power while increasing the wakeup latency. SLM switches the module clocks statically between On and Off and likewise switches one or more power domains statically between On and Off. SLM lowers the voltage substantially or shuts down applicable external and/or internal voltage regulators.

Adaptive Voltage Scaling (AVS) herein improves active power consumption and performance. For any given frequency of operation AVS adapts the voltage of each device individually according to its temperature and silicon performance determined by conditions of the silicon fabrication process or other semiconductor materials fabrication process. AVS automatically senses on-chip delay. AVS automatically adjusts the external voltage regulator according to the temperature and silicon performance.

Dynamic Voltage and Frequency Scaling (DVFS) also improves active power consumption and performance. DVFS dynamically adapts the voltage and frequency of operation of the device to the required performance of a given application or set of applications. DVFS predicts system load, adjusts the device frequency such as by software, and adjusts the device voltage such as by software and by AVS hardware if AVS is also enabled.

Dynamic Power Switching (DPS) improves active time. Based on to the hardware resources activity, as indicated by FIFO buffer status, for instance, DPS switches the device dynamically from any of several medium power modes (see TABLES 2-4 later hereinbelow) to a lower power mode during application execution or to a low power Standby mode of TABLE 5. DPS predicts system load and switches the module clocks dynamically between On and Off modes. DPS switches one or more power domains dynamically between On and Retention, or between On and Off. DPS provides automatic hardware detection of conditions (e.g. FIFO fill status or IO hardware signals) for sleep and wakeup transition for clock and power. DPS performs hardware management of sleep and wakeup dependency between the power domain, and hardware handshaking with modules.

Active power consumption refers to the power consumption of the system during the active time, namely when some processing is on-going. The active power consumption is composed of dynamic power consumption (transistor switching) and leakage power consumption.

Standby power consumption refers to the power consumption of the system during standby time, namely when no processing (or very limited processing) is ongoing and the system is waiting for a wakeup event. The standby current consumption is composed mostly of leakage consumption and very limited amount of dynamic power consumption.

Dynamic Voltage and Frequency Scaling (DVFS) power management reduces active power consumption by reducing both dynamic and leakage power consumption. With DVFS combined with AVS, the system dynamically adapts its supply voltage Vn and operating frequency Fn to achieve the performance required by the operations in process. Applying DVFS, a processor or a system runs at the lowest OPPn representing a (frequency, voltage) pair operating point that is adequate to deliver the desired performance at a given time, and then AVS herein adjusts the voltage in the vicinity of OPPn voltage Vn for the particular environment.

In some embodiments, DVFS is applied to the Processor domain while the device Core domain that represents a large part of the logic is held at a lower and fixed voltage most of the time. In this way, power is conserved because a large part of the device always works at lower than nominal voltage. Also, the DVFS hardware and software are simplified because the Core domain interconnect, memory interfaces and peripherals are working at fixed voltage and frequency.

In some other embodiments allowing for lower interconnect bandwidth herein, DVFS is independently applied to the device Core domain. As used here the Core domain involves the interconnect and interfaces exclusive of the processor cores. In this case, the DVFS voltage in the Core domain is reduced to the minimum value that still allows the peripherals to be kept working at their nominal functional clock while their interface frequency is reduced. Further power savings are achieved and some DVFS software overhead is acceptable to accomplish the power savings.

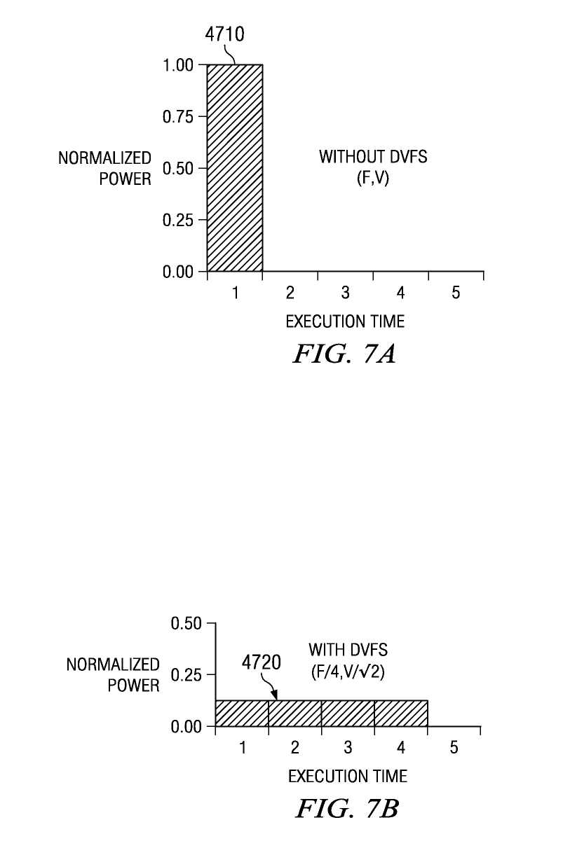

In FIGS. 7A and 7B, DVFS substantially minimizes the idle time of the system. DVFS primarily saves active power consumption, where power consumption is proportional to the multiplicative product CV²F of capacitance C, square of voltage V, and clock rate or frequency F.

In some embodiments of power management herein, an application processor system on a chip (SOC) features multiple on-chip voltage domains. The Core domain may cover an extensive portion of the SOC and works at a fixed voltage—as low as interconnect performance permits—while DVFS is applied to the processors. DVFS power management of the processors can produce more power savings than power management of interconnect in some of the power management operating scenarios.

In application scenarios allowing even lower interconnect bandwidth, the application processor and system are further arranged and coupled to apply DVFS to the Core domain and peripheral blocks. In this case, the Core domain voltage can be reduced by independent DVFS applied to the Core domain to the minimum value that allows the peripherals to keep working at their nominal functional frequency and with reduced interface clock between peripherals and the Core domain.

Splitting the voltage paths and their controls to memory and to logic associated with memory allows using the full operating voltage range of the logic gates. In some integrated circuit fabrication process technologies, the operating voltage range of the logic gates is likely to be larger than the memory operating range. By splitting the voltage paths, voltage for memory cells need not be a limiting factor when scaling the supply voltage for logic gates associated with the memory cells.

Three (3) programmable DPLLs are provided in an example and allow fully independent DVFS/AVS scaling of microprocessor MPU frequency and IVA (imaging, video and audio) processor frequency and Core domain interconnect frequency. A selection of clock dividers on the DPLL output provide a wide range of clock rate division ratios and support dynamic frequency scaling without incurring DPLL re-lock time.

One or more asynchronous interfaces ASYNC (FIG. 3) are provided to couple the processors MPU and IVA to the Core domain interconnect such that the frequency of the processors MPU and IVa can be set freely and scaled while keeping interconnect and memory interfaces at another frequency determined for them. This avoids software overhead of re-configuring a memory interface when MPU and/or IVA processor frequency is changed by DVFS/AVS.

Another one or more DPLLs supply Core domain modules and peripheral (PER) blocks P1 and P2 with their appropriate functional clock(s). This makes it unnecessary to reconfigure Core domain and peripheral blocks each time the processing frequency of MPU and/or IVA is scaled. Software overhead is valuably reduced.

The AVS module automatically hardware-adapts the respective supply voltage of each of the voltage domains in accordance with their clock frequencies. The AVS module works under software configuration for pre-selected operating frequencies.

A hardware interface to an external power IC of FIG. 5 is used to control each switch mode power supply (SMPS) in the external power IC.

Power managed split-rail SRAM has split logic/array voltage with built in level shifters and power switch transistor or power switch circuit. Periphery logic and memory array each have a built-in power switch. The split-rail approach establishes a built-in isolation between logic and array, and provides a built-in diode for source biased retention state.

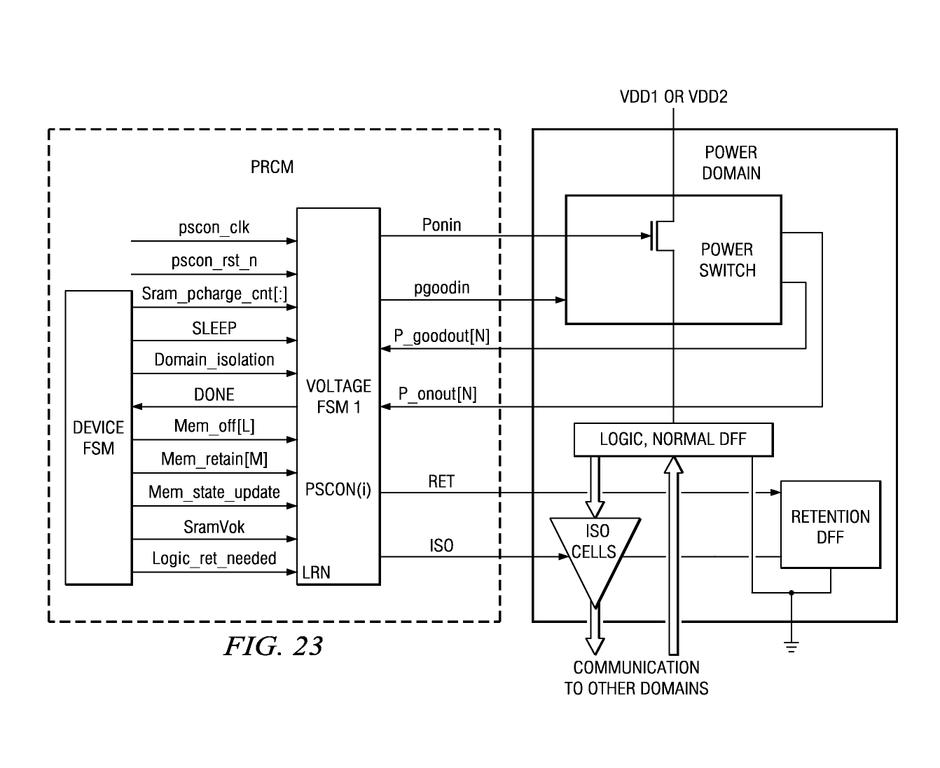

Retention power management of FIG. 23 holds logic states in retention flip-flops constructed and operated for low power dissipation. Associated combinational logic is powered down.

Voltage domain partitioning is sufficiently numerous or granular to power manage areas of the chip that have different usage patterns. Flexible control of clock frequency is provided for MPU, imaging, video and audio processor (IVA), and memory system with interconnect and DDR (double data rate) memory interface. Those domains for MPU, IVA and Core domain are clocked with independent DPLLs. Thus DPLL frequencies are not and need not be correlated. A selection of DPLL post dividers allows scaling the frequency while avoiding DPLL relock. Peripherals are structured so that functional clocks can be kept at constant frequency at all operating points while interface clocks are scaled.

The MPU and imaging, video and audio processor (IVA) voltage domains are controlled by two independent AVS circuits having an AVS ring oscillator in each sensor module SR and further having voltage processors VP. These continuously monitor temperature for adaptation. One wakeup voltage domain and two memory array voltage domains are also provided.

Scalable voltage domains are provided for CMOS digital logic. Split rail memory array for processor caches and core memories and analog cells (DPLL, VDAC, etc.) have built-in LDO (low drop out) regulators. Each LDO regulator is supplied with power supply voltage sufficiently higher than any voltage to be delivered from the LDO so that the LDO is able to effectively regulate the supply voltage that the LDO in turn delivers to power consuming circuitry. Appropriate power supply partitioning and control are established. Hardware control of a dedicated 12C interface provides continuous and autonomous closed loop control of the processor and core voltage domains. On-chip LDO regulators supply memory array, wakeup domain and analog cells such as DPLL, DLL, and so on.

Multiple Operating Performance Points (OPPs) are provided. In one example, four OPPs for an MPU domain and another pair of four OPPs are tailored to an imaging, video and audio processor (IVA) domain. In one embodiment of FIG. 6, the MPU and IVA have the same voltage VDD1 and can be operated at different frequencies using the respective DPLL1 and DPLL2 for them. In another embodiment, independent different voltages are provided for each of MPU and IVA as well. Another two DVFS OPPs are provided for voltage VDD2 to the Core domain in FIG. 6. A wakeup domain WKUP has an operating voltage VDD3 and a sleep voltage that is lower than the operating voltage. MPU and IVA caches are supplied with a voltageVDD4 in a manner that generally tracks the voltage VDD1 provided to the processor logic.

Each OPP voltage value is dynamically and optimally selected using DVFS and is respectively scaled by AVS adaptive voltage scaling herein in response to the respective sensors SR1, SR2 in steps of approximately 1% of the voltage delivered. The steps are suitably made a constant incremental voltage value on the order of 0.1% to 5% of the actual voltage delivered at any given OPP.

The operating voltages and operating voltage ranges are established based on the characteristics of the wafer fab process node (e.g., semiconductor materials, transistor dimensions) from which the integrated circuit is prepared. For example, the voltages and voltage ranges would likely be different for 90, 65, 45, 32, 22, etc. nanometer process nodes. The retention voltage(s) used is generally lower than any OPP voltage. The retention voltage(s) is suitably one (or two or more) voltages respectively suited to different storage element types (flip-flop, SRAM cell, etc.) based on the minimum voltage that is needed for data to be reliably retained therein.

TABLE 1
POWER STATES

| | Switch | | Power | | | |
|---|---|---|---|---|---|---|
| | | Mem- | | Mem- | | State |
| Power state | Logic | ory | Logic | ory | Clocks | retention |
| ACTIVE | Closed | Closed | On | On | On | All |
| | | | | | (at least | |
| | | | | | one) | |
| INACTIVE | Closed | Closed | On | On | All Off | All |
| RETENTION | Open | Open or | On or | On or | All Off | All or part |
| | or | closed | Off | Off | | |
| | closed | | | | | |
| OFF | Open | Open | Off | Off | All Off | None |

Power states relate to a given power module in the device, see TABLE 1. For a processor core, additional power states can have cache L2$ in retention with cache L1$ off, or have cache L1$ on and cache L2$ in retention.

By contrast to power states, power modes relate to the whole device. In some embodiments, power states are pre-defined by hardware and power modes are defined by software. Power modes are any relevant combination of domain power states to accomplish the operations represented by the software or specified by a state machine, for instance, in hardware. Power modes are characterized by total device (chip) power consumption, wakeup latency and level of functionality supported.

Types of power modes are Active power modes and the Standby power modes. An Active power mode is defined by any valid combination of domain power states in which one or more power domains are still in a fully powered and function (active) power state whether some software is still running or not. See, e.g., TABLES 2-4 later hereinbelow. A Standby power mode is defined by any valid combination of domain power states in which all the domains are either in inactive, retention or off power state, see, e.g., TABLE 5 hereinbelow.

Power domains are groups of modules on-chip that are independently supplied with power through embedded power switches. A power domain can be a subset of a voltage domain, or a power domain can be functionally split over two or more voltage domains.

By turning a power domain switch off and on, power is removed and restored to a power domain without impact to the regulator supplying the voltage domain(s). Large power saving with relatively short wakeup latency beneficially results, since switching transitions are faster than regulator voltage ramps.

Power domains are physically defined by the power rail that actually supplies the circuitry in a module. Power domains are functionally defined by the signal(s) that actually controls the switch. A single functional power domain can be composed of two physical power domains with their switch control inputs tied or connected together. A physical power domain is a subset of a voltage domain while a functional power domain can be split over two or more voltage domains.

In FIGS. 7A and 7B, an operational example of DVFS shows overall energy dissipation is cut in half by reducing the voltage to 70% (reciprocal of square root of two). In FIG. 7A, without DVFS, a process 4710 is run at full frequency F and voltage V and consumes normalized power of 1.0 units. In FIG. 7B, the voltage is reduced to

0.7 V. Power managed operation is facilitated in this example at normalized power of one-eighth unit (0.125) by also reducing the frequency to F/4, one-fourth frequency F, and then running the process four times as long which spreads out the process as a wide process bar 4720.

The latter two parameters—cutting frequency and running the process longer—cancel out in an energy consumption calculation, leaving the net benefit of voltage-squared equal to one-half energy consumption. Power units are watts (W), execution time is in seconds (s) or clocks, and energy dissipation is in watt-seconds or joules (J).

The deployment of DVFS in some embodiments has appropriate software support performance prediction software to predict dynamically the performance requirement of the application(s) running on the processor. In some embodiments, the performance prediction software also predicts interconnect bandwidth requirements. Software flexibly accommodates any one or combination of performance prediction processes and system power management processes described herein or known to the power management art now or in the future.

Adaptive voltage scaling (AVS) provides a power management process that reduces active power consumption, including both dynamic and leakage power consumption. Using AVS, the power supply voltage is adapted to the silicon performance either from a static sense (e.g. adapted to the manufacturing process of a given device), or a dynamic sense (e.g. adapted to the temperature induced current performance of the device).

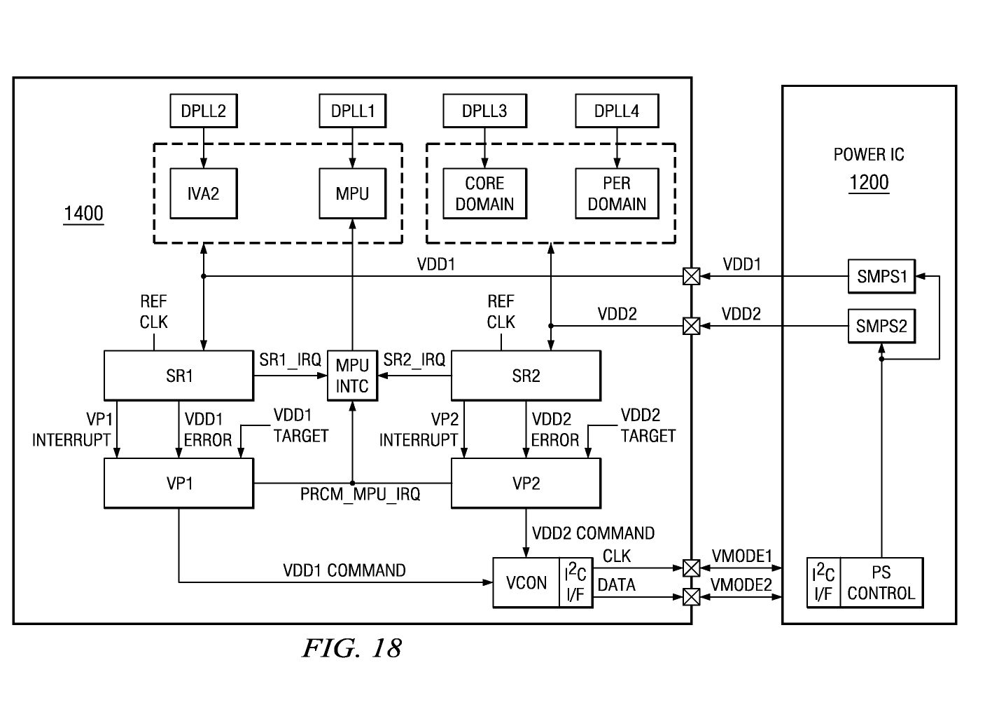

Description temporarily turns now to FIGS. 18-21. In AVS herein, one or more sensor modules SR1, SR2 having ring oscillators or delay lines are established on the physical silicon of an application processor integrated circuit chip. The ring oscillators by their frequency output gauge the performance of the silicon within the current environment established by the integrated circuit fabrication process in which the chip was made, the currently-applied operating voltage, and the currently-existing operating temperature at a present moment of run-time. See for some background, e.g., US Patent Application Publication US2005/0194592 dated Sep. 8, 2005, which is hereby incorporated herein by reference. A delay line approach to AVS measures the time delay that a delay line on the particular semiconductor material at a given temperature produces.

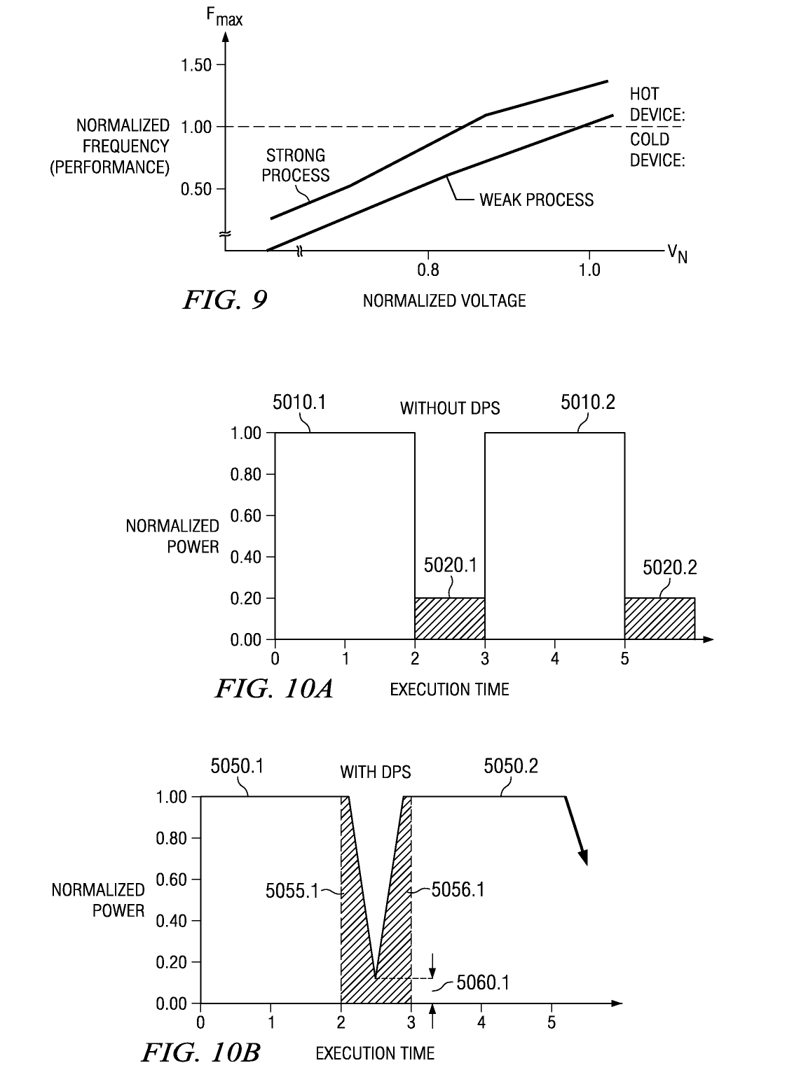

These environmental factors are expressed as a vector (Process, Voltage, Temperature) on which the maximum operating frequency of the chip depends, as indicated by the graph of FIG. 9. The circuit continuously compares the expected oscillator frequency REFCLK or expected delay line delay for each pre-defined OPP to the on-chip measured frequency of the oscillator. A digital circuit is provided to provide clock generation and control and generates stable clock references to the sensor core, provides a Min/Max/Average, and generates statistics about silicon performance over time. An error generator calculates the percentage frequency error when compared to targeted silicon performance.

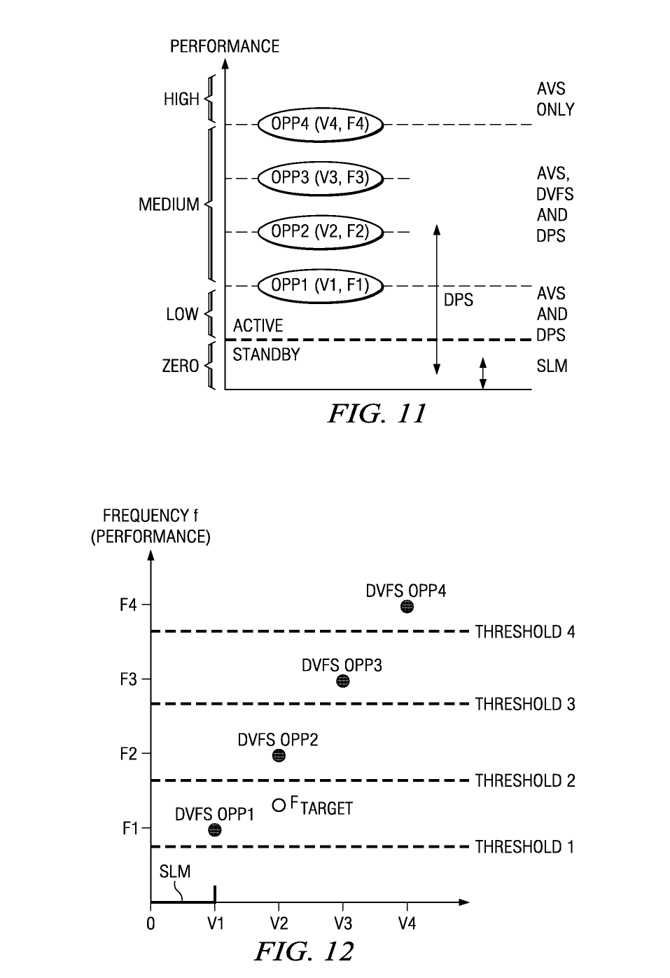

For each voltage domain, there are pre-defined OPPs of FIGS. 11-12. To each OPP corresponds an N-count value that is set, configured into, or built into sensor SR and which represents a simulated or reference oscillator frequency. This N-count value is derived through a combination of static timing analysis and spice analysis and is related to the frequency of the ring oscillator for the particular OPP. The SR circuit continuously compares the N-count value to the on-chip sensor module SR measured frequency of the oscillator. The sensor SR circuit processes the difference and derives an error output that indicates whether to raise or lower the voltage. The error is output on SR interface and is related to the actual voltage step that needs to be applied.

In FIGS. 18-22, each voltage processor VP monitors the error output on its associated SR1 or SR2 interface and converts the error output into a voltage level to be sent over to the external SMPS by the voltage controller VCON. Each Voltage controller (VCON) handles the 12C interface with external switch mode power supply SMPS. The VCON receives a voltage level from the voltage processor VP and also command from the voltage state machine FSM. In active mode, the VCON formats the voltage level and command and sends them over the 12C interface to control the external SMPS. When the device is in standby mode, the voltage controller VCON is then driven by the voltage state machines FSMs to allow the external supply to enter low power mode. The sensors SR, the voltage processor VP, the voltage controller VCON and the external SMPS are coupled to form a closed loop feedback system that automatically adapts the voltage of each voltage domain. This system supplies the voltage domain with the minimum voltage that matches the domain frequency, process and temperature operating conditions.

Digital circuitry processes the difference and derives an error amount that indicates whether to raise or lower the voltage. The error is related to the actual voltage step that needs to be applied. In some embodiments, the error is output on the digital circuit interface to a voltage processor VP1 or VP2 as in FIGS. 18, 20 and 21. The voltage processor VP1 or VP2 monitors the error output on the circuit interface and converts it into a voltage level to be send over to the external SMPS by the voltage controller VCON. The voltage controller VCON handles the dedicated I2C interface with external SMPS. The voltage controller VCON receives voltage level from the voltage processor and also command from the voltage FSM, it formats them and sends them over the I2C interface to the external SMPS.

In some other embodiments, the errors generate an interrupt to the MPU that processes the interrupt and adapts the external switch mode power supply (SMPS) voltage accordingly.

Power managed DPLLs have the following main features. The DPLL has a built-in LDO coupled to a common supply so the DPLL is not impacted by voltage variations on VDD1 and VDD2. The DPLL has a built-in switch to power down completely the internal logic, and support a very low power mode where the LDO is powered down and switches are open. The DPLL supports idle modes such as Low power or fast relock bypass, Low power or fast relock stop mode. Bypass mode routes input clock directly to clocked circuitry and bypasses a DPLL. In addition, the DPLL supports a mode where it stays locked but the output clock is gated. A clock divider circuit in some cases (e.g. peripheral) is coupled to the DPLL to generate a clock-divided version of the DPLL clock output. Such a divider is fed by the same LDO as the associated DPLL so that any voltage scaling affects the divider and DPLL substantially equally.

DVFS has a frequency scaling step wherein clock frequency is changed by software re-configuring a control register to cause PRCM to reach the frequency corresponding to the selected OPP. The configuration sets new values for clock divider or sets new M, N multiply, divide values for the DPLL, with due regard to the consideration that DPLL latency (re-lock time) can be longer than divider latency. DVFS voltage scaling software or hardware configures a new count value in the AVS sensor module SR1 and/or SR2 corresponding to the selected OPPn.

In FIG. 9, an optimal performance/power trade-off for a variety of devices is achieved across the technology process spectrum and across temperature variation and age of device. Optimal performance across process variations are provided for so-called hot devices and cold devices. Hot devices have a strong process corner and can be run at a lower voltage to save both active and leakage power. By contrast, cold devices have weak process corner and can be slightly overdriven to achieve their maximum performance. Circuits in different parts of the same integrated circuit chip may vary in their process corner. Overdriving a cold device is used, in some cases when feasible, to compensate for voltage regulator DC voltage accuracy and/or to compensate for part of the board level voltage drop (current-resistance IR drop).

The meaning of the phrase process corner depends on the context in which the phrase is used. The phrase process corner can be rather specifically used to refer to a corner of a table of many wafer fab process options in the wafer fab library. The table for example can have rows of hotness of N-channel transistors versus columns of hotness of P-channel transistors. The phrase can also be used more generally to refer to the speed of circuitry at a given power supply voltage, and the latter more general meaning is indicated by the context of some statements herein. See also U.S. Patent Application Publication 20050057230 (TI-36220) filed Aug. 9, 2004 which is hereby incorporated herein by reference.

In FIG. 9, a power management example involving calibration and configuration is shown. In FIG. 9, a graph of maximum clock rate for acceptable digital operation versus normalized voltage shows that at any given voltage, the hot device from the strong process can be clocked faster than the cold device from the weak process and still produce the same acceptably low logic data error rate and thus provide substantial freedom from logic errors. Since the hot device can be clocked faster than the cold device, the hot device can execute a given software application faster and has lower software execution latency than the cold device. In this way, running the software faster with lower latency makes the device and system hot, meaning hot in the sense of user-perception of high performance, as compared with the cold device.

At a given clock frequency, the hot device from the strong process can be operated at a lower voltage than the cold device from the weak process. Assuming the capacitance of the device from either process is about the same, this means that at any given clock frequency, the hot device from the strong process can be operated at a lower power (proportional to the square of the normalized voltage) compared to the power consumed by the cold device from the weak process. Since the power is proportional to the square of the normalized voltage and the other power parameters in the power formula CV²F are the same, the hot device runs remarkably thermally cool (and cool in the sense of performance desirability, battery life, and product prestige and cachet) relative to the higher and less desirable power dissipation of the cold (thermally hotter) device.

Notice that increasing the physical temperature of a device degrades its physical characteristics and makes the device colder in the sense of FIG. 9 than a device at a lower physical temperature. In other words, at a higher physical temperature, a device at a given voltage is run at a lower frequency to obtain the same acceptably-low error rate or a device at a given frequency is run at a higher voltage to obtain the same acceptably-low error rate.

In some embodiments, the parameters of a device corresponding to that of FIG. 9 are configured into the system flash memory for use by the power management circuitry. Also, these parameters are adjusted relative to configured parameters, or the parameters themselves are determined even without previous configuration, by an internal test run during actual operation of the device in the system at boot up and/or run-time.

Plural hardware power management modules in some system embodiments perform continuous hardware calibration and automatically adjust the power supply voltage across a hardware interface for respectively controlling plural voltage domains in a processor and/or system. See FIGS. 18, 20 and 21. Some other embodiments perform continuous software calibration. The power management sensor SR is enabled continuously and allows variation tracking in real time and dedicated hardware generates a host CPU interrupt when the voltage is outside an acceptable range and the power supply voltage can then be adjusted by software. See FIGS. 18 and 21. Still other embodiments provide support for the hardware modules to be used for continuous software calibration.

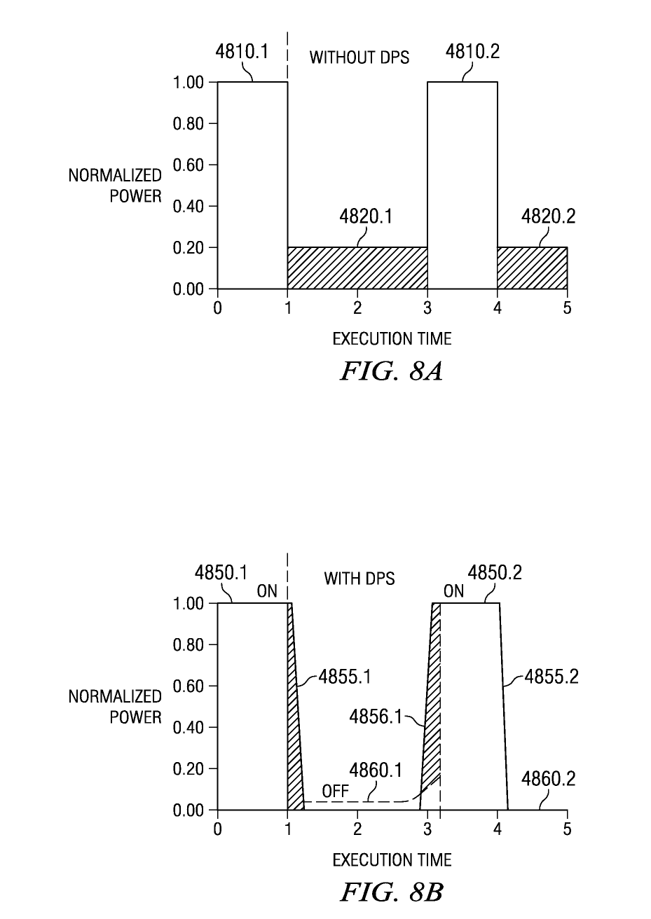

In FIG. 8B, Dynamic Power Switching (DPS) reduces DPS reduces leakage power consumption at a slight cost of a small overhead in dynamic power consumption. Notice that DVFS of FIG. 7B and DPS of FIG. 8B differ in their effects on active power consumption and leakage power consumption.

In FIG. 8A, without DPS, a process 4810.1 runs in an ON mode and completes, whereupon a leakage power 4820.1 of the ON mode is continually consumed. Then another process 4820.2 runs in the ON mode and completes, followed by more leakage power consumption 4820.2.

In FIG. 8B, with DPS, the system dynamically switches between high and low consumption system power modes such as ON and Standby during system active time. Applying DPS, a process 4850.1 is run at a highest (frequency, voltage) operating point to complete its tasks as fast as possible followed by an automatic switch to a low power mode 4860.1 where as much as possible of the system is placed in Retention or Off state. This saves or reduces leakage power consumption or dissipation. DPS is provided in various embodiments using software, hardware or both software and hardware.

In situation when (real-time) applications are started but pending occurrence of an event or depending on the type of event, the system is enabled to switch into a low power system mode if the wakeup latencies conditions allow such switching to low power.

Transitions between system power modes can involve processor context save 4855.1 operations and processor context restore 4856.1 operations that cost some limited additional dynamic power consumption. This additional dynamic power consumption is suitably taken into account in adapting the DPS rate herein. Then process portion 4850.2 continues or repeats the process 4850. 1, or commences a new process, whereupon completion occurs and a context save 4855.2 is followed by low power Standby mode 4860.2, etc.

This DPS process of FIG. 8B involves maximizing the idle period of the system in contrast to DVFS of FIG. 7B which involves minimizing the idle period. To support DPS as described herein, some embodiments provide and one, some or all of 1) multiple on chip power domains with on-chip power switches, 2) domain isolation that allows any combination of domain on/off states, 3) adapted clock and reset trees that allow any combination of domain on/off state, 4) power, clock and reset hardware (PRCM) circuits and processes for automatic sequencing of the domain transitions according to their sleep and wakeup dependencies, 5) memory retention capability, and 6) logic retention capability such as Retention DFF (D-flip-flop) or retention voltage (significantly reduced compared to active voltage).

In FIG. 8B, DPS runs the application rapidly to completion and then turns the voltage off. The area under the leakage line 4820.1 for the static leakage of FIG. 8A is thereby reduced or eliminated by DPS in the low power state 4860.1 of FIG. 8B. However, some additional vertical area at 4855.1 and 4856.1 is introduced by use of context save/restore operations that cost some limited additional dynamic power consumption. A net reduction in area-under-the-curve is enjoyed by deploying DPS as described herein.

The per-unit net reduction in area-under-the-curve is called the DPS margin herein. The DPS margin depends on the system wakeup latency, the system break-even time, the context save time, the context restore time, and other factors.

Partitioning the chip into numerous power domains provides substantial flexibility to enable DPS for complex application scenarios in audio processing, video processing, screen refresh, and other applications and structures. All domain states (On, Retention, Off) combinations are allowed for flexible DPS modes definition. Independent control of the logic and memory state (On, Retention, Off) is provided for selected power domains such as processor cache retention but logic off. Adequate clock and reset tree circuitry are provided to avoid inter-dependence among power domains except where desirable for interlocking.

Logic and memory retention reduces save latency and restore latency. Adequate FIFO size in key modules, such as audio buffer, display FIFO, and buffers in other DPS controlled modules, facilitates DPS for audio playback and screen refresh as in FIGS. 14A-14D.

Some embodiments improve DVFS by partitioning the processors and the memory system into separate voltage domains. Scaling the frequency of the memory system can be judiciously employed to maintain an acceptable software overhead. Improved DVFS as described herein is applied dynamically to the processor MPU and IVA and with independently established DVFS power management to remaining portions of the integrated circuit device.

In FIGS. 10A and 10B, the operations pertaining to a quantity herein called DPS margin are described by example further. The subject of DPS margin is described in even more detail elsewhere herein, see decision step 5820 of FIG. 17. Suppose a performance target frequency f_{target} is not far enough below a DVFS OPP frequency Fₙ and starting up DPS of FIG. 8B is therefore not justified. FIGS. 10A and 10B show this condition where DPS margin is too small. FIGS. 10A and 10B are compared by the reader with the condition of FIGS. 8A and 8B wherein running DPS power management is indeed justified because in FIGS. 8A and 8B the DPS margin is ample.

In FIG. 10A, the number of applications and their computing burden is large enough so that the processor clock needs to run almost all the time at even a target frequency f_{target} close to the range higher-end frequency Fₙ in order to execute application(s). In other words, given a power managed supply voltage Vₙ that has been established by DVFS, the higher-end frequency Fₙ is becoming a constraint that is crowding the target frequency f_{target}. Keeping DPS activated becomes less justifiable when the clock frequency cannot be run much faster than the target frequency needed to execute the application(s) in a hurry and shut the processor down to eliminate static power dissipation and get a net energy savings.

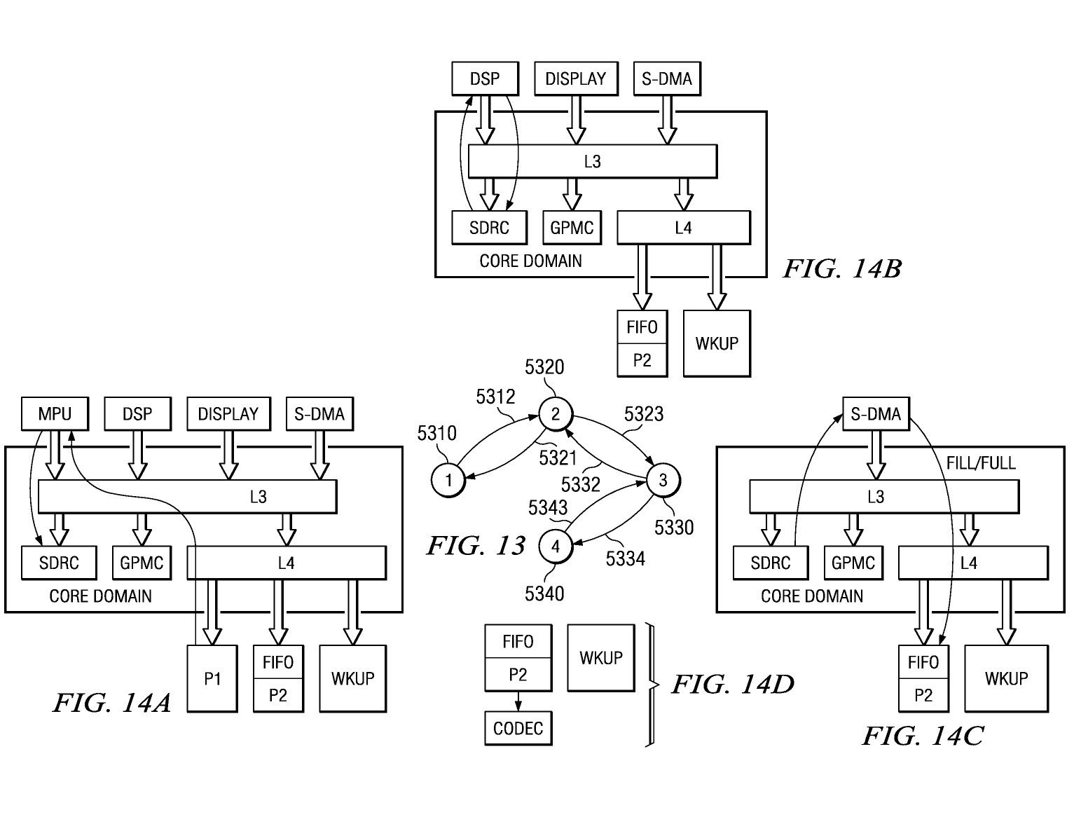

FIG. 10B illustrates this situation where the DPS margin is insufficient to justify DPS power management. In FIG. 10A without DPS, the intervals of execution 5010.1, 5010.2, etc. become wider and wider and the intervals of static leakage power consumption 5020.1, 5020.2, etc. become shorter. In FIG. 10B with DPS, the intervals of execution 5050.1, 5050.2, etc. also become wider and each interval of processor shut-down 5060.1 has become uselessly small or zero. The context save power consumption 5055.1 and context restore power consumption 5056.1 now exceed the power savings of eliminating static power dissipation and the DPS margin at this operating frequency is zero or negative. Notice that the DPS margin is an increasing function of the difference between range higher-end frequency Fₙ and the target frequency f_{target}. A criterion and procedure for activating DPS is described in connection with FIG. 17, and state machine transitions in DPS are shown in FIGS. 13 and 14A-14D.

In FIGS. 11 and 12, Standby Leakage Management (SLM) provides power management that reduces standby power consumption, or leakage power consumption. With SLM, the device switches into low power system modes automatically or in response to explicit user requests during system standby time such as when no application is started and the system activity is negligible or very limited.

Applying Standby Leakage Management (SLM) puts the system into the lowest static power mode and maintains that lowest mode, compatible with desired system response time. The integrated circuit operation in Standby Leakage Management SLM enters an ultra-low power mode called Off mode having very low total chip current and wherein the Wakeup domain on the chip can still be activated. The wakeup clock (e.g., 32 kHz) remains on and a wakeup power voltage remains applied to the Wakeup domain. A system and security timer and watchdog timer are functional and can wakeup the device. Also, a level transition can be detected, logged from any pad and thereby wakeup the device. Also, a small backup memory is retained in the Off mode. Thus, the SLM circuit still wakes up autonomously from Off mode in response to a timer interrupt or detection of any pad transition. SLM trades off static power consumption and wakeup latency (time interval consumed by a wakeup process).

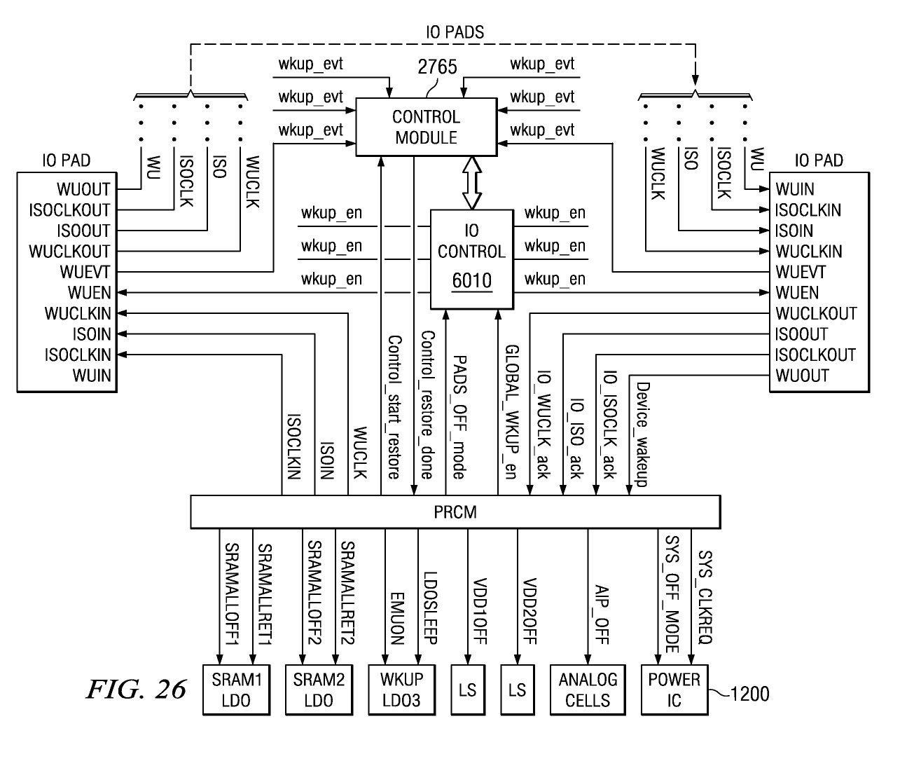

Some application processor features to enable SLM are the same as or analogous to those provided to enable DPS. Domain state transitions are controlled in sequence according to their sleep and wakeup dependencies. Intelligent idle and standby power management is provided in any one, some or all modules. A main voltage domain (processor/core) can be fully turned Off in a lowest power mode, while full hardware control is maintained by the power management interface controller block PRCM. Software configurability of the IO state in lowest power mode reduces IO leakage. Flexible wakeup capability is provided from any pad in lowest power modes, see FIG. 26.

In FIGS. 11 and 12, and comparing DPS and SLM, these two processes have some similarities in their processes and in the hardware utilized to support them. Both DPS and SLM switch between system modes, but their time scales is different. DPS and SLM differ principally by the latency allowed for the modes transitions and therefore by the modes attributes.

DPS is used such as in an applicative context when each task is started. Therefore, the mode transitions are related to system performance requirements or processor load. DPS transition latency is generally small compared to applications time constraints or deadlines so that DPS does not degrade application performance. For DPS, transitions latencies can be in a range of ten (10) microseconds to one hundred (100) microseconds, for instance, and latencies outside this illustrative range are also usable. DPS is supported by performance prediction software.

The performance prediction software monitors and controls transition latencies for DPS. The transition latency, in the case of real time application, is desirably kept short enough so that the transition latency does not deteriorate the device performance to a point where a deadline is missed. Analogously, in the case of an interactive application, the transition latency is kept short enough so that the transition latency does not noticeably degrade the user experience of interacting with the application.

SLM is not used in a running applicative context, and instead SLM operates with no task started in the applicable power domain or voltage domain. The mode transitions are more related to system responsiveness. The transitions latency on wakeup is made small compared to user perception so that the latency is compatible with a satisfying user experience. For SLM, transitions latencies for many systems are likely to lie in a range of one millisecond (1 ms) to ten milliseconds (10 ms) depending of available device mode, and SLM is feasible for longer or shorter latencies as well.

DPS and SLM also can differ by the type of wakeup event that triggers wakeup transitions. For DPS, wakeup events are application related (timer, DMA request, FIFO fill signal, peripheral interrupt, key pressed). In case of SLM, wakeup events are more user related, such as from touch screen, key-press, peripheral connections, etc.

Four wakeup processes are adapted to different modes of operation of the device. In active modes where either processor MPU and/or imaging, video and audio processor (IVA) is in Retention or OFF state but core is still active (clock running), an interrupt event can still wakeup the processor MPU and/or imaging, video and audio processor (IVA). In active modes where either processor (MPU or DSP) is in Retention or OFF state and core is inactive (clock stopped), a module wakeup event can still wakeup the processors and clocks. In active modes where processors (MPU and DSP) are OFF or in Retention and core is in Retention (Peripherals or Display can still be active), events mapped on GPIO in Peripheral domain or Wakeup domain can still wake up the other modules in the integrated circuit device. In standby modes and OFF mode (power domain are either OFF or RET), an IO can still wake up the device.

In regard to FIGS. 11 and 12, Operating Performance points (OPP) are discussed further. For practical reasons related to device making (flow, tools), the DVFS process in some embodiments utilizes a few discrete steps, although a continuum of voltage and frequency values for OPPs is possible. Each step or Operating Performance Point (OPP) is composed of a voltage-frequency (V, F) pair. When defining OPPs, the skilled worker chooses to set the voltage steps or the frequency steps. Either way, for a given OPP (V, F), the frequency (F) corresponds to the maximum frequency allowed at voltage (V). Conversely, the voltage (V) corresponds to the minimum voltage allowed for frequency (F).

When adaptive voltage scaling (AVS) is used on a device, it is in some cases easier to set the frequency steps and let the AVS adapt or adjust the voltage according to the device silicon performance. In such case, each frequency step corresponds to a range of voltage, rather than a voltage step, depending on whether the device is a hot device or a cold device. The operating points OPP are then each defined as a pair ([Vs−Vw], F). Vw signifies the magnitude or width of the AVS control over voltage reduction compared to supply voltage Vs (e.g. an OPP nominal voltage) and in response to a sensor module SR1 or SR2. In such pair, the voltage difference [Vs−Vw] is the range of voltage over which the AVS process can have the device operate at a given frequency F. With AVS, the frequency steps are identified and AVS adapts the voltage according to the device silicon performance. In this case, for each frequency step, instead of a DVFS voltage step there is a corresponding range of voltages due to combined operation of DVFS and AVS. This range of voltages depends on the device fabrication process and its real-time operating state (temperature) at a given frequency.

DPS is a power-management technique, like DVFS, aimed at reducing active power consumption by the device. Whereas DVFS reduces both dynamic and leakage power consumption, DPS reduces leakage power consumption at the cost of a slight overhead in FIG. 8B in dynamic power consumption and temporarily shuts down one or more parts of the system in FIGS. 14A-14D. With DPS, the system switches dynamically between high and low consumption system power modes during system active time. When DPS is applied, a processor or a system runs at a given OPP (full OPP frequency Fn) even when the OPP frequency exceeds a target performance frequency f_{target}. DPS thus combined with DVFS operates to complete tasks as fast as possible, given a currently established DVFS OPP, followed by an automatic switch to a low-power mode, for minimum leakage power consumption. DPS is also useful, for example, in situations herein where a real-time application is waiting for an event. The system can switch into a low-power system mode if the wake-up latency conditions allow it. This technique involves maximizing the idle period of the system to reduce its power consumption.

FIGS. 8A and 8B compare the power consumption behavior for the same device operation without DPS and with DPS. When operating without DPS, the device has a constant leakage current 4820.1, .2, etc. in idle mode. By using DPS, the system reduces the leakage current to near-zero as shown by line 4860.1. However, as shown in FIG. 8B, the transitions between system power modes suitably involves storing of information and consuming power 4855.1 before entering a low-power idle state and then consuming power 4856.1 when restoring the information after a wake-up event. This results in additional dynamic power consumption, referred to as the transition overhead in FIG. 8B. Transition overhead is taken into account in some embodiments of process and structure when considering whether to initiate DPS operation herein.

For efficient deployment of DPS techniques, dynamic prediction is provided pertaining to the performance requirement of the application(s) running on the processor. The DPS controller accounts for the overhead of wake-up latencies related to domain switching and ensure that they do not significantly impact the performance of the device. Even with transition overhead, a threshold idle-time limit beyond which the DPS is useful for dynamic power saving is identifiable by hardware or software, as in FIG. 17.

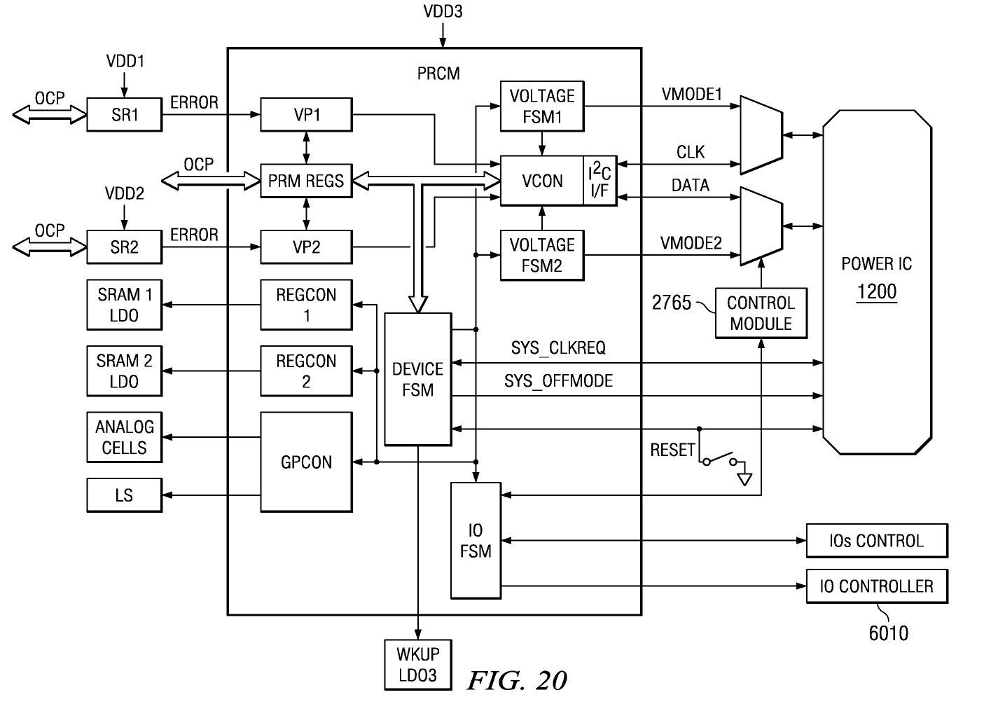

With AVS, the frequency steps are identified and AVS adapts the voltage according to the device silicon performance as described in connection FIGS. 18 and 20 elsewhere herein. In this case, for each frequency step, instead of a voltage step there is a corresponding range of voltages. This range of voltages depends on the device fabrication process and its real-time operating state (temperature) at a given frequency.

Power saving is enhanced herein by combining DVFS, DPS, SLM and AVS techniques. For a given operating state, one or more of the power saving techniques can be applied to ensure optimal operation with maximum power saving. AVS is used at boot time to adapt the voltage to device process characteristics (strong/weak) and then continuously to compensate temperature variations. AVS also helps deliver high application performance of the device at a given OPP.

In FIGS. 11-12, when medium application performance is desired or when application performance requirements vary, the DVFS technique is applied. The voltage and frequency are scaled to match the closest OPP that meets the performance requirement. When application performance requirements fall between two OPPs or when very low application performance is required and it is below the lowest performance OPP, DPS is applied to switch to low-power mode.

When combining DVFS and DPS, the operating frequency is not scaled to exactly match the minimum performance requirement ftarget . Unless DPS cannot be applied for other reasons, then for a given operating point OPP of DVFS the operating frequency is set to the OPP frequency Fn that is the maximum frequency allowed at a given voltage Vn for that OPP. This facilitates optimal process completion time and application of DPS.

If DPS cannot be applied in a given context, scaling the frequency while keeping the voltage constant does not save energy but does reduce peak power consumption. This example of an Other Power Management (OPM) technique can have a positive effect on temperature dissipation and on battery life. In other situations where no applications are running and the performance requirement becomes negligible or drops to zero, SLM is suitably used.

In FIG. 11, combining of contradictory power management processes is further described. Even more enhanced active power savings are obtained by combining DVFS, DPS and AVS processes and using SLM for static leakage management. AVS is used at boot time to adapt the voltage to device process characteristics (strong/weak) and then continuously to compensate temperature variations. In some situations that require maximum available application performance, some embodiments apply only AVS in the vicinity of a maximum OPP (e.g., OPP4 of FIG. 11). In situations that require medium application performance, DVFS is applied as well as AVS.

As application performance requirements are decreased, the voltage and frequency are scaled to correspond or match to the closest OPP that meets or satisfies the performance requirement. In situations where the application performance requirement is situated between two OPPs or in situations that require very low application performance below the lowest performance OPP, then DPS is suitably applied. Notice, as shown by a long vertical arrow in FIG. 11, that DPS automatically transitions or alternates between operation at one of the OPPs and a very low power Standby mode.

In FIG. 11, when combining DVFS and DPS, and unless DPS process is inapplicable for other reasons, the frequency is adjusted or set so that the frequency corresponds to the maximum allowed at a given voltage. The frequency does not need to be scaled independently of the voltage to match exactly the performance requirement. If DPS cannot be applied in a given context, scaling the frequency while keeping the voltage constant would not save energy but will reduce the peak power consumption. This can have positive effect on the temperature dissipation and also on battery capacity.

Further in FIG. 11, in situations where no applications are running and standby performance requirement is negligible or zero, then SLM is employed.

In FIG. 12, power managed clock frequency, which affects application performance, is graphed versus power managed voltage. Compare FIG. 12 with FIG. 11. On standby, the voltage is kept low or zero and the frequency is zero. A horizontal line SLM in the frequency-voltage region represents that Standby Leakage Management (SLM) is employed.

For low performance applications, a low voltage V1 is established and the frequency is established at frequency F1, represented by operating performance point OPP1 in FIG. 12, by power management processes AVS and DPS.

As more applications and/or applications performance are required, beyond the maximum performance available at OPP1, then DVFS power management makes a discrete transition of operating voltage from voltage V1 to voltage V2 and increases the frequency from F1 to F2.

Further in FIG. 12, as even more applications and applications performance are required, beyond the maximum performance available at OPP2, then DVFS power management makes a discrete transition of operating voltage from voltage V2 to voltage V3 and increases the frequency from F2 to F3, and so forth. At each OPP point, AVS power management manages the voltage depending on the parameters of the integrated circuit. DPS power management is activated if the target frequency F_{target} for a given process is below a threshold frequency THRESHOLD 1, 2, 3, 4 so that DPS energy savings are sufficient to justify activating DPS at the given OPPₙ. For example, in FIG. 12 the currently-selected DVFS OPP is OPP2, target frequency Ftarget is sufficiently below the frequency of OPP2 to be lower than THRESHOLD2, and DPS activation is justified.

The process operates in reverse as fewer applications and/or less applications performance are required. When performance needed can be managed at a lower OPP, then power management process DVFS makes a discrete transition of operating voltage downward by one voltage step to reach the next lower operating point OPPₙ₋₁.

In FIGS. 13 and 14A-14D, the integrated circuit voltage domain and power domain partitioning enables very efficient DPS for audio play back and screen refresh, which are subject to leakage power dissipation. During screen refresh or audio playback, the rest of the integrated circuit remains most of the time in an Off or Retention low leakage mode wherein only the display domain is On or audio playback circuit is on. The screen or audio circuit is refreshed from its respective internal FIFO which is sized sufficiently large (e.g. in range 1 Kbytes to 10 Kbytes or larger) to feed the screen or audio circuit independently of the rest of the integrated circuit and thus permit most of the integrated circuit to be in low leakage mode. When that internal FIFO needs to be refilled, a FIFO-fill signal is generated from the internal FIFO and is fed to and automatically wakes up the core domain.

This wakeup process is also herein called a Smart Standby mode, in which the Core domain wakes up automatically and the display can access the frame buffer in external DDR SDRAM memory. The processor MPU does not need to wake up on every FIFO-fill signal since DDR controller is built with retention D-flipflops and its configuration is automatically restored. Once the internal FIFO is refilled, the FIFO generates a FIFO-full signal. In response to the FIFO-full signal, the core domain turns off automatically and returns to low leakage mode. When the DDR memory is depleted of decoded audio or video, then a wake-up signal is sent to the MPU domain to wake up the MPU to restore the audio decode context, perform additional audio decode at a high rate and re-fill the DDR memory and re-fill the internal FIFO, whereupon the MPU does a DPS context save and returns to low leakage mode.

A Smart Idle mode provides automatic and clean management of the DDR memory when shutting down the L3 interconnect or Core domain clock or scaling the L3 clock frequency. In particular, an associated memory refresh controller SDRC of FIGS. 3 and 14A-14D drains the pending access and puts the DDR memory in self-refresh before gating the L3 clock or scaling the frequency.

The deployment of DPS is supported by suitable performance prediction software and/or hardware. The software predicts dynamically the performance requirement of the application(s) running on the processor. For DPS, the software accounts for the wakeup latencies overhead due to domain switching so that DPS is operative when such latencies do not significantly impact the performance of the device. PRCM is configured by the software, and PRCM maintains control of DVFS/AVS/DPS/SLM power management when a processor that runs of the software is shut down by the power management process itself.

Some embodiments have plural processors (MPU, IVA, etc.) that share the same voltage for hardware simplicity as in FIG. 6. In some of those embodiments DPS is respectively and individually applied to one, some or all processors that are not loaded. In this way, DPS more nearly optimizes power dissipation when one processor is loaded and another processor is not loaded.

In FIGS. 13 and 14A-14D, DPS operations are shown for an audio/video player application. FIG. 13 shows a state transition diagram having states 5310, 5320, 5330, 5340 that respectively correspond to FIGS. 14A, 14B, 14C, 14D. These state machine states identify and generate power modes such as in TABLES 3 and 4 or establish power modes specifically to correspond to FIGS. 14A-14D. In state 5310, power is applied to MPU, DSP, Display, S-DMA, Core domain with L3/L4 interconnect and SDRC and GPMC, to P1 and P2 peripheral domains, and to the Wakeup domain WKUP. Audio data is accessed through peripheral P1 domain by MPU and stored in SDRAM, as shown by transfer arrows in FIG. 14A. When this operation is completed a power management transition 5312 is initiated in FIG. 13 and operations reach state 5320.

In state 5320 of FIG. 13, the MPU domain and P1 peripheral domain are put in low power standby mode but the other domains are running in FIG. 14B. DSP performs two way accesses with SDRAM and decodes the audio data. When this operation is completed, a power management transition 5323 is initiated in FIG. 13 and operations reach state 5330.

In state 5330 and FIG. 14C, the MPU domain and P1 domain continue in low power standby mode, and DSP and Display are put into low power Standby mode, while the other domains are running. Now the System DMA S-DMA transfers decoded audio from SDRAM to a FIFO buffer associated with the P2 peripheral domain. WKUP domain is powered at all times. Notice in FIG. 14C that still more power is saved by having MPU, DSP, Display, and P1 peripheral domains on low power Standby mode. When this operation is completed a power management transition 5334 is initiated in FIG. 13 and operations reach state 5340.

In state 5340 of FIG. 13 and in FIG. 14D, even S-DMA and Core domains are now put on low power Standby mode. The MPU domain, P1 domain, DSP and Display continue in low power standby mode. Now only the P2 peripheral domain and WKUP domain are running. At this point the P2 peripheral domain transfers decoded audio from the P2 FIFO buffer to an off-chip audio codec to play back the audio. Notice in FIG. 14D that still more power is saved by having almost the entire applications processor chip in low power Standby mode.

Further in FIG. 13, transitions are suitably made from any step to the next previous step to refill buffers or do more processing to keep the application going smoothly. For example, when the P2 FIFO buffer in FIG. 14D becomes depleted sufficiently to make replenishment advisable before the buffer becomes empty, then a transition 5343 is made back to step 5330 to refill the P2 FIFO buffer. If more audio needs to be decoded from SDRAM, then a transition 5332 goes back to step 5320 to use the DSP to decode more audio. If more audio data is needed from the P1 peripheral, then a transition step 5321 goes back to step 5310 for that operation.

Partitioning of the integrated circuitry in FIGS. 2, 3, 6 and 14A-14D is established structurally in a manner that optimizes power conservation by power modes used in audio, video and screen refresh use cases, for instance. The TABLES 2-4 hereinbelow list some power mode examples. Other power modes are defined as appropriate for particular embodiments. A particular power mode is represented by a respective table column. The operation of any given domain is represented by a table row. The entries in the TABLES 2-4 correspond by column to configuration entries in Control Registers 6710 of FIG. 27, for instance, to control the various power domains of FIG. 6 according to a power mode currently selected by software or by a state machine as in FIG. 13 in the PRCM. Emulator modes are also configurable wherein the Emulator EMU power domain is activated.

TABLE 2 depicts some general purpose active power modes.

TABLE 2
GENERAL PURPOSE ACTIVE POWER MODES

| | | | | | Screen | | |
|---|---|---|---|---|---|---|---|
| | | | | | refresh | Low power | |
| | | | | Screen | frame | screen | |
| | Full ON | MCU ON | Graphic | update | access | refresh | Camera Preview |
| MCU | Active | Active | Active | Active | Off | Off | Active |
| IVA | Active | Off | Off | Off | Off | Off | Off |
| GFX | Active | Off | Active | Off | Off | Off | Off |
| CORE | Active | Active | Active | Active | Active | Retention | Active |
| DISP | Active | Active | Active | Active | Active | Active | Active |
| CAM | Active | Off | Off | Off | Off | Off | Active |
| PER | Active | Active | Active | Off | Off | Off | Active |
| EMU | Off | Off | Off | Off | Off | Off | Off |
| WKUP | Active | Active | Active | Active | Active | Active | Active |

TABLE 3 depicts various slow mode examples of an Audio/video active mode.

TABLE 3
AUDIO/VIDEO ACTIVE MODE - SLOW

| | AV1 | AV2 | | AV4 | | | |
|---|---|---|---|---|---|---|---|
| | Data | Data | AV3 Data | Data send | AV5 Data | AV6 Data | AV7 Data |
| | access | process | transfer | out | access | process | transfer |
| MPU | Active | Off | Off | Off | Active | Off | Off |
| IVA | Off | Active | Off | Off | Off | Active | Off |
| GFX | Off | Off | Off | Off | Off | Off | Off |
| CORE | Active | Active | Active | Retention | Active | Active | Active |
| DISP | Active | Active | Active | Active | Active | Active | Active |
| CAM | Off | Off | Off | Off | Active | Active | Active |
| PER | Active | Active | Active | Active | Active | Active | Active |
| EMU | Off | Off | Off | Off | Off | Off | Off |
| WKUP | Active | Active | Active | Active | Active | Active | Active |

While running audio and video use cases, some embodiments perform DPS state transitions between appropriate numbered audio/video AV# active modes in order to optimize the power consumption. As can be seen in the above table the MCU and IVA domain are either in ACTIVE or OFF state. In OFF state, the processor caches are lost incurring a slower resume to full operation in active state. These modes are thus referred to as slow modes, and they also provide more power saving.

TABLE 4
AUDIO/VIDEO ACTIVE MODE - FAST

| | AV1-f | AV2-f | AV3-f | AV4-f | AV5-f | AV6-f | AV7-f |
|---|---|---|---|---|---|---|---|
| MCU | Active | Retention(1) | Retention(1) | Retention(1) | Active | Retention(1) | Retention(1) |
| IVA | Retention(2) | Active | Retention(2) | Retention(2) | Retention(2) | Active | Retention(2) |
| GFX | Off | Off | Off | Off | Off | Off | Off |
| CORE | Active | Active | Active | Retention(3) | Active | Active | Active |
| DISP | Active | Active | Active | Active | Active | Active | Active |
| CAM | Off | Off | Off | Off | Active | Active | Active |
| PER | Active | Active | Active | Active | Active | Active | Active |
| EMU | Off | Off | Off | Off | Off | Off | Off |
| WKUP | Active | Active | Active | Active | Active | Active | Active |

(1)MPU L2 caches retention. MPU logic state need not be retained.
(2)IVA L2 caches/flat memory retention. IVA logic state need not be retained.
(3)Core domain: SDRAM Memory Scheduler SMS, SDRAM Memory Controller SDRC, SDAM, OMAP, WKUPGEN, INTC control and CM configuration registers have retention. Internal SRAM (public/secure) can also be lost or completely or partially retained depending on software configuration.

The TABLE 4 modes are analogous to TABLE 3 except that the MCU and IVA domain are now in RETENTION state instead of OFF state. Cache retention allows for faster resumption of operation at the expense of memory leakage power dissipation.

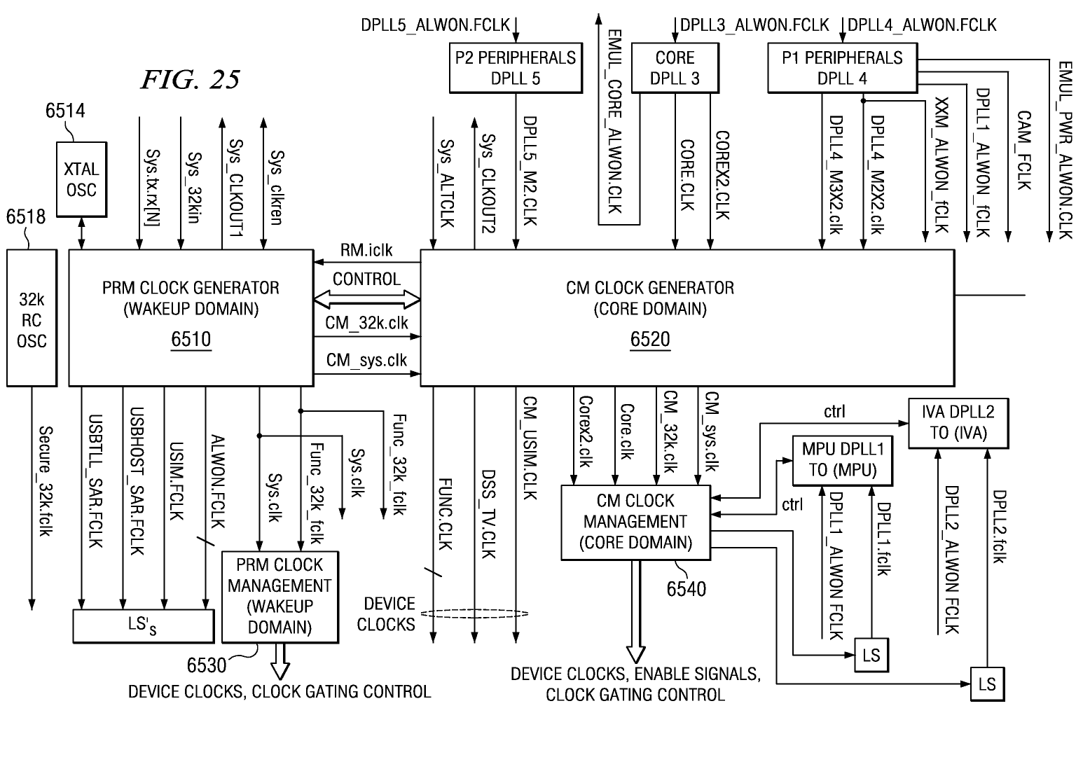

Various domains on the integrated circuit are suitably provided with power states. For example, in the MPU subsystem the memory is divided into power management entities pertaining to the L1 caches (Instruction & data) and L2 cache. The L2 cache power state is independently controlled while the L1 cache power state control is tied to the logic state. The transitions between these power states are handled by the PRM and Clock Manager CM of FIGS. 25 and 27. In some embodiments, a software control process is applied to the hardware of PRM and CM.

TABLE 5
STANDBY POWER MODES

| | Standby1 | Standby2 | Standby3 | Standby4 | OFF |
|---|---|---|---|---|---|
| MCU | Retention | Retention | Off | Off | Off/0 v |
| IVA | Retention | Off | Off | Off | Off/0 v |
| GFX | Retention | Off | Off | Off | Off/0 v |
| CORE | Retention | Retention | Retention | Off | Off/0 v |
| DISP | Retention | Retention | Off | Off | Off/0 v |
| CAM | Retention | Off | Off | Off | Off/0 v |
| PER | Retention | Off | Off | Off | Off/0 v |
| EMU | Off | Off | Off | Off | Off |
| WKUP | Active | Active | Active | Active | Active |

Standby modes are depicted in TABLE 5. In Standby 1 and 2 retention means all logic and memory retention by lowering VDD2 and/or VDD1 to minimum retention voltage. In Standby3 of TABLE 5, the CORE domain has retention of SDRAM Memory Scheduler SMS, SDRAM Memory Controller SDRC, SDMA, and application processor SOC control. Also, Wakeup WKUP, Interrupt Controller INTC and Control Module 2765 and Clock Manager CM configuration registers are retained using retention DFF. Logic state for other power domains is lost. The internal SRAM (public/secure) can also be lost or completely or partially retained depending on software configuration. Standby4 mode leaves only the WKUP domain active, and all other domains are Off.

The Display controller has a Smart Standby mode and a Smart Idle mode. In the display controller Smart Standby mode, the display controller refreshes the external screen from its internal FIFO only and indicates to the Control Module 2765 by asserting the Standby signal that display controller is not accessing the L3 interconnect in FIG. 3. In this mode, auto-gating by Clock Manager CM has already removed the clock from a large part of the display logic.

When the Display controller FIFO reaches its low level threshold, the display controller signals to the PRCM it requires access to external memory where the frame buffer is located. The display controller does this by de-asserting the standby signal if the display controller interface clock is still running or by asserting the Wakeup signal if IdleAck is already asserted.

The display controller is prevented from accessing the L3 interconnect to perform the FIFO refill for as long as the Control Module 2765 maintains the Wait signal asserted. Upon de-assertion of the Wait signal by CM, the display controller starts its FIFO refill and returns to standby mode when the FIFO is full again.

In Smart Standby mode, the display controller has its functional clock running. Accordingly, the display controller is still active in case of Core domain power management by DPS as in the case of low power screen refresh. In that case, the Core voltage domain may be in Core domain DVFS OPP2 and the display is made functional in that OPP2.

DVFS is applied to the device Core voltage domain without visible disturbance of the screen display. Moving between Core domain OPP1 and OPP2 is accordingly performed without varying or disturbing the pixel clock. The clock path from the DPLL4 to a clock divider included inside the display controller is functional to support pixel clock rate in both OPP1 and OPP2 of the Core domain and their corresponding voltages.

The display controller Smart Standby mode supports DPS power management of the Core domain. The Control Module 2765 uses this feature to switch the device automatically between low power screen refresh, and screen refresh frame access.

The display FIFO size is coordinated with power management by DVFS and DPS. The display refreshes the screen from its internal FIFO while the Core domain is in retention. The frame buffer may be inaccessible in low power screen refresh mode. Therefore, the FIFO size is made large enough to cover this period while the Core domain is in retention and also during the Retention to ON and ON to Retention transition time. Increasing the length of time the Core domain can stay in retention increases the power saving and the efficiency of DPS.

The display FIFO is coordinated with DVFS strategy. During the frequency scaling step of DVFS, the refresh controller SDRAM Memory Controller SDRC is momentarily not accessible for a time interval having a duration on the order of ten microseconds (10 us). The display FIFO is made large enough to absorb this time interval when the frame buffer is not accessible.

In one variant, three FIFOs of a sufficient capacity for DPS are provided, one for each of three pipelines. In another variant having a single pipeline instead, the three FIFOs are suitably merged into a single FIFO of combined (triple) capacity.

Analogous to the display FIFO, an audio process has a larger audio buffer size (e.g. in McBSP™ multi-channel buffered serial port interface) that increases the efficiency of the DPS strategy for audio low power use case. The longer the integrated circuit 1400 is in mode AV4 (data send out) of TABLE 3 the larger the power saving by DPS. In this mode the audio data are sent out using a McBSP interface to external audio codec.

A formula for estimating the buffer size S is

S=2 W fₜ Tₜ

where W is bus width (e.g. 32 bits), ft is transfer rate (e.g. 48 KHz), and Tₜ is transfer time, and the factor 2 is a Nyquist sampling factor. The buffer is like to be have a size in a range of 1 KByte to 64 Kbytes for audio. Buffer size varies depending on application as for audio, camera, display and other applications.

Camera interface supports Smart Standby mode. When the camera is enabled, a period of time of several microseconds elapses between capture operations on successive frames. During this time period, the Camera interface accesses L3 interconnect.

In Smart Standby mode, the camera interface indicates to the Control Module 2765 that camera does not access the L3 interconnect. Camera asserts the Standby signal during this blanking period. The Clock Manager CM performs system level power management during this time, and can shut down the interconnect clock and assert a Wait signal. At the end of the blanking period the camera interface de-assets the standby signal to indicate that the camera requires access to the L3 interconnect. CM then disables the Wait signal.

The DMA enters the Smart Standby mode and asserts its standby signal when all the DMA channels are disabled or no non-synchronized DMA channel is enabled and no DMA request input is asserted. The Control Module 2765 and Clock Manager CM perform system level power management such that interconnect clock is shut down when no DMA requests exist and then is restarted when DMA is active. The DMA has retention flipflops and DMA memory retention. The DMA Smart Standby mode and retention flipflops facilitate dynamic power switching DPS of the Core domain. The Control Module and Clock Manager CM use this to switch the device automatically between AV3 (data transfer) and AV4 (data send out) power modes in TABLE 3 in low power audio use cases without having to wakeup the processor to re-configure the DMA.

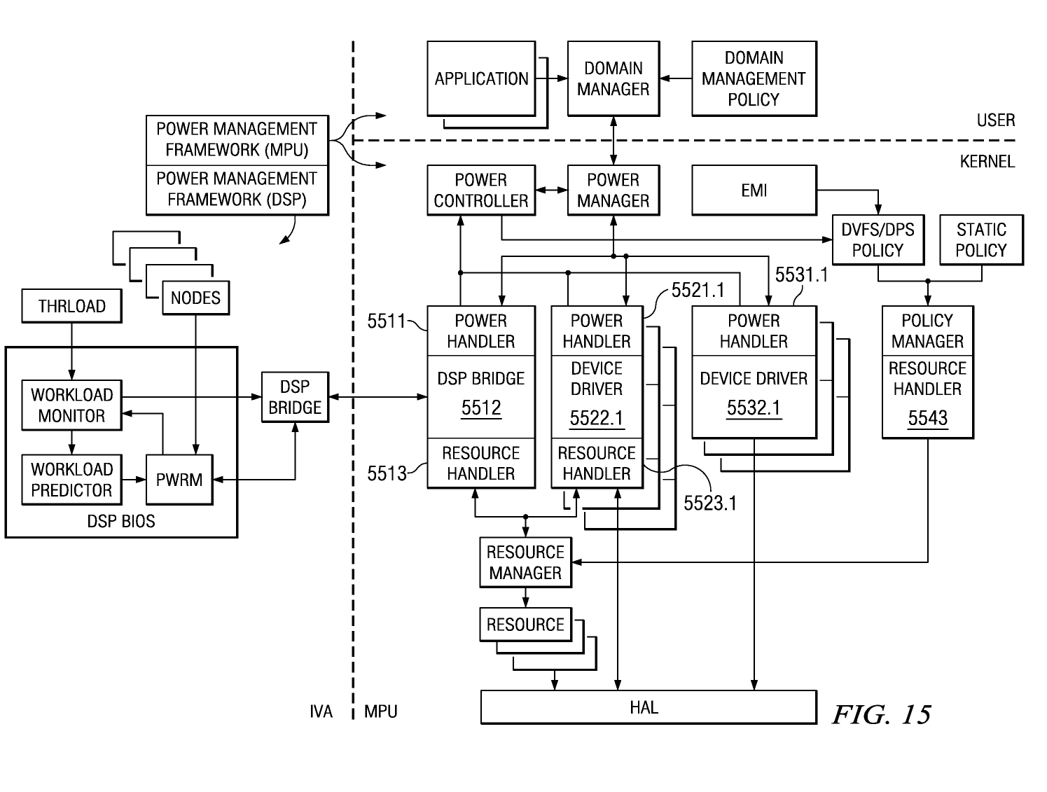

In FIG. 15 software-based processes of operation are shown. MPU power management related software provides a HLOS Power Management framework that supports DVFS and DPS power management processes and a prediction software process to predict the CPU load. Based on MCU and DSP load predictions, the power management policies adapt dynamically frequency/voltage and enable or disable domain DPS in OS idle thread. Device drivers are notified of frequency/voltage change to program hardware if and as needed. A device driver implements on-demand power ON/OFF mechanism (clock gating). Device drivers are notified of device mode changes to program hardware if and as needed. In some embodiments, legacy applications need no modification.

IVA power management related software includes a DSP/BIOS Power Management framework that supports DVFS and DPS power management strategy and a prediction software process to predict the CPU load. This prediction software process is similar to that used for the MCU and in some embodiments is tuned or modified for multimedia application. Based on the DSP prediction load, the power management policies send request to adapt dynamically frequency/voltage and enable or disable domain DPS in OS idle thread. In FIGS. 15, 18 and 19, DSP/BIOS Device drivers are notified of frequency/voltage change to program hardware if and as needed. Device drivers are notified of device mode changes to program hardware if and as needed. A Device driver implements on-demand power ON/OFF mechanism (clock gating).

In FIG. 15, a DSP BIOS has a Workload Monitor which receives loading information from a thread loading Thrload block. The Workload Monitor provides input to a Workload Predictor as well as to a DSP Bridge that is coupled to a counterpart DSP bridge 5512 software block on the MPU. The DSP has a Power Management software PWRM which receives input from the Workload Predictor and controls the Workload Monitor. PWRM receives information from system nodes as shown and outputs information to the DSP Bridge.

In FIG. 15, MPU software has a User layer, a Kernel layer, and a Hardware Abstraction Layer (HAL). In the User layer, Applications software is monitored by a Domain Manager according to a stored Domain Management Policy. Thus the power modes and transitions as in of FIGS. 13, 14A-D and TABLES 2-5 are established in software in some embodiments as supplement to the hardware of PRCM for use in various applications. A Power Manager bi-directionally communicates with the Domain Manager and with a Power Controller and with Power Handlers 5511, 5521.1,.2, etc., and 5531.1, .2, etc. The Power Handlers 5521.i, 5531.i configure and control through Device Drivers 5522.1,.2, etc., and 5532.1, .2, etc., the hardware PRCM and Control Module 2765 for chip 1400 and any other configurable power management hardware in the system such as for chip 1100 and other system chips and units. A Resource Manager module manages resources that couple to the HAL. The Resource Manager is bi-directionally coupled with Resource Handler 5513 associated with DSP Bridge 5512. Resource Manager is bi-directionally coupled with Resource Handlers 5523.i respectively associated with Device Drivers 5522.i.

A DVFS/DPS Policy Module and a Static Policy (e.g., SLM policy) block are coupled to a Policy Manager and Resource Handler 5543. The DVFS/DPS Policy Module receives information from the Power Controller and uses it to determine whether DVFS should make an OPP transition and whether DPS should be started or stopped in FIG. 17. The DVFS/DPS Policy Module receives information from an Energy Management Interface (EMI) pertaining to thermal environment and other energy management and power management information. The Policy Manager and Resource Handler 5543 feed information to the Resource Manager. In this way, DPS context save/restore operations are initiated, for instance.

In FIGS. 16 and 17, multiple seemingly-conflicting power management strategies are combined. In FIG. 16, software operations are shown by way of example in a column SW and hardware operations are shown for example in a column HW. Power On Reset POR 1042 resets the chip 1400 at a step 5605 and commences the mixed process. A step 5610 initializes the AVS Sensor modules SR1 and SR2, and initializes the Voltage Processor VP and the Voltage Controller VCON of FIGS. 18 and 20. In a succeeding step 5615, an application runs on the system and needs to be power managed.

In a step 5620 a load or performance prediction is made for the application. Then a step 5625 outputs the target performance to the PRCM. A PRCM hardware operation 5630 adapts the DVFS OPPs for the VDD1 voltage domain, adapts the DVFS OPPs for the VDD2 voltage domain, and adapts the DVFS OPPs for any other DVFS controlled VDDx voltage domain. This adaptation or adjustment of an OPP involves a change of frequency F and a change of voltage V. The PRCM reports back that the adaptation is completed and represents a current OPP.

A software step 5635 inputs, confirms, or updates the current OPP. A succeeding step 5640 computes a metric representing an amount of difference Δ, discrepancy, disparity or gap between the current performance and the target performance of step 5625. Then a decision step 5645 assesses the gap by comparing the metric with a configured or predetermined threshold value THRESHOLDi. For example, in FIGS. 12 and 17 this method is used for assessing a quantity called DPS margin to determine whether DPS power management should be activated or stopped. In FIG. 16, if step 5645 determines that the threshold is not exceeded or the gap is otherwise insignificant, then operations loop back to step 5615 to continue to run the application under the present conditions.

If step 5645 determines that the threshold is exceeded or the gap is otherwise significant, then operations proceed to a step 5650 to select an appropriate power mode to handle the power management to either deliver more power or less power in an appropriate way. Step 5650 activates a hardware operation 5655 to switch one or more domain power states and enter the selected power mode. Then hardware determines at a step 5660 whether the selected domain power states are now established and monitors until the switching is fully completed. Also at step 5660 hardware determines whether any hardware based mode transition event has occurred, such as a wakeup signal coming from a peripheral. Upon such completion or event, a succeeding step 5665 represents exit from the previous power mode, whereupon an interrupt of step 5670 is fed to the MPU and an application may run at step 5615 in the selected power mode.

In FIG. 17, control operations for power management of FIGS. 4-6 are established in hardware and/or software, depending on embodiment. Operations commence with a BEGIN 5701 or Power Up 5703 or Wakeup 5705 and proceed to a step 5710 to set Fmax as a new AVS reference frequency REFCLK. For example in FIG. 12, Fmax is the highest frequency F4 permitted as a clock frequency. Next, in FIG. 17, a step 5715 establishes or changes the operating point OPP so that OPPnew is OPPmax. Step 5715 is an initialization step that makes operating frequency f equal to the highest operating frequency Fmax, and makes the operating voltage Vn index n equal to the highest operating voltage index nₘₐₓ. In FIG. 12 this highest voltage has a voltage index of n=4.

Next in FIG. 17, the process has a step 5720 that executes performance prediction software. The performance prediction software delivers a performance prediction of number of applications and performance required. The performance prediction software suitably uses information stored in system flash memory that describes the performance parameters and requirements of each application, such as in instructions per second, together with currently monitored number of applications running plus number of applications being launched by the operating system.

A step 5725 generates or derives a new target frequency to accommodate the number of applications and performance required. For example, the target frequency f_{target} in some embodiments having one processor pipeline is made equal to the Sum of the applicable instructions per second to each currently-running application plus each application being launched, multiplied by a safety factor greater than 1.0. The safety factor is believed likely to lie in a range 1.1 to 1.5, for instance, and a value for the safety factor is adjusted for satisfactory system performance.

In embodiments having multiple processor pipelines in one or more processor cores, the target frequency in step 5725 is computed in some embodiments using the above-described Sum divided by the total number of pipelines in all processor cores that are allocated to the power-managed process, and multiplying the resulting ratio by an appropriate factor indicative of the average pipeline usage relative to pipelines all-full. In some more-complex embodiments having different cores managed at different clock frequencies and different numbers of pipelines, lengths and types of pipelines, suitable adjustments in the target frequency calculation of step 5725 are made to account for the actual processor hardware being managed.

These and other performance prediction processes or methodologies known now or in the future are applied alternatively to, or in combination for, steps 5720 and 5725. Other performance metrics besides target frequency are also suitably used.

A succeeding decision step 5730 determines whether the current target frequency Fn equals the minimum DVFS frequency in FIG. 12, namely F1. If not, operations proceed to another decision step 5735 to determine whether the target frequency f_{target} is in the currently-selected range [Fₙ₋₁, Fₙ]. In FIG. 12, the currently selected range is one of the pairs of OPP frequencies that is bounded or defined by frequencies Fₙ₋₁ and Fₙ.

If target frequency f_{target} is outside the currently-selected range [Fₙ₋₁, Fₙ], then a DVFS power management transition to a new range is needed. Accordingly, operations proceed from No at step 5735 to a step 5740 that stops DPS and AVS. Next, a decision step 5745 determines whether the target frequency f_{target} is less than the range lower-end frequency Fₙ₋₁. If yes, then operations proceed to a step 5750 to set that frequency Fₙ₋₁.as the new AVS reference, analogous to initial step 5710. The process is moving or transitioning down the DVFS stairstep of FIG. 12. In FIG. 17, a next step 5755 then changes the operating point OPP so that OPPnew is equal to OPPₙ₋₁. The frequency f for DPS and AVS to start with is set to Fₙ₋₁. The voltage index n is decremented to n−1, and the power management hardware transitions the applied voltage V lower in voltage to Vₙ₋₁ in FIGS. 12 and 18, whence a process node 5760 is reached, and operations loop back to step 5720.

If the decision step 5745 instead determines that the target frequency f_{target} is not less than the range lower-end frequency Fₙ₋₁, then operations branch from step 5745 to a decision step 5765. Decision step 5765 determines whether the target frequency f_{target} is greater than the range higher-end frequency Fₙ. (If not, an error has occurred and a branch to an error handler 5768 is performed.) If so (Yes) at step 5765, operations go to a decision step 5770 that determines whether that higher-end frequency already has topped-out at frequency Fₘₐₓ. If yes, then operations loop back to step 5720, since the top frequency has been reached. If no at step 5770, then operations proceed to a step 5775 that sets a next-higher stair-step frequency Fₙ₊₁ as the new AVS target, analogous to and opposite from step 5750. Here, the process is moving or transitioning up the DVFS stair-step of FIGS. 12 and 18. In FIG. 17, a next step 5780 then changes the operating point OPP so that OPPnew is equal to OPPₙ₊₁. The frequency f for DPS and AVS to start with is set to Fₙ₊₁. The voltage index n is incremented to n+1, and the power management hardware transitions the applied voltage V higher in voltage to Vₙ₊₁ in FIGS. 12 and 18, whence the FIG. 17 process node 5760 is reached, and operations loop back to step 5720.

In FIG. 17, if decision step 5730 determines Yes, namely that range higher-end frequency Fₙ is equal to the lowest clock frequency Fₘᵢₙ of a DVFS operating point (where Fₘᵢₙ is F1 in FIG. 12) used in the system, then operations branch from step 5730 to a decision step 5805. Decision step 5805 determines whether target frequency f_{target} is less than or equal to the range higher-end frequency Fₙ, which has just been determined to be the value Fₘᵢₙ. If No at step 5805, operations branch to a step 5810 to stop DPS or maintain DPS inactive, whereupon the step 5765 is reached. If so (Yes) at step 5805, operations go to a step 5815 wherein the current operating point OPP is kept or maintained and the frequency pertaining to the OPP remains at frequency Fₙ.

Step 5815 to keep current OPP is also reached along a flow path when decision step 5730 determines No and then decision step 5735 determines Yes that the target frequency f_{target} is within the currently-selected range [Fₙ₋₁, Fₙ] and thus a DVFS power management transition to a new range is not needed.

From step 5815, operations proceed to a decision step 5820 to determine whether the target frequency f_{target} is far enough from the range higher-end frequency Fₙ that starting up DPS of FIG. 8B would be justified. One example of a criterion for decision step 5820 is whether the difference found by subtracting f_{target} from Fₙ exceeds the applicable FIG. 12 THRESHOLDi, which is a function involving DPS margin multiplied by a conversion factor to convert to frequency units. Another example of a criterion involves the DPS margin itself and quantifies the excess of power savings in FIG. 8B from turning off leakage over the power consumed in transition overhead. See further detailed description elsewhere hereinbelow.

At step 5820, if it is justified (Yes) to start DPS or maintain DPS activated, then operations proceed to a step 5825 to in fact set a DPS enable bit to start DPS or maintain DPS activated. If at step 5820, the opposite result is determined (No), then operations proceed to a step 5835 to instead clear a DPS enable bit to stop DPS or maintain DPS inactivated. After either step 5825 and step 5835, operations reach a decision step 5850. If a standby condition is met (Yes, e.g., such as all applications inactive) at decision step 5850, then operations branch to a step 5860 for Standby Leakage Management (SLM). Otherwise, if No at standby decision step 5850, then operations proceed to node 5760 and loop back to step 5720 to obtain a new performance prediction. If a system reset or system turn-off occurs, then operations at node 5760 instead terminate the DPS and DVFS power management until power management at step 5705 is resumed at or after warm boot BEGIN 5701 after system reset, or upon power-up 5703 from system turn-off or wakeup 5705 from a sleep mode such as one using SLM 5860.

In FIGS. 17 and 18, the described step 5755 is applied for example to voltage domain VDD1. Suppose OPP(V2, f2) transitions down to OPP (V1, f1) with f1<f2. A suitable process disables SR1 and programs a new count value corresponding to REFCLK at frequency f1 into sensor module SR1. PRM changes the frequency by changing a clock processor clock divider or setting new M,N value in the DPLL(1 or 2). Then SR1 is enabled by PRM.

In the described step 5780 applied for example to voltage domain VDD1, suppose next that OPP(V1, f1) transitions up to OPP (V2, f2) with f2>f1. A suitable process disables SR1, and unmask an OPPchange_done event in voltage processor VP. A next step programs a new count value for REFCLK corresponding to frequency f2 into sensor module SR1, and enables SR1. An OPPchange_done interrupt event is generated from voltage processor VP to the PRM. Next, PRM changes the frequency by changing a clock processor clock divider or setting a new M,N value in the DPLL(1 or 2).

When scaling up the frequency in step 5780, if the latency of the SR loop is too slow for a particular module, the following alternate sequence is suitably provided. First, disable SRI, and then program directly the OPP_{new} voltage in the switch mode power supply SMPS. Wait for ramp time (use a timer or software loop). Then change the frequency by changing the clock processor clock divider or setting new M,N value in the DPLL(1 or 2). Next, unmask the OPPchange_done event in voltage processor VP. Program a new count value into SR1, and enable SR1.

Note that if the DPLL2 M, N values are programmed in a frequency scaling step, DPLL2 outputs the bypass frequency during the relock time. Programming the M, N values to change the frequency may have a significant latency and using a clock divider instead can deliver a lower latency. DPLL2 relocks and does not prevent the processor from running during the relock time. DPLL2 bypass frequency is configured to be the output of DPLL3 instead of the sys_clk. (See also FIG. 27.) This feature reduces the possible impact on performance of setting a new M, N value in the DPLL.

The processor is free to run and execute programs during the whole DVFS sequence on VDD 1 and thus no need to idle the processors arises during OPP changes. Thus, the latency of the voltage and frequency scaling steps can be completely transparent to the software execution. As a result, OPP changes on VDD1 can be quite dynamic.

In voltage domain VDD2, when step 5755 moves to a lower performance new OPP, the new OPP allowed frequencies are made compatible with all module functional clocking operations as driven by the applicative environment at the moment of the change from one OPP to the new OPP. For example, the new OPP frequency is compatible with the camera and display functional clock frequency. This compatibility is related to screen and camera resolution and ongoing processing in these subsystems.

The clock scaling steps involves relocking a delay lock loop DLL inside the memory refresh controller SDRAM Memory Controller SDRC to relock. During the DLL relock time on the order of a number of microseconds, the DDR memory access is stalled. This constraint is handled in some of the modules as follows. The Camera module is suitably paused or stopped during clock scaling steps to avoid overflow. The DMA request latency is increased and can affect operation of some peripherals serviced by a DMA. The processors are arranged to either execute from internal memory caches or on-chip memory, or the processors are suitably stalled. The display controller relies on its internal FIFO during this time.

In FIGS. 17 and 18, step 5755 is applied for example to voltage domain VDD2. Suppose OPP(V2, f2) transitions down to OPP (V1, f1) with f1<f2. An example of a process provides:
i Disable Sensor Module SR2
ii Program into SR2 a new count value REFCLK for OPP1 lower frequency f1
iii Resolve potential processor, peripheral, camera and display access issues
iv Disable or set appropriately interconnect (L3) timeout values
v Set SRfrOnIdleReq bit (from On to Idle request) in SDRAM Memory Controller SDRC
vi Clear EN_SDRC enable bit in CM and poll ST_SDRC status
   Control Module asserts the IdleReq signal to the SDRC
   SDRC stops accepting new OCP transactions
   SDRC completes all on-going memory accesses and OCP transactions
   SDRC places the external DRAM in self-refresh
   SDRC asserts IdleAck
   ST_SDRC status bit is set.
vii Change the frequency by changing clock processor clock divider or set new M,N value in the DPLL1 or DPLL2
viii Enable Sensor Module SR2
ix If new M, N value is set, wait for DPLL relock
x Set EN_SDRC enable bit in Control Module
   Control Module releases the SDRC Idlereq.
   SDRC accepts any new or pending transaction after the DLL is locked.
xi Wait L3 latency cycles or read SDRC DLL lock status
xii Program new SDRC AC access control timing and auto-refresh parameters

From step vi to xi above, the SDRC is not accessed and therefore the software related to this part of the sequence is executed from cache, internal memory or external flash memory.

In step 5780 applied to voltage domain VDD2, suppose OPP(V1, f1) transitions up to OPP (V2, f2) with f2>f1. A suitable process provides:
i Disable Sensor Module SR2
ii Unmask in voltage processor VP the OPPchange_done event
iii Program into SR2 a new count value REFCLK for OPP2 higher frequency f2
iv Enable Sensor Module SR2
v Resolve potential processor, peripheral, camera and display access issues
vi Disable or set appropriately interconnect (L3) timeout values
vii Set SRfrOnIdleReq from-On-to-Idle request bit in SDRC
viii Clear EN_SDRC enable bit in Control Module and poll status ST_SDRC
   CM asserts the IdleReq signal to the SDRC
   SDRC stops accepting new OCP transactions
   SDRC completes all on-going memory accesses and OCP transactions
   SDRC places the external DRAM in self-refresh
   SDRC asserts IdleAck
   ST_SDRC status bit is set.
ix OPPchange_done interrupt event from VP (PRM)
x Change the frequency by changing clock processor clock divider or set new M,N value in the DPLL1 or DPLL2
xi If new M, N value is set, wait for DPLL relock
xii Set EN_SDRC bit in Control Module
   Control Module releases the SDRC IdleReq.
   SDRC accepts any new or pending transaction after the DLL is locked
xiii Poll SDRC DLL lock status
xiv Program new SDRC AC access control timing and auto-refresh parameters

From step vi to step xiii, the SDRAM Memory Controller SDRC is not accessed and therefore the software related to this part of the sequence is executed from cache, internal memory or external flash memory.

The system can present latency depending of the applicative environment when changing an OPP. For example, changing the display functional clock is performed on a frame boundary in order to avoid visible effect on the screen. This condition can involve a number of milliseconds latency when changing VDD2 OPP. The software infrastructure resolves access. In some embodiments, the DVFS transition latency is transparent to software. In other embodiments, that latency is suitably partly monitored by software. In still other embodiments the DVFS latency is made transparent to software for one or more voltage transitions such as on VDD1, while the DVFS latency is monitored by software for one or more other voltage transitions such as on VDD2.

A brief correlation and summary of some Figures is described next for some embodiments. PRCM hardware instantiates DPS/DVFS operations of FIG. 17 to transition between OPPs and determine when to turn on DPS. Putting the process in hardware allows PRCM to put microprocessor(s) on standby. However, software on processor(s) in FIG. 15 and new performance prediction steps 5720-5725 of FIG. 17 compute the target frequency for a given application or application mix. FIFO fill/full feedback signals as part of DPS operations tell state machine of FIG. 13 in PRCM when to transition and operate various parts of the system on chip 1400 per FIGS. 14A-14D. The state machine of FIG. 13 is suitably made part of the Device FSM in PRCM block diagram of FIG. 20, for instance. The DPS margin decision step 5820 in FIG. 17 starts/stops DPS at 5825 and 5835. When DPS is started in step 5825, that step 5825 can be applied to single or multiple power modules and can represent the state machine of FIG. 13 doing cyclic operations of FIGS. 14A-14D and responding to FIFO fill/full signals. FIG. 8B represents the power saving operations of DPS in FIGS. 14A-14D having power saving effect on a microprocessor ARM/IVA core portion of the system.

Turning to the analysis of DPSmargin, and with FIGS. 10A and 10B in mind, the decision criterion of step 5820 of FIG. 17, expressed in somewhat more specific terms, is whether this DPS margin function DPSmargin[Fₙ−f_{target}] exceeds some predetermined DPS margin value Margin_{DPS} (e.g., zero or some constant) chosen by the skilled worker to justify invoking DPS. This analysis is suggestive and illustrative without limitation on other embodiments and scope of their adaptation herein.

DPSmargin[Fₙ−f_{target}]>Margin_{DPS}.

The DPS margin function DPSmargin[Fₙ−f_{target}] can be estimated by considering the energy consumption formula

E=½CV²FT

In the formula E is energy, C is capacitance of the powered circuit, V is voltage, F is clock frequency, and T is execution time. In terms of dimensionless normalized power wherein ½ CV² ftarget is one unit of normalized power, energy is 1.0(F/f_{target}) T relative to normalized power. Capacitance C is summed over all the pipeline stages in all the pipelines of all the power managed processor cores. A given amount of application computing burden or load is equal to the product FT and represents the number of instructions for the application(s) executed by each pipeline stage on average. A processor running at a higher frequency F runs the same load in a shorter amount of time. The static energy consumption of the circuit at a given voltage V is x_{static} t, where x_{static} is the dimensionless normalized power level 4820.1 of FIG. 8A, and the symbol t represents the time interval during which the static power is drawn. The computer load of context save and restore, or save/restore load, is designated L_{SR}. The corresponding energy consumed by context save and restore, or save/restore load, is designated ½ CV²LSR.

Let target frequency f_{target} be that frequency at which there is no time for processor shut-down, so

E=½CV²f_{target}T.

In terms of static power divided by power consumed at target frequency (dimensionless ratio), let a normalized static power be defined as

x_{static}=P_{static}/(½CV²f_{target})

The computer load of the applications is symbolized L, and

L=f_{target}T.

At the range higher-end frequency Fₙ the time Tₙ needed to execute the same computer load is

Tₙ=L/Fₙ

The time interval t during which the static power is drawn is

t=T−Tₙ=L(1/f_{target}−1/Fₙ)

Without DPS the energy consumed is

E_{NoDPS}=½CV²L+½CV²x_{static}f_{target}L(1/f_{target}−1/Fₙ)

With DPS, and wherein the DPS runs at range higher-end frequency Fₙ, the energy consumed is written as follows:

E_{DPS}=½CV²L+CV²L_{SR}.

The DPS margin is defined for this description as a dimensionless normalized energy difference with and without DPS:

DPSmargin=(E_{NoDPS}−E_{DPS})/½CV²L

E_{NoDPS}−E_{DPS}=½CV²L+½CV²x_{static}f_{target}L(1/f_{target}−1/Fₙ)

(½CV²L+½CV²L_{SR}).

Combining the above equations and simplifying yields a DPSmargin function of frequency difference:

DPSmargin[Fₙ−f_{target}]=x_{static}(Fₙ−f_{target})/Fₙ−L_{SR}/L.

The skilled worker determines a dimensionless threshold value Thresh_{DPS}, such as zero or some positive constant, for the decision criterion of step 5820 of FIG. 17.

In decision step 5820, the decision criterion is accordingly written:

DPSmargin>Thresh_{DPS}.

Substituting the DPS margin equation into the decision criterion provides an inequality

x_{static}(Fₙ−f_{target})/Fₙ−L_{SR}/L>Thresh_{DPS}.

Rewriting as a frequency inequality, like that of decision step 5820, yields:

(Fₙ−f_{target})>(Thresh_{DPS}+L_{SR}/L)Fₙ/x_{static}.

Thus, using the notation of FIG. 17 step 5820, the DPS frequency margin criterion is

Margin_{DPS} =(Thresh_{DPS}+L_{SR/}L)Fₙ/x_{static}.

If the threshold value Thresh_{DPS} is chosen to be zero, then the frequency margin equation shows that relative to the range higher-end frequency, the per-unit margin reduces to:

Margin_{DPS}/Fₙ=(L_{SR}/L)/x_{static}.

This latter equation, for instance, says that DPS saves power for frequencies at least 10% below the range higher-end frequency Fₙ when the ratio of the cycles L_{SR} occupied by save-plus-restore for the application(s) divided by the cycles occupied by the applications is 10% or less of the normalized static power dissipation x_{static}. The static power dissipation P_{static} itself is the product of multiplying voltage times the static leakage current IDDQ, or product Vn IDDQ.

Since normalized static power dissipation x_{static}=P_{static}/(½CVₙ² f_{target}) from earlier hereinabove, then this equation reduces to

x_{static}=2 IDDQ/(CVₙf_{target}).

In different embodiments the choice of number of operating points OPP for DVFS is set at a low enough number to provide a wide enough frequency range for DPS to work effectively. In this way, the complexity of DVFS, for providing various voltage levels and frequencies and controls for all of them, is also quite acceptably moderate; and DPS provides a power managed power savings too.

These considerations lead to the recognition herein of a range of embodiments according to number of voltage levels or operating points OPP permitted by various power management mechanisms as described. It is recognized that for a substantial variety (but not necessarily all) of the embodiments, the number of voltages or operating points OPP is at least two so that DVFS can dynamically transition between plural operating points depending on system operating conditions. Also, it is recognized that for a substantial variety (but not necessarily all) of the embodiments, the number of voltages or operating points OPP is less than or equal to eight (8), so that DPS for at least some operating conditions has enough DPS margin to provide a power managed power savings too. For example, FIG. 12 shows four voltages V1-V4 (corresponding to operating points OPP1-4), and the illustrated number of four (4) OPPs lies in the range.

Savings using DPS is now compared with the savings using DVFS between adjacent OPPs. The power savings between adjacent DVFS OPPs n and n−1 is expressed in per-unit terms as a DVFS margin.

DVFSmargin=(E_{NoDVFS}−E_{DVFS})/½CVₙ²L.

E_{NoDVFS}−E_{DVFS}=½CVₙ²L−½CVₙ₋₁²L.

DVFSmargin=1−(Vₙ₋₁/Vₙ)²

As noted above, the DPSmargin for using DPS is

DPSmargin[Fₙ−f_{target}]=x_{static}(1−(f_{target}/Fₙ))−L_{SR}/L.

x_{static}=2 I_{DDQ}/(C Vₙf_{target}).

DPSmargin=I_{DDQ}(f_{target}−Fₙ)/(f_{target}½CVₙFₙ))−L_{SR}/L

When the DVFSmargin exceeds the DPSmargin, an embodiment transitions between DVFS OPPs. In some embodiments this is the strategy that is uniformly used when pre-computation or pre-testing of the circuitry verifies that the DVFSmargin always exceeds the DPSmargin,. In some other embodiments, the determination is made whether the DVFSmargin exceeds the DPSmargin and, if so, a DVFS OPP transition is permitted. However, in such other embodiments, if the DVFSmargin does not exceed the DPSmargin, then the DVFS OPP is maintained the same and the DPS is executed at the unchanged OPPₙ even when the target frequency f_{target} goes below the next lower frequency Fₙ₋₁ that would otherwise be used by DVFS.

The determination whether the DVFSmargin exceeds the DPSmargin is represented by an inequality

DVFSmargin>DPSmargin

Substituting from above produces the inequality:

1−(Vₙ₋₁/Vₙ)²>I_{DDQ}Vₙ(f_{target}−Fₙ)/(f_{target}½CVₙ²Fₙ))−L_{SR}/L.

A few qualitative observations can be made based on this inequality. First, if the voltage spacing of the OPPs is sufficiently great, meaning the OPPs are sufficiently few, then DVFS is used to transition between OPPs. Second, if the leakage current I_{DDQ} is relatively low, then DVFS is used to transition between OPPs. Third, if the capacitance C is relatively high, then DVFS is used to transition between OPPs.

Also, if the DVFS OPPs are defined so that the OPP frequency is linearly related to the OPP voltage, then

Vₙ−Vₙ₋₁=k(Fₙ−Fₙ₋₁) and

1−(Vₙ₋₁/Vₙ)²=1−[1−k(Fₙ−Fₙ₋₁)/V_{n]}²

Expanding the right side and substituting into the inequality above yields:

2k(Fₙ−Fₙ₋₁)/Vₙ−[k(Fₙ−Fₙ₋₁)/Vₙ]²>I_{DDQ}Vₙ(f_{taget}−Fₙ)/(f_{target}½CVₙ²Fₙ)−L_{SR}/L.

Next, multiply through by ½Vₙ and rearrange:

k(Fₙ−Fₙ₋₁)−I_{DDQ}(f_{target}−Fₙ)/(f_{target}CFₙ)+½VₙL_{SR}/L−½[k(Fₙ−Fₙ₋₁]²)Vₙ>0.

At an analysis point, target frequency f_{target} is equal to the next lower OPP frequency Fₙ₋₁.

Applying this analysis point to the inequality by substitution,

k(Fₙ−Fₙ₋₁)+I_{DDQ}(Fₙ−Fₙ₋₁)/(Fₙ₋₁CFₙ)+½VₙL_{SR}/L−½[k(Fₙ−Fₙ₋₁]²)Vₙ>0

Multiplying through by Fₙ₋₁/(Fₙ−Fₙ₋₁) yields

I_{DDQ}/(CFₙ)+kFₙ₋₁+½VₙL_{SR}Fₙ₋₁/((Fₙ−Fₙ₋₁)L)−½k²Fₙ₋₁(Fₙ−Fₙ₋₁)/Vₙ>0.

Some embodiments are arranged so that a highest OPPₙ voltage Vₙ and frequency Fₙ are selected based on the process parameters and pre-testing. Then the equation is used to determine the next lower OPPₙ₋₁ frequency Fₙ₋₁. Then the voltage Vₙ₋₁ is computed by the linear approximation:

Vₙ₋₁=Vₙ−k(Fₙ−Fₙ₋₁).

The inequality is iteratively solved at the tip-over point (0) for successively lower OPP frequencies and voltages by replacing the frequency, voltage pair Fₙ and Vₙ with the pair Fₙ₋₁ and Vₙ₋₁ in the inequality and solving for Fₙ₋₂. Then the voltage Vₙ₋₂ is computed from the linear approximation (or a piecewise linear portion of it), and the solution process is repeated to specify more OPPs.

Notice that DPS in FIGS. 13 and 14A-14D involves sequential power down and power up for several modules, such as processors. Accordingly, the above DPS analysis is applied to each module such as a processor in the manner described above, and extended to encompass DPS embodiments of the sequentially powered type as in FIGS. 13 and 14A-14D. In some more complex embodiments, DVFS applied to plural voltage domains and DPS is controlled according to a discrete optimization of power management over the system.

In some of these more complex embodiments, FIG. 17 is replicated and applies more than one right DVFS pair [Vn, Fn] to different particular individual ones of the plural voltage domains. In other words, one applicable DVFS pair [Vn1, Fn1] determined from a process of FIG. 17 is applied to a first voltage domain, and another applicable DVFS pair [Vn2, Fn2] determined from a replicated and distinct process of FIG. 17 is applied to a second voltage domain, etc. DPS decision step 5820 is supported by extended Software on MPU of FIG. 3 that suitably responds to user request, such as for audio player. The software determines the target performance for the system and appropriate configuration to PRM registers in FIG. 20 to configure the Device FSM to operate according to the state transition diagram of FIG. 13. Discrete optimization of power management over the system configured to run an audio player application is then translated into a current run-time configuration for DPS control for a given voltage domain or given set of power domains. In this way, respective target frequencies f_{target1}, f_{target2}, etc. are established for the processors and voltage domains of FIG. 17 so that DPS for each voltage domain or processor is turned on and activated under the respective applicable condition of DPS decision step 5820 in the FIG. 17 process pertaining to that voltage domain or processor.

When another user request or automated system request, such as for display operation or video player, is involved, a different configuration is suitably loaded by software into the PRM registers of FIG. 20 to create a different state machine process represented by a different or more comprehensive state transition diagram than that of FIG. 13. Also, multiple applications run concurrently in some embodiments, and suitable power management configurations and controls for them are provided in some embodiments. In this way, a high-performance DVFS/DPS/AVS power management control is provided by a mixed software (for configuration updating) and hardware (for control when the MPU is powered down) in some of the embodiments.

One embodiment provides a 65-nm mobile multimedia applications processor with an adaptive power management scheme to compensate for wafer fabrication process variations. By using multiple voltage domains, fine grain power domains, split-rail memories, and adaptive compensation, SoC active power reduction and leakage power reduction are achievable. A dual pipeline microprocessor and IVA multimedia accelerator are included. IVA has a digital signal processor (DSP) and provides multi-standard (MPEG4, WMV9, RealVideo®, H.263, H.264) encode/decode at D1 (720×480 pixels), and 720p MPEG4 decode. Also integrated are a 2D/3D graphics engine, a Mobile DDR Interface, and numerous integrated peripherals as selected for a particular system solution.

PRCM hardware and software power management processes reduce both active switching power and leakage power. Active power reduction is achieved through Voltage/Frequency scaling. Voltage scaling is enabled through multiple voltage domains, and split-rail memories. Two main power supplies power the core logic and peripherals separately from the processor cores, and are termed voltage domains. The voltage domains are decoupled so that, for example, high bandwidth autonomous DMA transactions are run off a higher voltage while the low frequency microcontroller is run off a lower voltage to optimize SoC power. The processor cores are designed with multiple discrete Operating/Performance Points (OPPs) such as at 125%, 100%, 50%, and 25% of a nominal design frequency, and application OPPs are software programmable to a coarser or finer resolution. Some fixed function peripherals (e.g. MMC/SD interface) are synthesized to allow operation across OPPs, while others, (e.g. Mobile DDR SDRAM) are scaled in clock frequency at lower OPPs.

Process/Temperature compensation utilizes a silicon performance monitor to adjust each core logic supply independently. An Adaptive Voltage Scaling (AVS) module contains sensor modules SR1 and SR2 that allow the SoC to adaptively lower or raise voltage levels as the process, temperature, and aging vary across time and process spread. The monitors feed to dedicated hardware control of external switch mode power supply SMPS voltage converters, see FIG. 5. Adaptive adjustments are made as needed. Control loop bandwidth is programmable and is suitably set in a range between 10 KHz and 1 MHz (e.g., at 100 KHz) in some embodiments, while other bandwidths are used in some other embodiments.

Leakage Power Management recognizes that the leakage power dissipation of about 150 million transistors in one embodiment can consume up to 30% of the total power in active modes (higher in standby modes). Some voltage domains reduce leakage through supply modulation. Moreover, fine-grain power domains are established by power gating techniques for leakage management as described in Royannez etal. “90 nm Low Leakage SoC Design Techniques for Wireless Applications” ISSCC 2005. These are deployed in several power domains in the application processor 1400. Low-leakage SRAM memory retention and power down also reduce power.

An Off mode with low standby power is established by circuitry that fully powers down the core logic supplies. In the low-cost 65nm process, power management components (switches, isolation cells, etc.) are built using a core thin oxide device with a single threshold voltage. In order to achieve 100 μA standby leakage current with 150 million transistors, core supplies are lowered to 0V. An integrated linear regulator is used to generate a third core logic supply which powers a smaller amount of wake-up and watchdog/timer logic. This circuitry retains important system state information and allows emulator/debugger access. High threshold voltage V_{T} transistors are not used in some embodiments, thus minimizing both process and circuit complexity, and lowering manufacturing cost. Power reduction is enjoyed in modes in which significant portions of the chip are power gated.

Various embodiments for combining AVS power management are now described in connection with FIGS. 18-21.

In a first embodiment, such as for manufacturing test calibration, performance of the chip is directly measured at manufacturing test and the required operating voltage for that device is determined. This information is permanently programmed (fused) into each die.

In a second embodiment, such as for boot-time software calibration, a host MPU performs a boot-time calibration by initializing the AVS sub-chip of FIGS. 18 and 20 for a certain performance level and proceeding to exercise the SOC in pre-defined operating conditions. The AVS sub-chip digital processing records minimum/maximum/average performance data that is used by the host MPU to adjust the power supply voltage to guarantee a performance level. Once calibration is completed, the AVS sub-chip is disabled.

In a third embodiment, such as for continuous software calibration, AVS sub-chip is enabled continuously and tracks low frequency components of variation in real time. This embodiment gains some margin improvement over the second embodiment. Two variants of the third embodiment are described next. One variant provides a timer interrupt or some other system event (e.g. frequency or mode change) to initiate

interrogation of the AVS sub-chip. In another variant, the AVS sub-chip generates a host MPU interrupt when the sensor frequency is detected outside an acceptable range.

In a fourth embodiment, such as for continuous hardware calibration, the AVS sub-chip interfaces directly with a Voltage Processor module of FIGS. 18 and 20 which automatically calculates the desired voltage change. The Voltage Processor module communicates the desired voltage change to the voltage supply across a hardware interface (e.g. 12C) when the error is outside an acceptable range.

In a fifth embodiment, such as for fully integrated solution, the Power Supply is on-chip. System margins are further reduced since the device can be measured in terms of battery voltage, power and performance. The core voltage is not an independent variable with its own margins.

AVS in some process and structural embodiments operates to variably lower the operating voltage of the transistors (e.g., from 0-200 mV) over the range of weakest process transistors to strongest process transistors. Thus, the AVS voltage is reduced for nominal silicon so that the voltage and speed of the nominal silicon is closer to that of weak silicon. The AVS voltage for strong silicon is even further reduced than for nominal silicon so that the voltage and speed of the strong silicon is closer to that of weak silicon as well. This variable control of the operating voltage depending on the weak, nominal, and strong processes, compresses the path delay distribution over numbers of the thus-controlled devices considered collectively. Moreover, AVS operated in this way results in significant active power reduction and leakage power reduction.

The AVS process herein acts as a voltage control loop that presents a degree of latency representing the time needed to respond to changes in its environment. This latency is responsive such as to process variation, power supply DC level, and temperature changes, and DC portions of the printed circuit board (PCB) and device IR (ohmic) voltage drop. In FIGS. 18 and 20, each voltage sensor and digital filter accumulates a measured value of a parameter and its average error AvgError according to an averaging window. The voltage processor then sends an interrupt to the power supply interface control logic. In the third embodiment hereinabove, the interrupt is serviced, the voltage is calculated, and the 12C port is requested, any 12C contention resolved, and 12C serial exchange is performed. Next the power supply responds to the calculated voltage over a period of time called the settling time. The settling time depends on the size of the voltage step and the voltage slew rate of the power supply. The voltage processor suitably waits a somewhat longer period of time than the settling time to ensure voltage control loop stability and have desirable overdamping (non-oscillatory or non-hunting behavior) in the control loop performance. The voltage is changed from one OPP to another OPP in a suitable number of steps to that overdamped performance is maintained. In some embodiments the settling time for widely-separated OPPs is on the order of a millisecond, more or less.

In FIGS. 18, 20 and 25, Power and Reset Manager PRM is located in the WAKEUP domain and runs off the sleep clock (32 kHz or sys_clk on order of tens of MHz). The PRM controls the sys_clk oscillator and supplies the 32 kHz and sys_clk to the Clock Manager CM. PRM generates primary source clock, device global reset, and local reset for power domains. PRM controls power domains sleep/wakeup transitions between inactive and retention and off power states. PRM controls isolation cells, controls retention flipflop save and restore, controls power domain switches, controls memory states, and controls level-shifters. The PRM detects power domain wakeup events, manages power domain wakeup transition dependencies, and controls wakeup domain input isolations. The PRM sequences device transition to and from OFF mode, controls analog cells OFF state (internal LDO, etc.), and switches to OFF mode pad configuration. The PRM controls IO isolation for power transition glitch control, and IO wakeup, and detects OFF mode wakeup events. The PRM manages the interface with the AVS sensors, and manages interface with power IC such as supply voltages VDD1 and VDD2 from external switch mode power supply SMPS1 and SMPS2. The PRM latches the sys boot signals at power on reset from POR 1042 of FIGS. 1 and 16.

The PRM includes a Device state machine FSM, a Voltage domain state machine FSM, a Power manager domain state machine FSM, and a power switching controller state machine PSCON. The PRM has a Domain Wakeup Control circuit, a Global Reset Manager circuit, and a Local Reset Manager circuit. In addition the PRCM includes each voltage processor VP to interface with the Sensor Modules SR1 and SR2 and compute a voltage value from the sensor module SR error, and the voltage controller VCON to interface with voltage processor VP and format and send the voltage value over the I2C interface.

The PRCM has an OCP (Open Control Protocol) bus interface to access PRM control and status registers. This OCP interface runs off the system clock and is connected to the wakeup block. The PRM registers of FIG. 20 include Control Registers 6710 of FIG. 27 and are used, for instance, for DVFS/DPS power managed operation. Some embodiments include the PRM registers of FIG. 20 and Control Registers 6710 of FIG. 27 in the Control Module 2765 of FIG. 3. Other embodiments have the PRM registers and Control Registers 6710 separate and configurable and run-time re-configurable from Control Module 2765 and/or the OCP bus from MPU and/or IVA processors. Some hardware-controlled embodiments load the contents of the PRM registers and Control Registers 6710 from and under the control of the Device FSM of FIGS. 20 and 23 and control those registers to power manage the system in a manner such as depicted in FIGS. 13 and 14A-14D. Higher level parameters or controls on functionality of Device FSM are configurable by boot or initialization software from MPU and/or IVA processors, see FIG. 15.

The Clock Manager CM is located in the Core domain and includes a Clock Generator CG 6520 and a Clock Controller CC 6540 in FIG. 25. The Clock Manager CM has an OCP interface for MPU to access CM control and status register bit fields in Control Registers 6710 of FIG. 27. Clock Generator CG generates and distributes various clock signals and clock enable signals used in the SOC device. Part of the Clock Generator CG is located in the MCU and IVA domain to generate the clock of these subsystems. The CG uses as input the source clock from the PRM and the DPLLs.

In FIGS. 25 and 27, the Clock Controller CC 6540 handles device clock gating and manages power domain sleep/wakeup transition between On and Inactive power states. The Clock Controller CC manages Smart Idle handshake protocol with target modules, and manages Smart Standby handshake protocol with initiator modules. Clock Controller CC detects power domain sleep transition conditions, manages power domain sleep transition dependencies, and controls power domain clock signal gating. Clock Controller CC has a Module clock state machine FSM and a Clock manager domain state machine FSM associated with Control Registers 6710 of FIG. 27 and see FIGS. 28A-31 for operations related to them.

In FIG. 18, PRM has an interrupt circuit to generate interrupts to MPU and IVA processors. The interrupts respond to and depend on PRCM and CM internal events or external peripherals wake-up events. Depending on the context, the PRM can process a domain wake-up associated to the interrupt event. The interrupt events are maskable in the PRM interrupt enable register. Their status is readable in a PRM interrupt status register.

An interrupt PRCM_MPU_IRQ in FIGS. 18 and 21 is coupled from PRM to the MPU Interrupt controller INTC when any of the following events has occurred. 1) MPU peripherals group wake-up event, 2) End of ON time event, 3) End of OFF time event, 4) a sleep or wake-up transition has completed (in imaging/video, compressor, SGX, DSS, camera, peripheral, USB host, emulator domains). Further events to which interrupt PRCM_MPU_IRQ responds are: 5) recalibration events for DPLL of MPU, IVA, Core Domain, Peripherals P1 and 2^{nd} Peripherals P2, and 6) status events for Voltage Controller (VCON) error, and for either of Voltage processors 1 and 2, IO pads wake-up, and either of VDD1 and VDD2 voltage control timeout.

Another interrupt PRCM_IVA2_IRQ is coupled from PRM to IVA Wakeup generator when an IVA peripherals group wake-up event has occurred or a forced wakeup transition has completed for IVA domain wakeup.

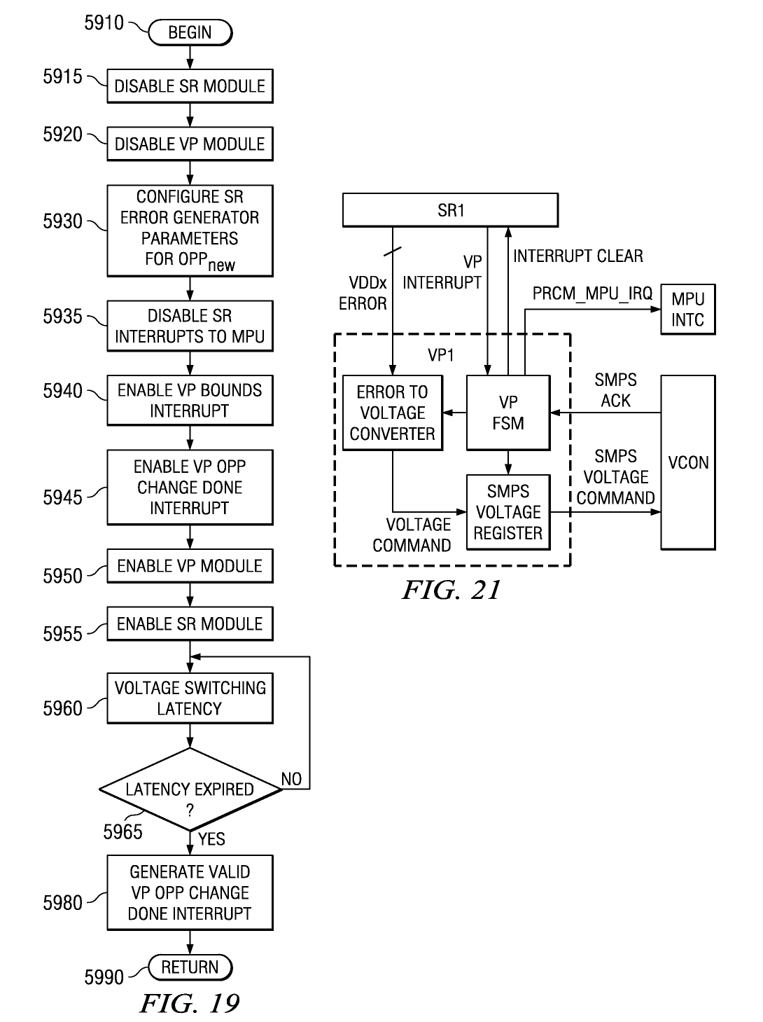

In FIG. 19, a process for OPP change commences with a BEGIN 5910 and proceeds to disable each sensor module SR in a step 5915 and to disable the corresponding Voltage Processor VP module in a step 5920. Compare with FIGS. 18, 20 and 21 and with discussion of steps 5755 and 5780 of FIG. 17. In FIG. 19, a step 5930 configures the sensor module SR error generator parameters for the new OPP_{new}. A succeeding step 5935 disables the sensor module SR interrupts to the MPU. A step 5940 then enables the voltage processor VP Bounds interrupt when the error exceeds bounds for staying in a given OPP. If exceeding bounds, DVFS signals hardware to change the OPP.

Then a step 5945 enables a VP OPP Change Done interrupt from hardware indicating completion of the OPP transition. Next a step 5950 enables the Voltage Processor VP module, and a step 5955 enables each Sensor Module SR or the applicable Sensor Module SR. A further step 5960 represents voltage switching latency in the 12C communications path and the power IC 1200. A decision step 5965 determines whether the latency has expired by activating a counter and counting to expiration of a predetermined or configured time interval. When the latency has expired, operations proceed to a step 5980 to generate an interrupt called a Valid VPP OPP Change Done interrupt. Then operations are completed and reach RETURN 5990.

In FIGS. 20 and 23, the PRM Voltage management has several blocks that manage the different voltage sources. Two voltage processors convert AVS sensor errors in voltage values sent to the voltage controller VCON. The voltage FSMs 1 and 2 manage respectively VDD1 and VDD2 voltage with the applicable portion of each FSM depicted as the FSM in FIG. 23. They either send commands to the voltage controller (I2C mode) or controls VMODE1 and VMODE2 signals (direct control mode). The voltage controller VCON gathers commands from register (direct access), voltage processors and voltage FSMs. VCON then handles communication with the external IC through the dedicated 12C interface. A GPCON FSM controls SRAM and wake-up LDOs, analog cells sleep mode and level shifters. A devices FSM sequences GPCON, voltage FSMs and IO FSM during device OFF sleep and wake-up transitions. IO FSMs manages IO OFF mode control. In this way, static leakage management (SLM) is integrated with DVFS/DPS/AVS active power management.

Adaptive power supply AVS reduces active power consumption. The power supply voltage is adapted to the silicon performance either statically (depending on the device manufacturing process), or dynamically (depending on the temperature induced current performance of the device). An AVS sub-chip uses sensors to monitor the silicon performance and outputs a measure of the performance error.

When performing DVFS, the software or user can program a new operating point in the sensor module by programming the new reference frequency REFCLK and causes the sensor module to re-calculate the error. When error data is stable, it is transmitted to the Voltage Processor. The Voltage Processor takes the average frequency error from the AVS sub-chip and determines the appropriate voltage level to program into the power supply. The Voltage Processor monitors the interrupt signal and error value from the respective AVS sensor module SR, and automatically adjusts the power supply by sending a voltage command to the Voltage Controller.

In FIGS. 18 and 20, Sensor modules SR1 and SR2 are respectively provided for voltage domains for VDD1 and one for VDD2. These sensor modules are configured through their own OCP bus interface. Continuous hardware calibration of the sensor modules is provided. However, the software or user can also disable the voltage processors and do continuous software calibration, based on interrupts generated each time the error values are updated.

Two instances of Voltage Processors VP 1 and VP2 are respectively associated to these sensor modules SR1 and SR2 to convert generated frequency errors in voltage commands. Each of the Voltage Processors VP1, VP2 respectively contains a Look-Up Table and is correctly initialized and configured to optimize the voltage control. Voltage Processors VP1, VP2 and related control registers (cf. 6710 of FIG. 27) are parts of PRM module.

In FIG. 21, Sensor Module SR1 couples VDD1 error to an Error-to-Voltage converter block in voltage processor VP1. The Error-to-Voltage converter monitors the Sensor Module SR1 error interface and converts the frequency error to a voltage level. Then the Error to Voltage converter in turn provides a voltage command to an SMPS voltage register in Voltage Processor VP1. Sensor Module SR1 provides an interrupt signal to a Voltage Processor Finite State Machine VP FSM, which in turn controls the Error-to-Voltage Converter and the SMPS voltage register. The VP FSM provides an interrupt clear back to Sensor Module SR1. VP FSM provides an interrupt PRCM_MPU_IRQ to the MPU interrupt controller INTC. The SMPS register supplies an SMPS voltage command to the Voltage Controller VCON which in turn communicates via I2C to Power IC 1200 to adjust the voltage to the commanded voltage. Voltage Controller VCON returns an SMPS acknowledge SMPS ACK.

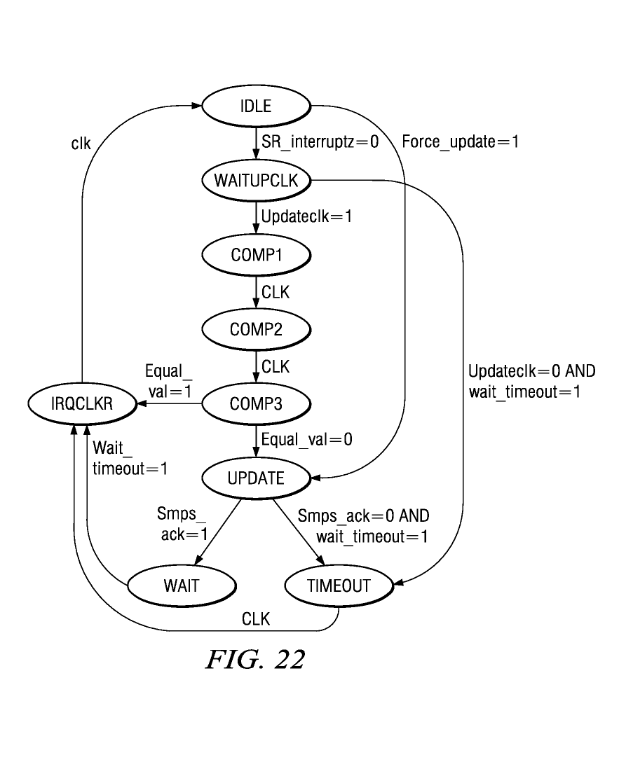

In FIG. 22, the VP FSM of FIG. 21 has a section associated with interface I2C IF in FIG. 20, and has a state transition diagram such as that illustrated in FIG. 22. The VP FSM begins at an IDLE state and monitors a low-active Sensor Module SR1 interrupt SR_interruptz. A register interface contains configuration and control signals for the Voltage Processor VP1 and provides a mechanism for the host MPU to read the Voltage Processor VPI status. When a voltage change is requested by low-active SR_interruptz, the VP FSM processes the information given by the register interface and generates a voltage update using a comparator process at states WAITUPCLK, COMP1, COMP2, COMP3. When comparison supplies equality signal Equal_val, the update is ready. If the equality signal is not obtained as expected, VP FSM clears the interrupt at a state IRQCLKR and returns to IDLE. Software can also apply a Force_update signal to transition the VP FSM from the IDLE state directly to the UPDATE state. At a state UPDATE the VP FSM sends an update called a SMPS Voltage Command (FIG. 21) to the SMPS interface, and waits for the SMPS interface to acknowledge that the voltage has been set. After the acknowledgement ACK is received, the VP FSM waits at a state designated WAIT for the SMPS voltage to settle before clearing or resetting (IRQCLKR) the Sensor Module interrupt and returning to an IDLE state to wait for a new voltage change request. Also, if no SMPS acknowledgement is received, then VP FSM has a default waiting period at a state TIMEOUT and when a wait_timeout signal goes active to indicate that the waiting period is expired, then the VP FSM clears or resets the Sensor Module interrupt in due course at a state IRQCLKR and returns to an IDLE state.

The VP FSM of FIGS. 21 and 22 administers and waits for voltage updates for a period of time based on the size of the voltage requested, allowing the supply voltage to settle. These wait times are programmed into a configuration register and are based on the operational characteristics of the SMPS and I2C communications subsystem. When a specified delay time has elapsed for the SMPS voltage to settle, the Voltage Processor Controller clears the Sensor Module SR1 interrupt by issuing an Interrupt Clear signal in FIG. 21. This starts the VP FSM loop again, waiting for another interrupt from the Sensor Module SR1.

Note that the arrangements of FIGS. 21 and 22 for Sensor Module SR1 and Voltage Processor VP1 are equally descriptive of Sensor Module SR2 and Voltage Processor VP2 in FIGS. 18 and 20.

The Voltage Controller is a part of PRM and interfaces internally to the Voltage Processors, as well as with the two voltage device FSMs. Externally, it interfaces to a Power IC, through a dedicated I2C interface. To reduce latency of voltage changes, the Voltage Controller is configurable to run in High-speed I²C mode.

The Voltage Controller handles five input ports as follows: VDD1 and VDD2 Voltage Processor ports input voltage commands depending on sensor module calculations (during device activity). VDD1 and VDD2 device FSMs input voltage commands when the device enters in retention mode, or in OFF mode, and upon device wake-up. Direct software control is a fifth input port.

An arbitration scheme allows managing overlapping requests on the five ports. Each of the internal ports has a handshake to indicate when the I²C frame resulting from the request on that port has been acknowledged by the external Power IC. The Voltage Controller uses some PRM registers for configuration values.

If Power IC does not support I2C interface, a simpler voltage command can be used to control two voltage values per voltage domain (VDD1, VDD2), controlling external VMODE1 and VMODE2 signals. These two signals are used alternatively with I2C and are muxed on the same device pins in FIG. 20. The Muxes are managed from the Control Module.

FIGS. 20 and 23 show an overview of PRM power management wherein the PRM controls the several voltage domains. PRM also does Logic power switches control, Retention flip-flop control, Memory power switches control, Embedded LDOs (SRAMs, Wakeup, Emulation) control, IOs OFF mode control, and External power IC control. In an example, each power domain is driven by the PRM in any of various different power states of TABLE 6, depending on the functional mode desired by the user. TABLE 6 expands on TABLE 1.

TABLE 6
POWER STATES

| | Power Logic | | | |
|---|---|---|---|---|
| Power State | DFF | RFF | Memory | Clocks |
| Active | On | On | On, Ret, or Off | At least one On |
| Inactive | On | On | On, Ret, or Off | All Off |
| Retention CSWR | On | On | Ret or Off | All Off |
| Retention OSWR | Off | On | Ret or Off | All Off |
| Off | Off | Off | Off | All Off |

CSWR stands for Closed SWitch Retention. In CSWR mode, the full domain logic is maintained supplied, and the voltage is reduced to a low non-zero voltage to minimize leakage. OSWR stands for Open SWitch Retention. In OSWR mode, the full domain logic is switched OFF. However context is saved for the modules that embed retention flip-flops (RFF). In both cases, memories are put in retention or can be also switched OFF.

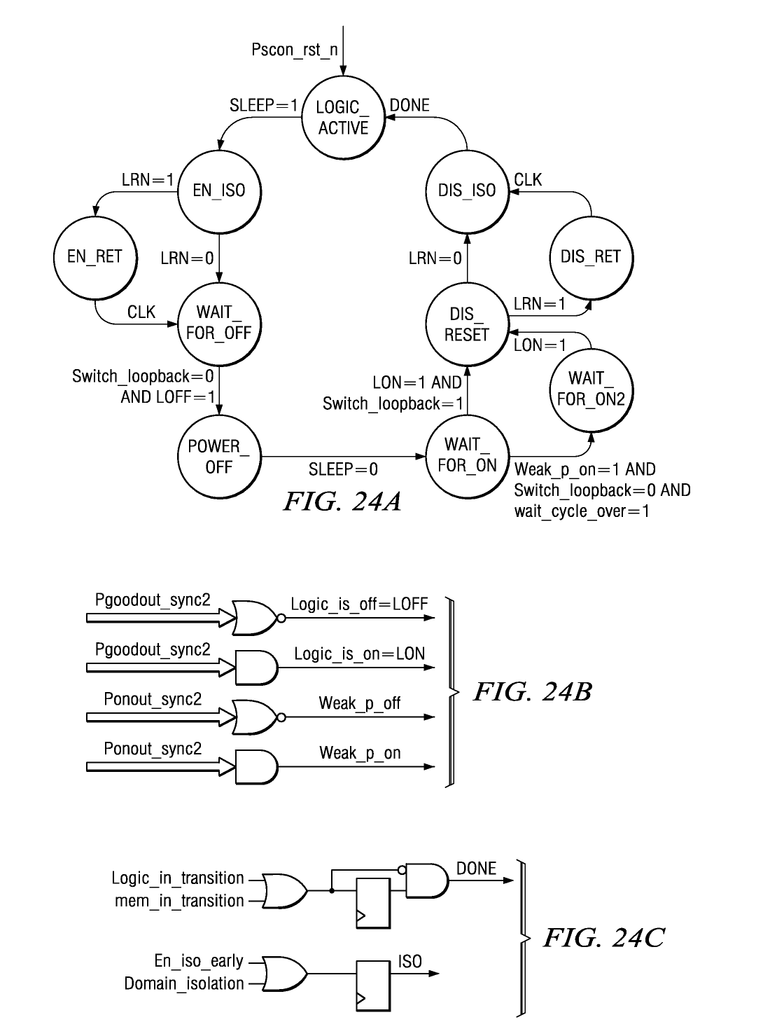

In FIGS. 23 and 24A-24C, and in TABLE 6, for each power domain, the PRM FSM circuitry properly manages transitions by controlling domain clocks, domain resets, domain logic power switches, memory power switches, and memory retention. Examples of supported transitions are Active=>Inactive; Inactive=>Active; Active=>Retention; Retention=>Active; Active=>Off, and Off=>Active. Domains power state combinations are supported by hardware, which physically protects the power domains by controlling isolation of the domains. The software properly sets the power states combinations to ensure correct functional behavior.

In FIGS. 23 and 24A-24C, the PRM embeds for each power domain a power state controller PSCON that sequences properly ON to OFF and OFF to ON transition. The control is mainly based on three signals (Power on Ponin, RET, ISO) for the logic, plus two other signals per memory bank. The control is handled by a dedicated state machine, the PSCON (Power State CONtroller). A retention signal RET is used to control retention flip-flops when logic retention state is required. State machine PSCON is suitably replicated as plural state machines, demuxed, and/or coupled to each of various power domains in order to implement desired controls over the power domains.

In an Active to Retention transition, PSCON asserts ISO signal to isolate domain outputs, then asserts then the RET signal to save RFF content, and releases the Power on Ponin signal to open the switch. In a Retention to Active Transition, PSCON asserts the Power on Ponin signal to close the switch, then releases the RET signal to restore RFF content, and releases ISO signal to de-activate isolation of domain outputs. In an Active to Off transition, PSCON asserts ISO signal to isolate domain outputs and releases the Power on Ponin signal to open the switch. In an Off to Active transition PSCON asserts the Power on Ponin signal to close the switch and then releases ISO signal to de-activate isolation of domain outputs.

In some embodiments, each power domain switch is composed of one or several small switches daisy chains spread over the domain physical layout. These daisy chains are managed by the PSCON (Power State Controller) which properly sequences the domain isolation, the logic/memory save/restore procedure (retention) and switches daisy chains control. For big power domains (such as MPU), several daisy chains can be used and are controlled in parallel by the same PSCON. This way, PSCON can reduce switching duration while better managing the switch transition peak current. For small domains (such as DPLL) or domains that have slower wakeup time, one daisy chain is used. One PSCON can drive daisy chains for several memory blocks.

In FIG. 24A, state machine PSCON has a set of state machine states shown as circles connected by transition arrows. Each state collectively represents an output vector, meaning a set of output signal bit-states, several of which are shown in FIG. 23. The output signals are Power-on input Ponin, Good power input Pgoodin, Isolation enable Eniso corresponding to ISO of FIG. 23, Retention RET, low-active Reset voltage Vresetz, and a signal Logic_in_transition. The output signal states remain the same from state to state unless a change therein is described below.

In FIG. 24A, PSCON has a POWER OFF state represented by vector (0,0,1,ret,0,0). All the signals are low except Enable isolation Eniso is active, and Retention RET has whatever state was set for the circuit when the circuit was put in its low power state. As long as a control signal Sleep is active (1) when PSCON is in the POWER OFF state, then PSCON remains in that state. When control signal Sleep goes inactive (0), then as shown in FIG. 24A, state machine PSCON transitions to another state WAIT_FOR_ON. In that state, the Ponin signal goes active (1) and Logic_in_transition goes active. The other output vector signals retain their values.

Occurrence of Logic_is_on (LON) when active concurrently with Switch_loopback active initiates a transition from PSCON state WAIT_FOR_ON to a disable reset state DIS_RESET. The LON signal is provided by logic of FIG. 24B. In FIG. 24A, the DIS_RESET state makes Pgoodin go active and reset Vresetz goes inactive high to disable the reset. Some embodiments provide an alternative and additional intermediate state WAIT_FOR_ON2 between WAIT_FOR_ON and the disable reset state DIS_RESET. A transition from WAIT_FOR_ON to WAIT_FOR_ON2 is initiated when a concurrence of the following signals happens: Weak_p_on=1 and Switch loopback=0 and wait_cycle_over=1. This allows a wait cycle or period to be permitted and utilized. Compared to WAIT_FOR_ON, the state WAIT_FOR_ON2 sets Pgoodin active to a power domain switch in FIG. 23, but keeps the other output bits the same, including Vresetz active low. Then subsequently when Logic_is_on (LON) goes active, a transition is made from WAIT_FOR_ON2 to disable reset state DIS_RESET wherein reset is lifted by making Vresetz inactive high.

In FIG. 24A, turn-on operations in state machine PSCON now confront isolation of the circuit of FIG. 23. When a signal Logic_ret_needed goes inactive (0), PSCON makes a transition from disable reset state DIS_RESET to a disable isolation state DIS_ISO. In the state DIS_ISO, the enable isolation Eniso is inactivated and the retention signal RET is inactivated. Some embodiments provide an alternative and additional intermediate state DIS_RET so that an active state of LRN=1 transitions from disable reset state DIS_RESET to the disable retention state DIS_RET. In state DIS_RET, the output signal RET is inactivated but enable isolation Eniso remains active. Then after a clock cycle or when LRN=0, a further transition is made from state DIS_RET to disable isolation state DIS_ISO whereupon the further step of inactivation of enable isolation Eniso is executed.

In FIG. 24A, at state DIS_ISO, the logic is still in transition in FIG. 23 but the outputs of state DIS_ISO are driving that logic to be operationally active. When the transitioning is complete, a done signal from FIG. 24C initiates a transition from state DIS_ISO to the state LOGIC_ACTIVE of FIG. 24A. The state LOGIC_ACTIVE now has output Logic_in_transition inactivated compared to state DIS_ISO. The state LOGIC_ACTIVE delivers output vector (1,1,0,0,1,0) meaning that Ponin and Pgoodin are active high (also called Poweron), enable isolation Eniso and retention RET are inactive low, reset Vresetz is inactive high, and Logic_in_transition is inactive low.

State machine PSCON includes an analogous set of states and transitions to handle a process of taking operationally active circuitry in a power domain to a power-off condition. In FIG. 24A, a control signal Sleep goes active and initiates a PSCON transition from the state LOGIC_ACTIVE to a state EN_ISO wherein enable isolation Eniso and Logic_in_transition are set active. PSCON responds to the Logic Retention Needed LRN signal, if active, to transition to an enable retention state EN_RET wherein output signal retention RET is activated, and a clock CLK initiates transitions onward to a state WAIT_FOR_OFF. Additionally, PSCON at state EN_ISO responds to the LRN signal, and if inactive to transition directly to the state WAIT_FOR_OFF. At the state WAIT_FOR_OFF, power Ponin and power good input Pgoodin are both inactivated (0) at the circuitry of FIG. 23 and retention RET is maintained at whatever bit-state it either had in state EN_ISO (RET inactive) or was given by state EN_RET (RET active).

In FIG. 24A, the POWER_OFF state is reached by transition from the WAIT_FOR_OFF state when a concurrence of signals Switch loopback is inactive and Logic_is_off (LOFF) is true (1). Compared to the state WAIT_FOR_OFF, the state POWER_OFF state activates the reset Vresetz to active low, and Logic_in_transition is set inactive low.

In FIG. 24B, the Logic_is_off (LOFF) signal to PSCON is provided by a NOR gate having inputs for the Pgoodout signals from the power domain power switch of FIG. 23. The Logic_is_on (LON) signal to PSCON is provided by an AND gate having inputs for those Pgoodout signals of FIG. 23. A signal Weak_p_off is provided by a NOR gate having inputs for the Power on output (Ponout) signals from the power domain power switch of FIG. 23. The Weak_p_on signal to PSCON is provided by an AND gate having inputs for those Ponout signals of FIG. 23.

In FIG. 24C, the transition signal Done to PSCON of FIG. 24A is provided an AND gate having a high active input coupled to the output of a clocked D-flipflop. The AND gate also has a low active input connected to a data input of the D-flipflop and to the output of an OR-gate. The OR-gate has one input for the output signal Logic_in-transition from PSCON, and another input for a signal Mem_in_transition, for circuitry that uses such a signal. Further in FIG. 24C, the ISO signal of FIG. 23 and Eniso signal of FIG. 24A are provided by another clocked D-flipflop having a data input connected to the output of another OR-gate. That OR-gate has control signal inputs for En_iso_early (or Eniso of FIG. 24A) and a control register signal Domain Isolation which can be used to override the PSCON.

In FIGS. 20, 25 and 26, a SYS_OFFMODE signal is asserted when the device enters in OFF mode (VDD1 and VDD2 shut down). In this way, Static Leakage Management (SLM) is further enhanced. The external power IC 1200 can itself use the SYS_OFFMODE signal to properly manage VDD1 and VDD2 OFF entry and exit sequences.

The main power supply sources, VDD1 and VDD2 can be controlled according to three different modes, selected in the Control Module: Direct control, I2C control, and software SW control.

Direct control with VMODE signals of FIGS. 18 and 20 utilizes a simpler voltage command to manage two voltage values per voltage domain (VDD1, VDD2), by controlling VMODE1 and VMODE2 signals. VMODE signals are used to request new voltage levels to the external switch mode power supply. They allow the switch mode power supply to switch into the lowest functional voltage of the device. This transition is enabled by software according to a dedicated PRCM register (PRM_VOLTCTRL.SELVMODE) and is triggered when the device enters in retention or OFF state.

The Power IC 1200 initiates a voltage transition scenario upon assertion of this signal and another voltage transition scenario upon de-assertion of this signal. For example, a power IC is configured by software through the I2C interface to establish the voltage values corresponding to the two respective VMODE signals states and to be sensitive to VMODE signal activation. Selection of I2C or VMODE interface is accomplished by programming selection mux in CONTROL_PADCONF_i2c4_scl and CONTROL_PADCONF_i2c4_sda registers in Control Module.

The voltage controller can drive independent voltage channels, one for VDD1 and one for VDD2, through the SR I2C. One or more programmable I2C bus slave address values for each SR accommodate respective SMPS cores or separate devices each with a respective slave address. Voltage configuration register address values correspond to the address of the registers in the power IC used to program the voltage value for VDD1 and VDD2 SMPS. When the Power IC is in Active mode, the voltage controller drives VDD1 and VDD2 SMPS by writing over the I2C interface a voltage value at the respective address of VDD1 and VDD2 voltage configuration registers in the power IC.

Programmable Command configuration register address values correspond to the address of the registers in the power IC used to program the command value for VDD1 and VDD2 SMPS. The voltage controller selects VDD1 and VDD2 SMPS modes of operation by writing over the I2C interface a respective multi-bit command value at the respective address of VDD1 and VDD2 command configuration registers. The multi-bit command values correspond, for instance, to ON or Active mode, On Low Power or Sleep mode, Retention mode, and OFF mode.

When the ON/Active command is sent, the SMPS reverts to its Active mode of operation at a voltage value which is either the reset voltage value of the SMPS or optionally a configurable value. When the Sleep command is sent, the SMPS enters its Sleep mode of operation at a voltage value which is either the present voltage value of the SMPS or a configurable value. When the Retention command is sent, the SMPS scales the voltage down to a retention voltage and the integrated circuit 1400 enters a Sleep mode of operation. The retention voltage is configurable in the power IC at a lower voltage than the Active mode or Sleep mode. When the OFF command is sent, the SMPS enterd its OFF mode and to shut down its voltage (0v).

The retention voltage and optionally the Active and Sleep voltage are configurable. The values of these voltages can be either programmed in separate register in the Power IC or they could be made part of the command itself as a multi-bit field associated with another multi-bit field identifying the command itself.

PRM is also able to send VDD1 and VDD2 sleep commands that can be used, for each voltage, to activate Power IC sleep mode (the voltage regulator switches in sleep mode, where voltage is maintained but only small load is supported). This allows external Power IC reducing its power consumption as well.

OFF mode transition sequences using I2C are described next.

An ON to OFF sleep sequence embodiment has steps wherein PRCM sends OFF command or OFF voltage for VDD1 over the I2C interface to the power IC. Power IC acknowledges the command and starts ramping down the VDD1 voltage. PRCM sends OFF command or OFF voltage for VDD2 over the I2C interface to the power IC. Power IC acknowledges the command and starts ramping down the VDD2 and VPLL voltage. Applications processor chip releases SYS_CLKREQ. The power IC or the clock generator shuts down the system clock SYS_CLK provided it is not requested by another component in the system.

An OFF to ON wakeup sequence embodiment has steps wherein PRCM asserts SYS_CLKREQ. The power IC or clock generator re-starts the SYS_CLK. The clock is clean (no glitch, stable frequency). PRCM waits for a time interval called system clock settling time in master clock mode or Tval in slave clock mode, detects first rising clock edge and sends the ON command or ON voltage for VDD2 over the I2C interface to the power IC. Power IC acknowledges the command and starts VDD2 and VPLL ramp up. PRCM waits for a time interval including VDD2, VPLL settling time. PRCM sends the ON command or ON voltage for VDD1 over the I2C interface to the power IC. Power IC acknowledge the command and start VDD1 ramp up. PRCM waits for a time interval including the VDD1 settling time.

OFF mode transition sequences using SYS_OFF.MODE are an alternative way of operation without using the I2C channel.

In an ON to OFF sleep sequence, the following steps are followed. Applications processor chip 1400 asserts SYS_OFF.MODE and release SYS_CLKREQ. Power IC ramps down the VDD1 voltage. Power IC ramps down the VDD2 and VPLL voltage. The power IC or the clock generator shuts down the system clock SYS_CLK provided no other system component requests it.

In an OFF to ON wakeup sequence, the following steps are followed. PRM asserts SYS_CLKREQ. PRM releases SYS_OFF.MODE after a delay time Tdelay expires. The power IC or clock generator re-starts the system clock SYS_CLK. The clock is clean with no glitch and provides a stable frequency. Power IC ramps up VDD2 and VPLL, and then ramps up voltage VDD1. The PRM waits for VDD2, VPLL and VDD1 settling time. Also, the PRM waits during system clock settling time or configured time value Tval and detects first rising edge.

Turning to the subject of OFF mode, the OFF mode is the device mode where power consumption is minimal. All domains in the device except the Wakeup domain are powered OFF. The VDD1 processors voltage and VDD2 voltage are shut down by the external power IC in order to eliminate always-on components of leakage due to VDD1 and VDD2. Entering OFF mode is preceded by software device context saving.

Application processor chip 1400 integrates an enhanced management of the OFF mode that 1) saves IOs leakage by settings pads in the lowest power state compatible with the device environment, 2) enables wake-up with limited capabilities from almost all programmed input pads all around the device, and 3) enables wake-up with full capabilities by using few GPIO inputs located in wake-up.

PRM manages and sequences the control of various OFF mode contributors, such as IO pads, input/output IO control for chip 1400, Control Module, Wake-up LDO, SRAM LDOs, analog cells, and Voltage Controller VCON.

IO pad OFF mode support sets a dedicated OFF mode configuration for all the pads when the device enters OFF mode. This support is configured in Control Module and activated by the IO control circuit or by a wake-up event from any of the device pads by enabling a IOs wake-up daisy chain.

In FIG. 26 to handle this wake-up capability, the IO pad has controls called ISOCLKIN, ISOIN, WKCLKIN, WKEN, and WKEVT. ISOCLKIN latches a current output signal value coming from the applications processor chip 1400 to the IO. This signal is buffered in the pad then transmitted to the next IO through the ISOCLKOUT signal. Regarding ISOIN, the pad outputs the value latched by ISOCLKIN and isolates the IO from any signal change in the applications processor chip 1400. This ISOIN signal is buffered in the pad then transmitted to the next IO through the ISOOUT signal. WKCLKIN resets the wake-up circuitry and process and latches the current input value. Once the daisy chain is enabled, a change of this value is seen as a wake-up event. This signal is buffered in the pad circuit and then transmitted to the next IO through the WUOUT signal. The WKEN signal enables/disables the pad wake-up event capability. If WKEN is enabled when a wake-up occurs, the signals WKEVT and WUOUT are asserted. When WKLN is disabled, any wake-up event coming from a previous pad circuit in the daisy chain (WUIN asserted) is still transmitted to the next pad circuit (WUOUT asserted). Signal WKEVT is asserted upon wake-up event, provided the IO wake-up capability has been activated, and WKEN is cleared with a WCLKIN pulse.

FIG. 26 shows the PRM communicating with the pads and various modules involved in the OFF mode mechanism and signaling.

In FIG. 26, ISOCLKIN, ISOIN, WCLKIN, ISOCLKOUT, ISOOUT and WUCLKOUT are supplied with the VDD3 and are generated by the PRM. The PRM generates signals ISOCLKIN, ISOIN, WCLKIN to the first pad of the daisy chain, and then the signals are propagated from each TO to the following one. At the end of the chain, the PRM gets back signals ISOCLKOUT, ISOOUT and WUCLKOUT from the last pad circuit. In this way, the PRM is informed that the full daisy chain has been driven. Signals WKIN and WKOUT are supplied by the VDD3 domain. The wake-up chain starts from the first pad circuit and is propagated up to the last pad circuit in the chain. The PRM receives a Device-wakeup signal, issued from the last pad circuit WKOUT output.

For each pad, the Control Module 2765 of FIG. 3 sends a wake-up enable control and gets a wake-up event signal. These two signals are supplied by the VDD2 voltage. In addition, the PRM manages 1) the restoration of the scratch pad memory, by communicating with the OMAP control module (Control_start_restore and Control_restore_done signals), 2) TO pad control for PADs OFF mode activation (PADS_OFF_mode signal) and the IOs wake-up reset (GLOBAL_WKUP_en signal), 3) analog cells power down control, 4) the wake-up LDO control, and 5) SRAMs LDO control. Some pads can wake the device from OFF, independently from the daisy-chain. Examples are D2D.Swakeup (FIG. 4) and some wake-up GPIO pads.

In FIGS. 23, 24A, 26 and TABLE 6, Core power domain Retention mode is a mode wherein logic is switched OFF using a power domain Power Switch of FIG. 23. Context is saved in modules built with retention flip-flops DFF/RFF, and where memory blocks are retained as in TABLE 6. If Peripherals domain is kept ON, its related IOs with wake-up capability are disabled by clearing control_padconf_x and clearing Wakeupenable corresponding bits in the Control Module 2765. In that case, wake-up events are generated functionally by the Peripheral domain instead of daisy chain of FIG. 26. Software sets PM_WKEN_WKUP.EN_IO bit to enable the IO wakeup scheme to assert a GLOBAL_WKUP_EN signal to the application processor chip 1400 IO control 6010. The MPU initiates the sleep sequence. When all conditions are met, all Core power domain clocks are shut down. At this stage, most of the pads are inactive, but some of them may stay active (Peripherals and Display domains). The PRM initializes and resets the IO wake-up detection scheme by generating a pulse on a wakeup clock line WUCLK line. PRM activates all retention flip-flops and asserts Core domain output isolations, but not the IO isolation (ISO line), and switches OFF all non retention logic. PRM enables the device_wakeup input, and that input becomes sensitive to wake-up events issued from the daisy-chain of FIG. 26. PRM switches the Core domain to Retention state and then waits for device_wakeup assertion from the daisy chain. When Core domain is in Retention mode, VDD2 voltage is present (ON or RET), and thereby maintains stable output values from Core domain to the IOs.

When conditions to enter OFF mode are met (all domains are OFF and OFF mode transition is enabled by software configuring a bit field in Control Registers 6710), the following sequence occurs. PRM switches OFF all domains including Core domain. The PRM switches ACTIVE mode pads configuration to OFF mode pad configuration, by asserting PAD_OFF_mode signal to the IO control module. PRM isolates the pads before VDD1 and VDD2 removal by asserting ISOCLK line to latch the current state and asserts the ISO line to isolate the IO. PRM shuts down all analog cell (DPLL, DLL, . . . ) by asserting an AIPOFF signal. PRM shuts down the SRAM LDOs and bandgap by asserting respective signals SRAMALLOFF1 and SRAMALLOFF2. PRM asserts VDD1OFF level shifter control to fix outputs coming from VDD1 to VDD2 before VDD1 removal. PRM sends OFF command for VDD1 to Voltage Controller VCON and releases VMODE1. VDD1 shuts down. Upon I2C transaction acknowledge, PRM asserts VDD2OFF level shifter control. PRM sends OFF command for VDD2 to VCON and releases VMODE2. VDD2 shuts down. Upon I2C transaction acknowledge, PRM ramps down the wake-up LDO to a holding voltage, releases a clock request CLKREQ and disable oscillator signal if any, and PRM then waits for wake-up from daisy chain.

In a transition to ON, once the MPU has booted, software accesses the Control Module to read the wake-up event source by reading CONTROL_PADCONF_X.WakeUpEvent bits corresponding to all enabled pads. The software disables the wakeup daisy chain, by clearing the PM_WKEN_WKUP.EN_IO bit. When cleared, the PRM releases the GLOBAL_WKUP_en signal to the OMAP IO control. This clears all IOs wake-up enable controls, overriding all the signals wkup_en, and the PRM generates a pulse on the wakeup clock WUCLK line, which resets all the IOs wake-up logic.

In FIGS. 23 and 26, a daisy-chain wake-up event Device_Wakeup causes the MPU to restart and boot. Other independent wakeup signals can also be activated in OFF mode, such as the D2D wake-up. These wakeup signals cause the Core domain to be activated. The MPU is also awakened if a wake-up dependency has been set by the user or if the modem generates an interrupt to the MPU. PRM releases domains isolation, restarts MPU and CORE clocks, and releases the reset for the Core domain. When CORE domain exits from reset, PRM starts the Control Module context and IO configuration restore from scratchpad memory by asserting a Control_start_restore signal. Once restore is done and the PRM receives a Control_restore_done acknowledge, PRM releases IO pads isolation by releasing the ISO line, and PRM also releases MPU reset.

In FIGS. 20, 25, 27 and 29, when Core power domain is ON and DPLL3 is in bypass, the reset timer for Core power domain is started. When MPU power domain is ON and DPLL1 is in bypass, the reset timer for MPU power domain is started. When CORE reset time expires the Core domain reset is released. When Core domain exits from reset, PRM starts the Control Module context and IO configuration restore from scratchpad memory, by asserting a Control_start_restore signal. Once done the PRM gets back the Control_restore_done acknowledge, releases the MPU and CORE domains output isolations. PRM releases IO isolation (releases ISO line). PRM switches OFF mode pads configuration to ACTIVE mode pad configuration, by releasing PAD_OFF_mode signal to the IO control module.

The Clock Manager CM is located in the Core power domain. The Core power domain can be powered OFF for DPS (dynamic power switching) purpose. In that case, clock outputs cease and their OFF state is latched by isolation circuits. DPLLs controls are also latched. The full Clock Manager CM setting in Control Registers 6710 is saved by retention flip-flops and is transparently restored when the Core power domain becomes active again.

The functional clock input of the CM (namely CM_xxM.FCLK where xx or xxx is number of MHz) is gated internally in the CM. This is because this clock is now generated in the PRM and therefore signaling from the CM to gate this source clock in the PRM is asynchronous (crossing voltage domain). Gating this clock only in the PRM could result in a clock gated in high state.

In FIGS. 25 and 27, the MPU DPLL and IVA DPLL each receive two inputs clocks: 1) the system clock which is used by the DPLLs to produce their synthesized clock, and 2) a high speed bypass clock, which is a L3 divided clock programmably divided by 1 or 2. The high speed bypass clock is used or can optionally be used when the DPLLs are set in bypass mode either statically, or dynamically during re-lock time. The high speed bypass clock allows saving processors DPLL power consumption when the processors do not need to run faster than at L3 clock speed, or optimizing performance during frequency scaling. As soon as a processor DPLL enters in bypass, high speed bypass clock (and not system clock) is output.

In response to configuration of Control Registers 6710, system clock SYS_CLK is multiplied by M and divided by N+1 to establish a particular clock frequency CLKOUT. M and N are each a multi-bit multiplication factor binary value that is software programmable in the respective Control Registers 6710 fields. In FIG. 27, one or more configurable post-dividers are provided for bypass or combination with the DPLLs. CLKOUT is post-divided by 1 or 2 to establish a given processor clock MPU_CLK and IVA_CLK.

The DPLL provides an output frequency ramping feature when switching from the bypass clock to the synthesized clock during lock and relock period. The frequency ramping is executed in steps up to a maximum of 4 steps in frequency before the signal FREQLOCK is asserted. When FREQLOCK is asserted, the output frequency is stable to final output frequency. A field RAMPTIME[:] in a PRCM register in control registers 6710 specifies the total duration of the ramp, or specifies that frequency ramping is omitted.

Control of DPLLs supports several power modes. Each DPLL power mode establishes a different trade-off between power saving and DPLL re-lock time period. The PRCM hardware also introduces sequencing in the transitions between the DPLL power modes. Each next power mode is configurable.

The transition (if any) to the DPLL stable state after reset is automatically performed by the PRCM hardware. This depends on reset values of some PRCM registers. From the stable state reached after reset the DPLL can move to another power state. This transition can be driven in two ways. First is by software (SW) of FIG. 15. This is done by SW programming of a PRCM register. In FIG. 15, software is programmed so that the transition can be performed based on the activity on the device. A second way is by a combination of SW and HW. This is done by the PRCM HW by collecting HW events to allow the transition whenever the HW conditions are met and the transition has been allowed by a SW programming of a dedicated PRCM register. Reciprocally the PRCM allows the return transition whenever the same HW conditions are not met anymore or different HW conditions are met.

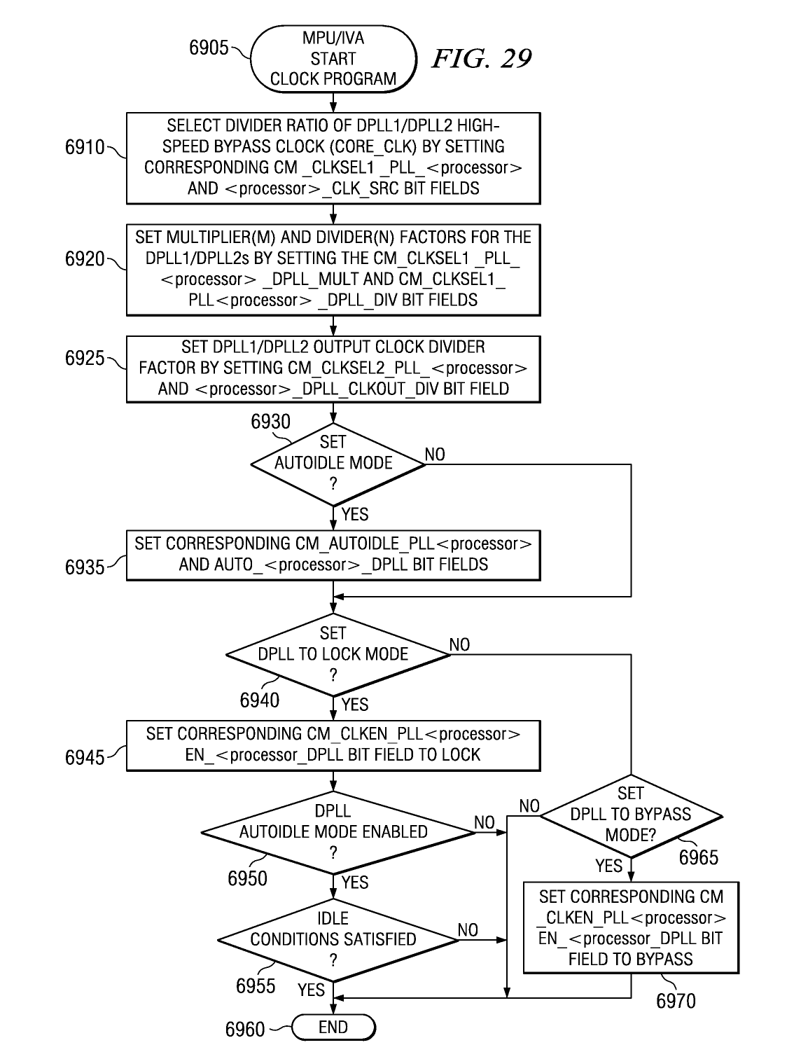

The main DPLLs can be used in different modes, depending on the power domain state, the device state and the latencies requirements. Each mode can be reached upon a software (SW) request and/or in automatic (SW and HW) mode (auto) depending on specific hardware conditions. The automatic mode is enabled or disabled by software by programming the CM_AUTOIDLE_PLL or CM_AUTOIDLE_PLL<processor_name>registers, see FIG. 29 and FIG. 27 Control Registers 6710.

In FIG. 27, Control Registers 6710 are coupled by control lines to control most or all of the illustrated elements of the PRM and CM. Recall from FIG. 25 that PRM is in the Wakeup domain WKUP for controllability on wakeup, and that Clock Manager CM is in the Core domain for power savings when Core domain can be powered down. Together the PRM and CM form a flexible PRCM.

Crystal oscillator 6514 of FIGS. 25 and 27 has a clock output coupled by a controlled switch 6721 to a controlled divider 6722 in FIG. 27. Switch 6721 also couples oscillator clock via a controlled switch 6726 to a USB serial interface block, and via another controlled switch 6728 to one or more Sensor Modules SR. Controlled divider 6722 has an output coupled via a controlled switch 6724 to an input controlled switches 6732, 6742, 6784, and to an input of a clock divider 6750, and via a system clock line SYS.CLK to a first input of a Mux 6758.

Switch 6732 passes system clock to the controllable DPLL3 6730 for the Core domain. DPLL3 provides a clock output to the Clock Manager CM. Switch 6742 is an example of replicated circuitry that provides system clock to a DPLL such as DPLL4 or DPLL5. The respective DPLL4 or DPLL5 provides DPLL clock to a controlled switch 6744 that in turn supplies each of controlled switches 6746 and 6748. Switch 6746 supplies a mux for clock a Peripheral domain such as P1 or P2. Switch 6748 provides clock to Clock Manager CM. System clock from switch 6724 is also coupled by switch 6784 by a CM System Clock line CMSYS.CLK to the CM. Divided system clock from divider 6750 is fed via a controlled switch 6752 to a Mux 6754, that in turn provides an output Module.FCLK. The circuitry of one, some or all of divider 6750, switch 6752, and/or Mux 6754 is suitably replicated as appropriate to controllably deliver module functional clocks to many respective power modules.

In FIG. 27, the 32 KHz oscillator 6518 of FIG. 25 is coupled via a controlled switch 6756 to a line CM32K.CLK to the Clock Manager CM. An unswitched line FUNC32K.CLK couples the 32 KHz oscillator 6518 to the second input of the Mux 6758. A selector control of Mux 6758 is also coupled to Control Registers 6710. The Mux 6758 has an output that feeds a selected one of either system clock SYS.CLK or the just-mentioned FUNC32K.CLK to a controlled switch 6759 and on to the Wakeup domain WKUP. An external Wakeup signal such as IO Pad Device_wakeup line from FIG. 26 is coupled to control the controlled switch 6759. Using Mux 6758, the Wakeup domain WKUP is selectively either in a sleep mode on FUNC32K.CLK or more fully active on system clock SYS.CLK. If Switch 6759 is opened, the WKUP domain is not clocked and is in an Off condition. Closing switch 6759 in response to the external Wakeup signal moves the WKUP domain to a clocked mode that depends on the selection by Mux 6758.

In FIG. 27, the description turns to the Clock Manager CM, enclosed by dashed line in the illustration. Core DPLL3 6730 feeds a set of independently controlled clock dividers 6760.1, 6760.2, 6760.3, 6760.4 in the Clock Manager CM. Clock divider 6760.1 is coupled via controlled switch 6762.1 to MPU DPLL1. Clock divider 6760.2 is coupled via controlled switch 6762.2 to IVA DPLL2. Clock divider 6760.3 is coupled via controlled switch 6762.3 to a Security accelerators block. Clock divider 6760.4 is coupled via controlled switch 6762.4 to a Display block. See depictions of various blocks in FIGS. 2, 3, 6, 18 and 25 for various clocked blocks. This circuitry is also suitably replicated or reduced for additional or fewer such clocked blocks. Notice that Core DPLL3 is in series farther up the clock chain, which facilitates an interlock or clock dependency guarantee wherein Core DPLL3 is previously activated before the downstream clocked blocks are provided with clock.

Further in Clock Manager CM of FIG. 27, a controlled divider 6770 has its input coupled by a controlled switch 6772 back to controlled switch 6748 of the PRM. Divider 6770 has an output coupled to a first input of a Mux 6774. A second input of the Mux 6774 is coupled to an external clock EXT.CLK in case a module fed Mux 6774 should be externally or internally clocked. For example, if an internal module needs to be clock-slaved to an external module, then external clocking of the internal module may be appropriate. Mux 6774 has an ouput coupled a controlled divider 6776 that in turn is coupled via a controlled switch 6778 to a clocked module such as the HDQ interface useful for battery monitoring for instance. Mux 6774 has its output also coupled via a controlled switch 6779 to suitable clocked circuitry such as a UART.

Clock Manager CM of FIG. 27 further has a Mux 6780 with a first input coupled via a controlled switch 6782 to line CMSYS.CLK to controlled switch 6784 in the PRM. Mux 6780 has a second input coupled via a controlled switch 6788 to line CM32K.CLK from controlled switch 6756 in the PRM. Mux 6780 has its output coupled to a Peripheral domain PER such as P1 or P2.

As shown in FIG. 27, the Control Registers 6710 are coupled to most or all of the controlled switches, controlled dividers, Mux selector inputs, and controlled DPLLs in order to provide configurable and flexible control of clocking of various power domains and to accommodate dependencies of various modules in a system. Switching provides a clock off or clock on mode. The type of clock selected, such as crystal oscillator clock, 32 KHz clock and/or external clock EXT.CLK provides flexibility of clocking for the system. DPLLs provide clock multiplication by a factor M, and clock divider(s) provide clock division by a factor N for each particular module so connected. In this way, OPP frequencies F in FIGS. 11 and 12 are flexibly controlled over a range of discrete selectable clock frequencies.

In a process of FIG. 28A for use with circuitry of FIG. 27, operations for disabling a power module functional clock FCLK commence at flow point 6805 at which the module FCLK is running and applied to the module. Operations proceed to a decision step 6810 to determine what kind of idle mode is established by control register 6710 for the power module. Software is responsible to ensure coherence between the module idle state, clock activity bit test, and clock gating request. If no-idle, then operations loop back to point 6805. If Smart Idle, then a branch goes to a decision step 6815 to determine whether the module FCLK can be gated.

To make its determination, step 6815 tests a bit field in control registers 6710 pertaining to functional clock activity for the particular module. If not gateable, then idling is not permitted and operations loop back to point 6805. If gateable at step 6815 or Forced Idle mode at step 6810, then operations go to a step 6820. Step 6820 clears a Control Register 6710 bit for the domain FCLK enable corresponding to the particular power module to suitably control clock manager CM in FIG. 27.

In FIG. 28A, operations proceed from step 6820 to a decision step 6825 that does a hardware test to determine whether it is true that all modules of the clock domain are idle and further that there is no wakeup event. If Yes, the module functional clock FCLK is gated to prevent clocking the module and an End flow point 6830 is reached.

In FIG. 28B, operations for enabling module FCLK commence at a flow point 6835 at which the module power domain is on with voltage and the module FCLK is gated such that the module is not clocked currently. Operations proceed to a decision step 6840 to determine whether to use internal source clock based on the contents of control register 6710. If No at step 6840, then operations go to a decision step 6845 to determine whether the request is to use a peripheral clock source such as DPLL4 or DPLL5. If Yes, then operations go to a step 6850 and select the peripheral DPLL clock as the selectable source functional clock. Next a step 6855 sets the output clock divider for the appropriate FCLK clock rate. Then a step 6860 configures multiplication M and division N values of the peripheral DPLL depending on the desired clock frequency for the functional clocks to be delivered. From step 6860 a decision step 6865 is reached. If no peripheral DPLL is involved at step 6845, then operations branch directly from step 6845 to step 6865. At step 6840, if no internal source clock will be used, then operations branch from step 6840 to a step 6867 to select an external source clock sys_altclk for clock line EXT.CLK of FIG. 27 and use it for the selectable source FCLK, whence decision step 6865 is reached.

Further in FIG. 28B, the decision step 6865 determines whether the source clock is selectable. If Yes, then operations go to a step 6870 to select the source clock represented by a bit field in Control Register 6710 pertaining to the particular clock domain, whereupon a step 6875 is reached. If No at step 6865, the clock is not selectable and operations proceed directly to step 6875. Step 6875 sets a bit in the Control Register 6710 to enable or activate FCLK for the particular clock domain. Control Register 6710 feeds the active signal to the PRM and/or Clock Manager CM circuitry of FIG. 27 to set the module function clock FCLK running, whence End flow point 6880 is reached.

In FIG. 29, operations to start programming MPU/IVA clock commence at Start 6905. Operations proceed to a step 6910 that selects the divider ratios for dividers 6760.1 and 6760.2 in FIG. 27. These dividers 6760.1 and 6760.2 respectively divide the Core clock high-speed bypass clock from DPLL3 6730 and supply respective clocks to MPU DPLL1 and IVA DPLL2. The divider ratios are set by step 6910 in respective bit fields of Control Registers 6710 that control the Clock Manager CM.

In FIG. 29, a succeeding step 6920 sets multiplier M and divider N factors for the DPLL1 and DPLL2 by setting further respective bit fields in Control Registers 6710. A further step 6925 sets an output clock divider factor for each of DPLL1 and DPLL2 by setting respective further bit fields of Control Registers 6710. Next, a decision step 6930 determines whether a control bit that calls for setting an AutoIdle mode is active. If Yes, then operations go to a step 6935 to set processor-specific bit fields for AutoIdle and for Auto control of the DPLL1 and DPLL2 respectively, whereupon a decision step 6940 is reached. If step 6930 calls for AutoIdle to not be set, then operations branch directly from step 6930 to step 6940.

Decision step 6940 determines whether a Control Register is configured so that the DPLL is to be set to Lock mode. If Yes, then operations go to a step 6945 to set a corresponding processor-specific bit field to enable the clock in the Clock Manager CM and to enable a processor-specific bit field to enable Lock on that DPLL. Then operations proceed to a decision step 6950 that determines whether the AutoIdle mode is enabled for the particular DPLL. If Yes at step 6950, then a decision step 6955 determines by hardware test whether Idle conditions are satisfied. If Yes at step 6955, then the applicable DPLL is put in a low-power STOP mode and clock is gated to that clock domain, whence an End flow point 6960 is reached. If No at either step 6950 or No at step 6955 then the applicable DPLL is put in Lock Mode in FIG. 27 and clock is running, whence the End flow point 6960 is reached.

In FIG. 29, if decision step 6940 determines that no Lock mode is called for by Control Register, then operations go to a decision step 6965 to determine whether Control Register calls for the applicable DPLL to be set to a low-power Bypass mode. If Yes at step 6965, then operations go to a step 6970 to set a corresponding processor-specific bit field to enable the clock in the Clock Manager CM and to enable a processor-specific bit field to enable Bypass on that DPLL, whereupon End flow point 6960 is reached and DPLL is in Bypass mode and bypass clock is running. If no at step 6965, then operations put the DPLL in low-power STOP mode and clock to the clock domain is gated, whence End 6960 is reached.

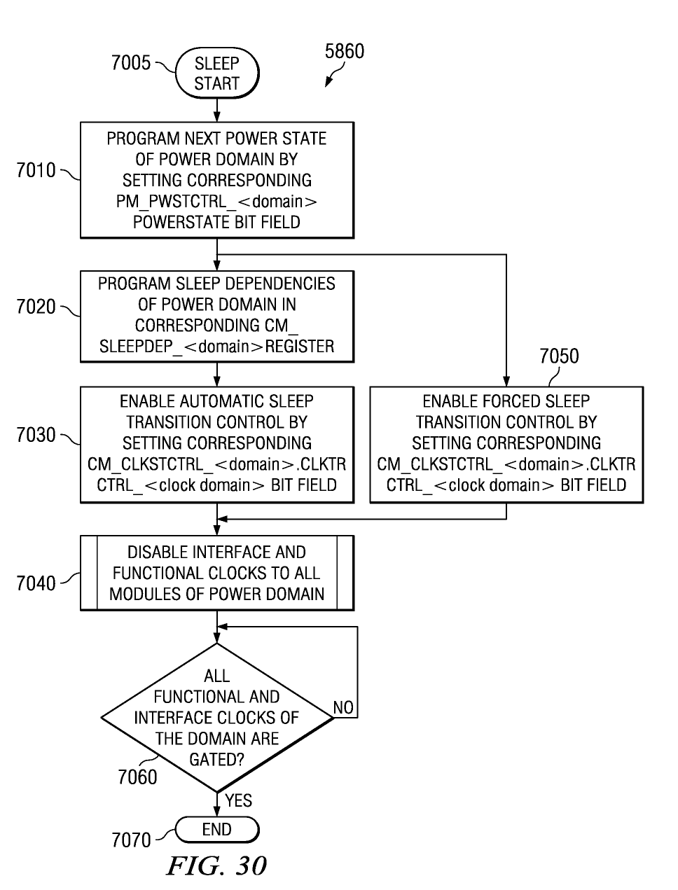

In FIG. 30, operations to start a SLEEP mode commence at a Start flow point 7005 with an applicable power domain in an ON power state. Next, a step 7010 programs the next power state of the power domain by setting a PM Power State bit field in the Control Registers 6710 wherein the bit field corresponds to the particular power domain. Also step 7010 determines whether a Forced Sleep transition or Automatic Sleep transition is called for in the Control Registers 6710.

If Automatic Sleep transition, then operations proceed to a step 7020 that programs sleep dependencies of the power domain in a SleepDep bit field to control the Clock Manager CM in the Control Registers 6710 wherein the bit field corresponds to the particular power domain. A further step 7030 enables automatic sleep transition control by setting a particular value representative of automatic sleep control in a CM Clock State Control bit field in the Control Registers 6710 wherein that bit field corresponds to the particular power domain, whereupon a step 7040 is reached.

If Forced Sleep transition at step 7010, then operations go instead to a step 7050 to enable Forced Sleep transition control by setting a particular value representative of Forced Sleep control in a CM Clock State Control bit field in the Control Registers 6710 wherein that bit field corresponds to the particular power domain, whereupon the step 7040 is reached.

In FIG. 30, the step 7040 then disables interface and functional clocks FCLK to all modules of the power domain. Then a decision step 7060 determines whether all functional and interface clocks of the domain are gated. If not, then some of the clock gates are conductive and sleep transition operations are deferred until all such clocks are gated. When all such clocks are gated, then the power domain is in a Retention or OFF power state, whence an End flow point 7070 is reached.

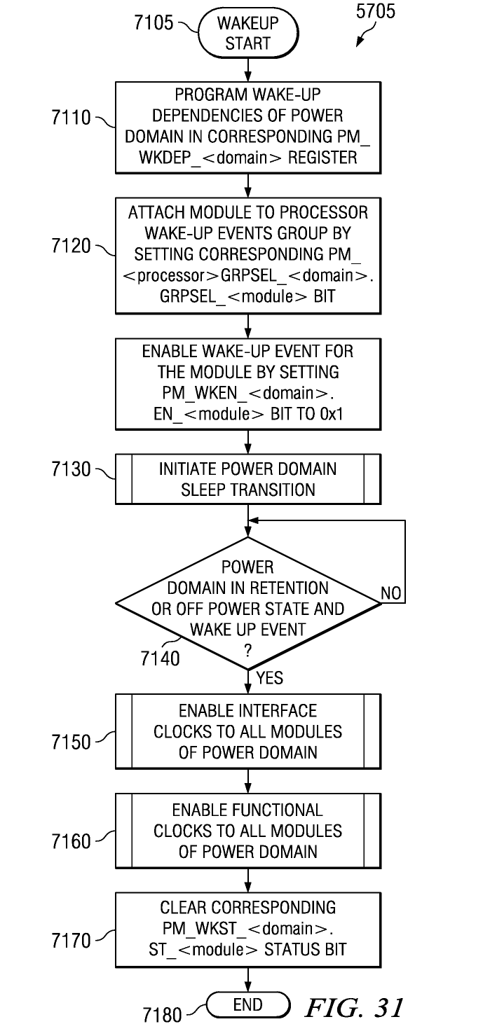

In FIG. 31, operations to start a WAKE UP mode commence at a Start flow point 7105 with an applicable power domain in an OFF power state. Next, a step 7110 programs wakeup dependencies of the power domain in a WkDep bit field to control the PRM in the Control Registers 6710 wherein the bit field corresponds to the particular power domain. Another step 7120 attaches the module to a processor wakeup events groups by setting a corresponding processor-specific and module-specific GrpSel bit in the Control Registers 6710. A further step 7125 enables a wakeup event for the module by setting a domain specific and module-specific wakeup enable WkEn bit in the Control Registers 6710. Then a step 7130 initates a power domain Sleep transition.

Next a decision step 7140 determines whether it is true that the power domain is in a Retention or OFF power state, and also true that a Wakeup event has occurred. If No, then wakeup operations are deferred. If Yes at step 7140, then operations proceed to a step 7150 to enable interface clocks to all modules of the power domain, and then to a step 7160 to enable functional clocks FCLK to all modules of the power domain. Then a step 7170 clears a wake state WkSt domain-specific and module-specific status bit in the Control Registers 6710. Now the power domain is in an ON power state and an End flow point 7180 is reached.

Power Management Combined with Security

In some embodiments, Power management features are coordinated with security features as described herein.

MCU domain DPS between OFF and ON state involves context save operations of the MCU before sleep transition to OFF state and reciprocal context restore operations on a wakeup transition from OFF to ON state. In order to maximize the DPS efficiency, the save/restore operation latency is kept low.

In FIG. 8B, both power management efficiency and security are enhanced by performing security context save on each exit from secure mode so that it does not need to be done on sleep transitions. In this way, power management transition is kept independent from security operations for high security, and security operations are removed from sleep transitions to reduce the save/restore latency. Security context restore is performed at next entry in secure mode so that the security context restore is separate from wakeup transition latency.

Security and Core domain DPS between OFF and ON state of L3 and L4 interconnect are discussed. In some embodiments, security firewalls are reset so that configuration registers return to their initial reset values on wakeup transition from OFF state. Accordingly, the security firewall reset values are exported to the control module register pertaining to security and made configurable by software. Background information on security firewalls and control module is provided in incorporated patent application TI-61985 which is hereby incorporated herein by reference.

In FIG. 3 and 14A-14C, security is maintained by isolating reset values of interconnect security firewalls from access control that controls access to refresh controller in SDRAM Memory Controller SDRC from the display controller, access to refresh controller of SDRC from the DMA, and access to the audio/modem peripheral interface from the DMA. Also, in the case of a non-secure (GP) device embodiment that boots from Flash memory, security is maintained by isolating reset values of interconnect security firewalls from access control that controls access to the GPMC from the MCU. SDRC access is handled in the SDRAM Memory Scheduler SMS block with retention flipflops and therefore retains the SMS security firewall settings. These SMS security firewall settings are made compliant as described to allow SDRC access from Display and DMA.

Some secure embodiments define secure region(s) in the SDRAM space using export values under on-chip control. The default region stays public.

In FIGS. 3 and 14A-14C, Core domain memory ON/OFF state control is made secure. As shown in Table 13 the Core domain SRAM memory bank is individually controlled and switched ON and OFF. These controls are performed by public software in the PRM. In case the SRAM memory is configured as a secure memory in the L3 firewalls, there is a conflict between SRAM public/secure configuration which is secure and the ON/OFF control of the SRAM is public. To maintain security, the security hardware is structured to directly monitor the on/off control of any memory that is at the output of the PRM in order to create secure status of the secure memory state. This status is then used to ensure integrity of the secure memory. A beneficial side effect is that the secure code can use the on/off control of the memory in the PRM in order to perform a fast purge of all the memory secure content.

In OFF mode, VDD2 is powered down and the contents of the retention flipflops is lost. Therefore, any security control and status registers in any affected modules are lost and return to their reset values on wakeup. Secure ROM code restores critical security configuration to the configuration established upon initial boot. Security operations are minimized upon wakeup from OFF mode in order to keep OFF mode wakeup latency low.

A clock control register in the Clock Manager CM can enable, disable, or otherwise affect clock control of secure peripherals. Accordingly, Clock control of secure peripherals is structured secure even assuming that the clock control register inside the Clock Manager CM may be non-secure. This accomplished by establishing Smart Idle mode for security peripherals.

In FIG. 28A, Smart Idle mode operates so that if a secure peripheral is enabled and there is an ongoing secure operation, the module must not respond IdleAck (upon IdleReq assertion) until the secure operation is completed and the results were retrieved. In this way, the security peripheral clock is not shut down prematurely by the Clock Manager CM and a power state transition is prevented on the security peripheral domain(s). Secure software processes also set the secure module in a No Idle mode so that Idle Acknowledge signal IdleAck is never returned to the Clock Manager CM at any time the secure module is in use.

In a further security measure, the security peripherals have their own interface clock independent from, and not shared with, the interface clock used by non secure modules. In this way, power management Clock Manager CM can shut down the interface clock to non-secure peripherals even when a security peripheral keeps its interface clock on by not returning IdleAck.

Power management provides power support by DVFS applied to split voltage domains between a processor and a SOC (system on a chip) backplane. DVFS is combined with DPS support and higher power domain granularity AVS support is provided. DPS can run applications to stopping points and shut down the MPU(s) by using a sufficiently larger audio buffer and sufficiently larger Display FIFOs from which those peripherals can feed during each MPU shut down interval of DPS. Logic retention support is provided. OFF mode saves power with supply shut down.

In some embodiments, the processor executes a performance prediction process that delivers a performance prediction of number of applications and performance required. A non-volatile memory has stored information that describes the performance requirements of each of a plurality of software applications. The processor is operable to execute a performance prediction process utilizing the information stored in the non-volatile memory. The performance prediction process, for example, delivers a prediction of target frequency related to instructions per second of performance and delivers a prediction that is responsive to and increases with a current number of applications running under the operating system plus a number of applications being launched by the operating system. The prediction is also based on and decreases in a manner roughly inversely to the number of pipeline stages in each processor and the number of processor cores in the processor section, with estimated stalls and pipeline loading taken into account.

In some DVFS embodiments, the supply voltage and operating frequency are scaled to one of the available pairs of DVFS nominal voltage selections Vn and frequencies Fn that is just sufficient to accommodate a current operational mode and desired predicted performance. In some system embodiments with plural DVFS-controlled voltage or power domains, each such voltage or power domain is suitably operated at a respective one of plural selectable operating performance points (OPPs) established in response to respective target frequencies determined for and/or allocated to the corresponding domains. DPS in some embodiments is activated when the target frequency for a given domain is sufficiently lower than the OPP frequency to justify using DPS to save further power. DPS then runs the respective domain at the OPP determined by DVFS for that domain and then puts the respective domain into a very low power or no-power mode to save on leakage power dissipation. Some DPS embodiments herein also sequence various power domains through power on and power off according to predetermined sequences.

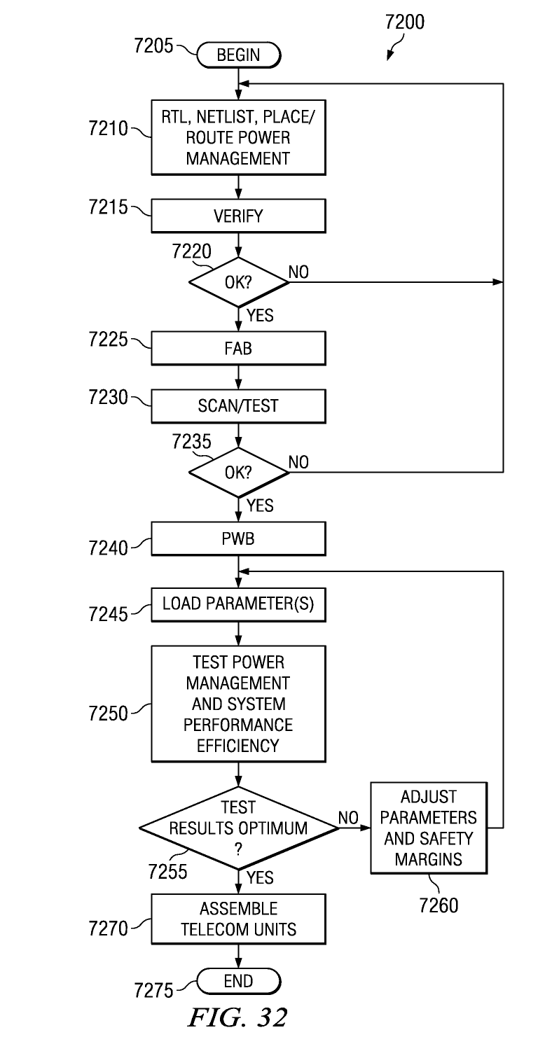

In FIG. 32, various embodiments of an integrated circuit improved as described herein are manufactured according to a suitable process of manufacturing process 7200 as illustrated in the flow of FIG. 32. The process begins at step 7205. A step 7210 prepares RTL (register transfer language) and netlist for a particular design of one or more integrated circuits or a system as shown in one or more of the Figures of drawing herein as some examples and alternatives, and/or as described in the detailed description herein.

In a step 7215, the design of configurable power management circuitry for voltage and clock control by combined DVFS/DPS/SLM/AVS, for instance, is verified in simulation electronically on the RTL and netlist. In this way, the contents and timing of the registers, operation of the circuits in response to various configurations and uses of the registers, are verified. Compliance with power module dependencies, and response to conditions for invoking DVFS, DPS, SLM, AVS and combinations thereof are verified. The operations are verified pertaining to real-time and non-real-time operations and interrupts, and transitions through handlers, Monitor Mode, Secure Privilege modes, User mode, Debug modes, power management wakeup, and various attack scenarios. Then a verification evaluation step 7220 determines whether the verification results are currently satisfactory. If not, operations loop back to step 7210.

If verification evaluation 7220 is satisfactory, the verified design is provided in a manufacturing-ready form on a design information media, such as a design dataset, pattern generation dataset or the like, and fabricated in a wafer fab and packaged to produce a resulting integrated circuit at step 7225 according to the verified design. Then a step 7230 verifies the operations directly on first-silicon and production samples by using scan chain methodology on power management circuitry and other circuitry of the actual chip. An evaluation decision step 7235 determines whether the chips are satisfactory, and if not satisfactory, the operations loop back as early in the process such as step 7210 as needed to get satisfactory integrated circuits.

Given satisfactory integrated circuits in step 7235, a system unit is manufactured, such as any one, some or all of those system units shown together in FIG. 1 or otherwise based on teachings herein. The process prepares in a step 7240 a particular design and printed wiring board (PWB) of the system unit. For instance, the system unit, for example, can have a modem, a processor coupled to the modem, a configurable control register, a controlled power management circuitry , peripherals coupled to the processor, and a user interface coupled to the processor. Storage, such as SDRAM and Flash memory and on-chip secure memory, is coupled to the system and is provided with real-time operating system RTOS, Public HLOS, protected applications (PPAs and PAs), and other supervisory software.

The particular design of the configurable adjustable shared-memory embodiment is tested in a step 7250 by electronic simulation and prototyped and tested in actual application. Operations of the power management circuits by selectively activating fields of a configurable control register, for instance, are verified to confirm operations of the integrated circuit(s) and system and to perform verification and test operations that include and/or go beyond the verification operations described at step 7215 earlier in the process. The verification and test operations pertaining to real-time and non-real-time operations, power management, various real-time scenarios as are specified for the system. Further testing evaluates and confirms system stability and perforamnce, power management performance and efficiency and satisfactory operation of mobile video display, phone, e-mails/data service, web browsing, voice over packet, content player, camera/imaging, video, microcontroller, and other such operation that is apparent to the human user and can be evaluated by system use. Also, various attack scenarios are applied in the test operations, such as by using real viruses, DoS attacks and other attacks.

Parameters of the power management circuitry, software and system are adjusted for in faster application execution, lower power dissipation, QoS (quality of service) for each communications service processed, and other pertinent metrics. Examples of parameters include enable/disable register bits in Control Registers 6710 of FIG. 27 and comparison thresholds for DPS margin in FIG. 17. If further increased efficiency is called for in step 7255, then adjustment or reconfiguration of the parameter(s) and safety margins is performed in a step 7260, and operations loop back to reload the parameter(s) at step 7245 and do further testing. When the testing is satisfactory at step 7255, operations proceed to step 7270.

In manufacturing step 7270, the adjusted parameter(s) are loaded into the Flash memory or otherwise established in the integrated circuit(s) of the system. The components are assembled on a printed wiring board or otherwise as the form factor of the design is arranged to produce resulting system units according to the tested and adjusted design, whereupon operations are completed at END 7275.

Various embodiments are used with one or more microprocessors, each microprocessor having a pipeline is selected from the group consisting of 1) reduced instruction set computing (RISC), 2) digital signal processing (DSP), 3) complex instruction set computing (CISC), 4) superscalar, 5) skewed pipelines, 6) in-order, 7) out-of-order, 8) very long instruction word (VLIW), 9) single instruction multiple data (SIMD), 10) multiple instruction multiple data (MIMD), 11) multiple-core using any one or more of the foregoing, and 12) microcontroller pipelines, control peripherals, and other micro-control blocks using any one or more of the foregoing.

Various embodiments are implemented in any integrated circuit manufacturing process such as different types of CMOS (complementary metal oxide semiconductor), SOI (silicon on insulator), SiGe (silicon germanium), organic transistors, and with various types of transistors such as single-gate and multiple-gate (MUGFET) field effect transistors, and with single-electron transistors and other structures. Photonic integrated circuit blocks, components, and interconnects are also suitably applied in various embodiments.

### Aspects

(See Notes paragraph at end of this Aspects section.)

1A. The electronic circuit claimed in claim 1 wherein the dynamic power switching initiates an information save from the power managed circuit prior to entering the lower static power condition and an information restore upon leaving the lower static power condition.

1B. The electronic circuit claimed in claim 1A wherein the condition that activates dynamic power switching includes a threshold related to a first energy saving as a function of the static power dissipation and lower static power state, less a second energy involved in performing the information save and information restore.

1C. The electronic circuit claimed in claim 1 wherein said power managed circuit at a given operating performance point has an operating frequency and a target frequency, and the condition for activation of dynamic power switching includes a difference of the operating frequency less the target frequency exceeding a threshold.

1D. The electronic circuit claimed in claim 1 wherein said power managed circuit at the first operating performance point has its operating frequency and a target frequency, and said power management control circuit is operable to select the second operating performance point when the target frequency is higher than the operating frequency at the first operating performance point.

1E. The electronic circuit claimed in claim 1 wherein said power managed circuit at the first operating performance point has a first operating frequency and at the second higher operating performance point has a second higher operating frequency and a target frequency, and said power management control circuit is operable to select the first operating performance point when the target frequency is lower than the first operating frequency.

1F. The electronic circuit claimed in claim 1E wherein said power management control circuit is operable according to the condition for dynamic power switching to activate dynamic power switching when the target frequency is between the first operating frequency and the second higher operating frequency, and the condition for activation of dynamic power switching includes a difference of the second higher operating frequency less the target frequency exceeding a threshold.

3A. The device claimed in claim 3 wherein said processor is operable, when the target frequency is within the current range, to determine whether the target frequency is far enough below a higher-end frequency of the current range that starting up a dynamic power switching (DPS) mode by said power management circuit is justified.

3B. The device claimed in claim 3A wherein said processor is operable to determine whether a difference found by subtracting the target frequency from the range higher-end frequency exceeds a threshold for DPS margin, the DPS margin related to an energy savings from turning off leakage and the energy savings being offset by an energy consumption due to a context save/restore.

3C. The device claimed in claim 3A wherein said processor is operable, when justified to activate said DPS mode, to set a DPS enable bit active in said power management circuit to activate the DPS mode.

3D. The device claimed in claim 3A wherein said processor is operable, when not justified to start or maintain the DPS mode, to make a DPS enable bit inactive in said power management circuit to inactivate the DPS mode.

3E. The device claimed in claim 3A wherein said processor is operable according to a looping process to obtain a new target frequency.

3F. The device claimed in claim 3 wherein said processor is operable to determine whether the target frequency is less than a lower-end frequency of the current range, and if so, then to activate a transition in said power management circuit to decrement the operating voltage and decrement the operating frequency.

3G. The device claimed in claim 3 wherein said processor is operable to determine whether the target frequency exceeds a higher-end frequency of the current range, and if so, then to activate a transition in said power management circuit to raise the operating voltage and raise the operating frequency.

3H. The device claimed in claim 3 wherein when the target frequency is higher than a predetermined maximum frequency said processor maintains a current operating point when the operating point is at the maximum frequency.

3J. The device claimed in claim 3 wherein when the target frequency is lower than a predetermined minimum frequency said processor maintains a current operating point when the operating point is at the minimum frequency.

3K. The device claimed in claim 3 wherein said power management circuit is operable to establish a standby leakage management mode for said processor.

3L. The device claimed in claim 3 wherein said power management circuit is operable to initially establish a predetermined maximum operating voltage and operating frequency for said processor, whereby to establish an initial operating point.

5A. The electronic circuit claimed in claim 5 wherein said power management control circuit is responsive to at least one bit of said power management register circuit as an enabling condition for said power management control circuit to perform the dynamic power switching of said processor.

5B. The electronic circuit claimed in claim 5 wherein said processor is operable to activate said at least one bit of said power management register circuit as an enabling condition for said power management control circuit to perform dynamic power switching of said processor.

5C. The electronic circuit claimed in claim 5 wherein said processor is operable to configure a bit field of said power management register circuit with a target frequency and said power management control circuit is operable to compare said target frequency to a reference frequency to conditionally enable dynamic power switching of said processor.

5D. The electronic circuit claimed in claim 5 further comprising a second functional circuit and said power management control circuit is operable to power up and power down said processor and to power up and power down said first functional circuit independently.

5E. The electronic circuit claimed in claim 5 wherein said power management control circuit is operable to generate a voltage command representing a scaled voltage for said processor.

5F. The electronic circuit claimed in claim 5 wherein said power management control circuit includes a clock manager circuit operable to establish a frequency for said processor from among a plurality of possible frequencies.

5G. The electronic circuit claimed in claim 5 wherein electronic circuit is divided into power domains and said power management control circuit includes a first state machine operable to sequentially provide commands and at least a second state machine coupled to control at least one of said power domains and operable in response to at least one of the commands from said first state machine.

5H. The electronic circuit claimed in claim 5G wherein said power domains include a power domain having a power switch, a retention flipflop, an isolation buffer, and a portion of said functional circuit included in the power domain and coupled to said power switch, said retention flipflop, and said isolation buffer.

5J. The electronic circuit claimed in claim 5H wherein said second state machine is coupled to sequentially operate said power switch, said retention flipflop, and said isolation buffer in forward and reverse order.

5K. The electronic circuit claimed in claim 5 further comprising at least one pad and wherein the electronic circuit is divided into power domains and one of said power domains includes said power management control circuit and has a mode wherein the said power domain including said power management control circuit is solely powered when others of said power domains in the electronic circuit are unpowered, and said power domain including said power management control circuit is responsive to an external wakeup signal via said at least one pad to initiate power to at least one other of said power domains.

5L. The electronic circuit claimed in claim 5 further comprising an interrupt controller coupled to said processor, said power management control circuit having at least one power management interrupt output line to said interrupt controller.

5M. The electronic circuit claimed in claim 5 wherein said power management control circuit is operable to transition from a first pair of voltage and frequency to a second pair of voltage and frequency applied to said processor, and to start and stop dynamic power switching in response to a condition.

5N. The electronic circuit claimed in claim 5 wherein said processor has software operable to configure said power management register circuit with information representing a changed pair of voltage and frequency.

5P. The electronic circuit claimed in claim 5 wherein said power management control circuit is operable to control a first scaled selectable voltage and a first selectable frequency for said processor and to control a second scaled selectable voltage and a second selectable frequency for said functional circuit separately.

5Q. The electronic circuit claimed in claim 5 further comprising a power domain including a coupling circuit coupling said processor and said functional circuit wherein said power management control circuit is operable to activate a first clock for said coupling circuit and a second clock for said processor and said first clock and said second clock have an interlocked dependency of said second clock upon said first clock.

5R. The electronic circuit claimed in claim 5 wherein said functional circuit includes a data transfer peripheral and said power management control circuit includes a peripheral clock circuit and an external clock line and a selective coupling between said data transfer peripheral selectively to said peripheral clock circuit and said external clock line, whereby said data transfer peripheral is loadable when coupled to said peripheral clock circuit and operable in response to the external clock line to transfer data externally.

7A. The electronic circuit claimed in claim 7 wherein said peripheral includes an audio peripheral.

7B. The electronic circuit claimed in claim 7 wherein said peripheral includes a display peripheral.

7C. The electronic circuit claimed in claim 7 further comprising a direct memory access (DMA) coupled to said memory and to said buffer, whereby the portions of resulting information are successively transferred.

7D. The electronic circuit claimed in claim 7 wherein the controlled sequence further includes an interval wherein the peripheral and buffer and power management control circuit are fully powered and other parts of the electronic circuit are in a low power state.

7E. The electronic circuit claimed in claim 7 wherein said power management control circuit includes a state machine for establishing the controlled sequence.

9A. The electronic circuit claimed in claim 9 further comprising a control module and a security firewall coupled to said processor and wherein said processor is operable to export at least one security firewall reset value to said control module.

9B. The electronic circuit claimed in claim 9A further comprising an interconnect security firewall coupled to said processor and wherein said processor has an access control that controls access to a peripheral, and security is maintained by isolating at least one reset value of said interconnect security firewall from access control that controls access to at least one peripheral.

9C. The electronic circuit claimed in claim 9B further comprising a direct memory access block and access control to said at least one peripheral interface from said direct memory access block, and security is maintained by isolating at least one reset value of said interconnect security firewall from access control that controls access to said at least one peripheral interface from said direct memory access block.

9D. The electronic circuit claimed in claim 9A further comprising a display controller and a memory controller and an access control that controls access to said memory controller from said display controller, and an interconnect security firewall coupled to said processor, and security is maintained by isolating at least one reset value of said interconnect security firewall from the access control that controls access to said memory controller from said display controller.

9E. The electronic circuit claimed in claim 9A further comprising an interconnect security firewall coupled to said processor and a memory that is configurable as secure in said interconnect security firewall and said memory is power controlled by said power management circuit, and wherein said power management circuit is publicly configurable, and security is maintained by a security circuit operable to directly monitor power control of said memory coupled to said power management circuit thereby to provide security for said memory when configured as secure.

9F. The electronic circuit claimed in claim 9E wherein said processor has secure code operable to use the on/off control of the memory in said power management circuit to perform a fast purge of all the memory secure content.

11A. The electronic circuit claimed in claim 11 wherein said DVFS circuit is operable to select the voltage from a number of voltage levels and that number lies in a range between two (2) and eight (8) inclusive.

11B. The electronic circuit claimed in claim 11 wherein said DVFS circuit is operable to transition between voltage-frequency pairs of the voltage and clock frequency depending on operating conditions of said power-managed processing circuit.

11C. The electronic circuit claimed in claim 11 wherein said DPS circuit is further operable to restore processing power and initiate a context restore by said power-managed processing circuit.

15A. The electronic camera system claimed in claim 15 further comprising a direct memory access (DMA) having DMA channels and having a smart standby mode wherein said DMA is operable to assert a standby signal when all the DMA channels are disabled and said power management control circuit is responsive to said standby signal to shut down said interconnect clock and to restart said interconnect clock when a said DMA channel is enabled thereafter.

15B. The electronic camera system claimed in claim 15A wherein said DMA has retention flipflops and a DMA memory with retention.

15C. The electronic camera system claimed in claim 15 further comprising a camera interface functional clock having a camera interface functional clock frequency and additionally comprising a display functional clock having a display functional clock frequency, and wherein said power management control circuit is operable to select between at least a first operating performance point and a second higher operating performance point for said camera interface, each performance point including a respective pair of nominal voltage and frequency, said selection compatible with said camera interface functional clock frequency and said display functional clock frequency as related to camera resolution and display resolution.

15D. The electronic camera system claimed in claim 15 further comprising an interrupt controller coupled to said digital signal processor wherein said camera interface has a sleep state and a wakeup state, and wherein said power management control circuit is operable to couple an interrupt to said interrupt controller upon completion of a transition between sleep and wake-up in said camera interface.

15E. The electronic camera system claimed in claim 15 wherein said digital signal processor is operable for image transcoding.

15F. The electronic camera system claimed in claim 15 further comprising a wireless video modem coupled to said digital signal processor.

17A. The mobile video electronic system claimed in claim 17 for use with an automotive vehicle having windows wherein said video display includes a transparent organic semiconductor display provided on at least one of said windows.

17B. The mobile video electronic system claimed in claim 17 wherein said video display includes a digital light processor display.

17C. The mobile video electronic system claimed in claim 17 further comprising a digital video circuit and a television antenna coupled to said digital video circuit and said processor operable to configure and control said digital video circuit.

17D. The mobile video electronic system claimed in claim 17 wherein said processor has an active power state, a low power retention state and an off state, and said processor is responsive to an interrupt to wake up said processor.

19A. The manufacturing process claimed in claim 19 further comprising stuffing a printed wiring board with the at least one integrated circuit.

19B. The manufacturing process claimed in claim 19A further comprising stuffing a printed wiring board with a second integrated circuit coupled to the power management circuitry.

19C. The manufacturing process claimed in claim 19A further comprising stuffing the printed wiring board with at least one additional component and providing an enclosure defining a wireless product.

19D. The manufacturing process claimed in claim 19A further comprising programming a non-volatile memory with power management information and coupling said non-volatile memory to said at least one integrated circuit.

19E. The manufacturing process claimed in claim 19D further comprising programming the non-volatile memory with revised power management information for conditional dynamic power switching of the processor combined with the voltage and frequency scaling.

Notes: Aspects are paragraphs which might be offered as claims in patent prosecution. The above dependently-written Aspects have leading digits and internal dependency designations to indicate the claims or aspects to which they pertain. Aspects having no internal dependency designations have leading digits and alphanumerics to indicate the position in the ordering of claims at which they might be situated if offered as claims in prosecution.

It is emphasized here that while some embodiments may have an entire feature totally absent or totally present, other embodiments, such as those performing the blocks and steps of the Figures of drawing, have more or less complex arrangements that execute some process portions, selectively bypass others, and have some operations running concurrently sequentially regardless. Accordingly, words such as “enable,” “disable,“ “operative,” “inoperative” are to be interpreted relative to the code and circuitry they describe. For instance, disabling (or making inoperative) a second function by bypassing a first function can establish the first function and modify the second function. Conversely, making a first function inoperative includes embodiments where a portion of the first function is bypassed or modified as well as embodiments where the second function is removed entirely. Bypassing or modifying code increases function in some embodiments and decreases function in other embodiments.

A few preferred embodiments have been described in detail hereinabove. It is to be understood that the scope of the invention comprehends embodiments different from those described yet within the inventive scope. Microprocessor and microcomputer are synonymous herein. Processing circuitry comprehends digital, analog and mixed signal (digital/analog) integrated circuits, ASIC circuits, PALs, PLAs, decoders, memories, non-software based processors, microcontrollers and other circuitry, and digital computers including microprocessors and microcomputers of any architecture, or combinations thereof. Internal and external couplings and connections can be ohmic, capacitive, inductive, photonic, and direct or indirect via intervening circuits or otherwise as desirable. Implementation is contemplated in discrete components or fully integrated circuits in any materials family and combinations thereof. Various embodiments of the invention employ hardware, software or firmware. Process diagrams herein are representative of flow diagrams for operations of any embodiments whether of hardware, software, or firmware, and processes of manufacture thereof.

While this invention has been described with reference to illustrative embodiments, this description is not to be construed in a limiting sense. Various modifications and combinations of the illustrative embodiments, as well as other embodiments of the invention may be made. The terms “including”, “includes”, “having”, “has”, “with”, or variants thereof are used in the detailed description and/or the claims to denote non-exhaustive inclusion in a manner similar to the term “comprising”. It is therefore contemplated that the appended claims and their equivalents cover any such embodiments, modifications, and embodiments as fall within the true scope of the invention.

What is claimed is:

1. An electronic circuit comprising:
a power managed circuit; and
a power management control circuit coupled to said power managed circuit and operable to select between at least a first operating performance point and a second higher operating performance point for said power managed circuit, each performance point including a respective pair of voltage and operating frequency, and said power management control circuit further operable to control dynamic power switching of said power managed circuit based on a condition wherein said power managed circuit at a given operating performance point has a static power dissipation, and the dynamic power switching puts the power managed circuit in a lower static power state that dissipates less power than the static power dissipation.

2. The electronic circuit claimed in claim 1 wherein the respective pair of voltage and operating frequency are established at a sufficient spacing that a transition from the second higher operating performance point to the first operating performance point saves as much or more energy in said power managed circuit than activation of dynamic power switching at the second higher operating performance point.

3. An electronic device comprising
a processor; and
a power management circuit operable to establish a selected operating point including a voltage and operating frequency for said processor thereby defining ranges bounded by adjacent pairs of operating frequencies,
said processor operable to generate a target frequency and operable to determine whether or not the target frequency is outside or within a current range and further operable to configure an operating point transition in said power management circuit when the target frequency is outside the current range.

4. The device claimed in claim 3 wherein said processor is operable to execute a performance prediction process, and wherein the performance prediction process is operable to deliver the target frequency.

5. An electronic circuit comprising:
a processor;
a functional circuit coupled to said processor;
a power management register circuit coupled to said processor for holding configuration bits in said power management register circuit;
a power management control circuit coupled to said power management register circuit and said power management control circuit operable in response to the configuration bits for voltage and frequency scaling combined with conditional dynamic power switching of said processor.

6. The electronic circuit claimed in claim 5 wherein said power management control circuit includes a state machine operable to selectively command a power down of said processor independently of said functional circuit.

7. An electronic circuit comprising:
a processor operable to run an application;
a memory coupled to said processor;
a peripheral including a buffer coupled to said memory and said buffer having a buffer state output; and
a power management control circuit coupled to said processor, to said memory and to said buffer state output, said power management control circuit conditionally operable in a dynamic power switching mode having a controlled sequence wherein said processor runs the application and delivers resulting information to said memory, and power to said processor is substantially lowered, and portions of the resulting information are successively transferred from said memory to said buffer depending on the buffer state output, and then power to said processor is restored.

8. The electronic circuit claimed in claim 7 further comprising a second processor and wherein the controlled sequence includes a data input execution by said second processor and then power to said second processor is substantially lowered generally prior to the first-named processor running the application.

9. An electronic circuit comprising
a power management circuit having a dynamic power switching mode and a sleep control mode; and
a processor operable in a secure mode and responsive to said power management circuit dynamic power switching mode to perform a context save of the processor before a sleep transition and a context restore on a wakeup transition, said processor further operable to perform a security context save on each exit from secure mode, whereby the security context save does not need to be done on the sleep transition.

10. The electronic circuit claimed in claim 9 wherein said processor has a wakeup transition latency and is operable to perform a security context restore at next entry into secure mode instead of upon the wakeup transition whereby the security context restore is separated from the wakeup transition latency.

11. An electronic circuit comprising:
a power-managed processing circuit operable to execute an application context and said power-managed processing circuit subject to active power consumption when an application is running and static power consumption if its power is on when the application is not running;
a dynamic voltage and frequency scaling (DVFS) circuit operable to establish a voltage and a clock frequency for said power-managed circuit; and
a dynamic power switching (DPS) circuit coupled to said dynamic voltage and frequency scaling circuit, said DPS circuit operable to determine an excess of the clock frequency over a target frequency for said power-managed processing circuit, and when that excess exceeds a predetermined threshold to initiate a context save by said power-managed processing circuit then temporarily substantially reduce the static power consumption.

12. The electronic circuit claimed in claim 11 wherein said power-managed processing circuit is operable to deliver the target frequency to said DPS circuit.

13. An electronic system comprising:
a first integrated circuit including
a processor;
a functional circuit coupled to said processor;
a power management register circuit coupled to said processor to hold configuration bits;
a power management control circuit coupled to said power management register circuit and said power management control circuit operable in response to the configuration bits for combined voltage and frequency scaling and conditional dynamic power switching of said processor; and
a second integrated circuit including
a power controller coupled to said power management control circuit of said first integrated circuit; and
a first controllable voltage power supply responsive to said power controller and said first controllable voltage power supply coupled to supply a controllable voltage to power said processor; and
a second controllable voltage power supply responsive to said power controller and said second controllable voltage power supply coupled to supply a controllable voltage to power said functional circuit said first integrated circuit.

14. The electronic system claimed in claim 13 further comprising a third integrated circuit including a modem coupled to said processor and a second power management control circuit coupled to said first power management control circuit.

15. An electronic camera system comprising:
a camera sensor operable for successive capture operations to capture image frames;
a digital signal processor operable for image processing;
an interconnect coupled to said digital signal processor;
an interconnect clock coupled to said interconnect;
a power management control circuit;
a camera interface coupled to said camera sensor and to said interconnect, said camera interface including a buffer and supporting a smart standby mode wherein when said camera sensor is enabled, a time interval elapses between the successive capture operations, said camera interface operable during the time interval to assert a camera standby signal to the power management control circuit that said camera interface is not accessing said interconnect, said power management control circuit operable during the time interval to shut down said interconnect clock and assert a wait signal to prevent sourcing by said digital signal processor onto said interconnect; and at substantially the end of the time interval the camera interface further operable to de-assert the camera standby signal to indicate that said camera interface is ready to access said interconnect, and said power management control circuit operable to then disable the wait signal and activate said interconnect clock; and
a display coupled to said digital signal processor.

16. The electronic camera system claimed in claim 15 further comprising a memory controller and wherein said digital signal processor has a memory cache and said display has a display buffer and wherein said power management control circuit is operable to control a frequency scaling circuit coupled to said memory controller and having a latency for changing from one frequency to another frequency, said power management control circuit operable during the latency to pause said camera sensor, and to signal said digital signal processor to operate from said memory cache, and to signal said display to operate from said display buffer independently of said memory controller.

17. A mobile video electronic system comprising:
a processor;
a power management control circuit coupled to said processor and operable for voltage and frequency scaling combined with conditional dynamic power switching of said processor;
a video camera coupled to said processor and to said power management control circuit;
a modem coupled to said power management control circuit; and
a video display operable to display video content and coupled to said power management control circuit.

18. The mobile video electronic system claimed in claim 17 wherein said video display includes a display processor for graphics, video, temporal dithering, plural video image formats, and plural television output types, said display processor coupled to said power management control circuit.

19. A manufacturing process comprising
preparing design code representing a processor and configurable power management circuitry for voltage and clock control by power management control operable for voltage and frequency scaling combined with conditional dynamic power switching of the processor; and
making at least one integrated circuit by wafer fabrication responsive to said design code.

20. The manufacturing process claimed in claim 19 further comprising verifying operation of the integrated circuit for compliance with a condition for invoking the dynamic power switching.
